(19) United States
(12) Patent Application Publication
(10) Pub. No.: US 2013/0246690 A1
(43) Pub. Date: Sep. 19, 2013

(54) INFORMATION PROCESSING SYSTEM AND DATA-STORAGE CONTROL METHOD

(71) Applicant: FUJITSU LIMITED, Kawasaki-shi (JP)

(72) Inventor: Terumasa HANEDA, Machida (JP)

(73) Assignee: FUJITSU LIMITED, Kawasaki-shi (JP)

(21) Appl. No.: 13/777,882

(22) Filed: Feb. 26, 2013

(30) Foreign Application Priority Data
Mar. 19, 2012 (JP) 2012-061509

(51) Int. Cl. G06F 12/02; G06F 12/08

(52) U.S. Cl. CPC G06F 12/0246; G06F 12/0813; G06F 12/0804
USPC 711/103; 711/147; 711/143

(57) ABSTRACT

In an information processing system, a processor requests a first transfer control circuit to transfer data to a first memory. In response to the request from the processor, the first transfer control circuit sends the data to a second transfer control circuit. The second transfer control circuit stores in a second memory the data received from the first transfer control circuit, and also stores the data in the first memory through the first transfer control circuit.

### CROSS-REFERENCE TO RELATED APPLICATION

This application is based upon and claims the benefit of priority of the prior Japanese Patent Application No. 2012-061509, filed on Mar. 19, 2012, the entire contents of which are incorporated herein by reference.

### FIELD

This invention relates to an information processing system and a data-storage control method.

### BACKGROUND

The storage systems using a disk array or the like as a storage device include a storage control apparatus receiving an access request from a host apparatus and accessing the storage device according to the access request. The storage control apparatus temporarily stores, in a cache memory in the storage control apparatus, data requested by the host apparatus to be written in the storage device or data frequently accessed by the host apparatus among the data stored in the storage device.

In addition, the reliability of the processing for accessing the storage device in a storage system is increased by arranging multiple storage control apparatuses in the storage system. In an example of such a storage system having multiple storage control apparatuses, cached data are duplexed by storing data received by one of the storage control apparatuses from the host apparatus, in cache memories in the one and another of the storage control apparatuses.

Further, in an example of a system in which the data in a cache memory can be backed up, the data cached in the cache memory are backed up in a nonvolatile memory.

See, for example, Japanese Patent Laid-Open Nos. 2005-70995, 2009-48544, and 06-222988.

As described above, in the storage system in which the cached data is duplexed, one of the storage control apparatuses performs two data transfer operations, one for transferring the write data to the cache memory in the one of the storage control apparatuses and the other for transferring the write data to the cache memory in the other of the storage control apparatuses. In this case, the CPU (central processing unit) in the one of the storage control apparatuses outputs twice a data transfer request such as a DMA (Direct Memory Access) transfer request. Therefore, the overhead times for the data transfer delay the completion of the data storing operations in both of the cache memories.

Further, similar problems of delay in completion of data storing operations generally occur in the case where data are doubly stored in different storage devices and therefore two data transfers are required.

### SUMMARY

According to an aspect, there is provided an information processing system including a processor, a first memory, a second memory, a first transfer control circuit connected to the processor and the first memory, and a second transfer control circuit connected to the processor and the second memory. When the first transfer control circuit receives from the processor a request for transfer of data addressed to the first memory, the first transfer control circuit sends the data to the second transfer control circuit. When the second transfer control circuit receives the data sent from the first transfer control circuit, the second transfer control circuit stores the received data in the second memory, and also stores the received data in the first memory through the first transfer control circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a construction and an example of a sequence of operations of a control system according to a first embodiment;

FIG. 2 illustrates an example of a configuration of a storage system according to a second embodiment;

FIG. 3 illustrates examples of hardware constructions of a CM (controller module) and a CBU (cache backup unit);

FIG. 4 is an explanatory diagram for explaining duplexing of data stored in a cache area;

FIG. 5 is an explanatory diagram for explaining duplexing of data when a CM receives a request for accessing a logical volume the access control to which is assigned to another CM;

FIG. 6 illustrates a comparison example of a procedure for writing in a NAND flash memory on a block-by-block basis;

FIG. 7 is an explanatory diagram for explaining an area management method for a NAND flash memory in a CBU;

FIG. 8 illustrates an example of writing of data in each user area;

FIG. 9 illustrates an example of processing performed when only a part of data in a division area is overwritten;

FIG. 10 illustrates examples of data tables for management of memory areas in the NAND flash memory;

FIG. 11 illustrates an example of a structure of a packet transmitted or received through a PCIe (Peripheral Components Interconnect-express) bus;

FIG. 12 illustrates examples of a control area allocated on a RAM in a CM;

FIG. 13 is a first sequence diagram indicating a first example of a sequence of operations performed when a CM receives a request for writing in a logical volume the access control to which is assigned to the CM per se;

FIG. 14 is a second sequence diagram indicating a second example of a sequence of operations performed when a CM receives a request for writing in a logical volume the access control to which is assigned to the CM per se;

FIG. 15 illustrates examples of states of the tables when operations for full overwriting are performed;

FIGS. 16 and 17 illustrate a third sequence diagram indicating a third example of a sequence of operations performed when a CM receives a request for writing in a logical volume the access control to which is assigned to the CM per se;

FIG. 18 illustrates examples of states of the tables when an operation for partial overwriting is performed;

FIGS. 19 and 20 illustrate a first sequence diagram indicating a first example of a sequence of operations performed when the CM receives a request for writing in a logical volume the access control to which is assigned to another CM;

FIGS. 21 and 22 illustrate a second sequence diagram indicating a second example of a sequence of operations performed when the CM receives a request for writing in a logical volume the access control to which is assigned to another CM;

FIGS. 23 and 24 illustrate a third sequence diagram indicating a third example of a sequence of operations performed when the CM receives a request for writing in a logical volume the access control to which is assigned to another CM;

FIG. 25 is a sequence diagram indicating an example of a sequence of operations performed for writing back data;

FIG. 26 illustrates examples of control areas allocated on a RAM by a CM which takes over access control, and examples of correspondences between the information in the control areas and information in a NAND management table in a CBU;

FIG. 27 is a sequence diagram indicating an example of a sequence of operations for writing back data stored in a NAND flash memory;

FIG. 28 is a flow diagram indicating an example of a flow of operations performed when a readout request is received from a host apparatus during an operation of writing back data; and

FIG. 29 illustrates examples of patterns in determination of operations in an IO control unit in a CBU.

### DESCRIPTION OF EMBODIMENTS

The embodiments will be explained below with reference to the accompanying drawings, wherein like reference numbers refer to like elements throughout.

### 1. First Embodiment

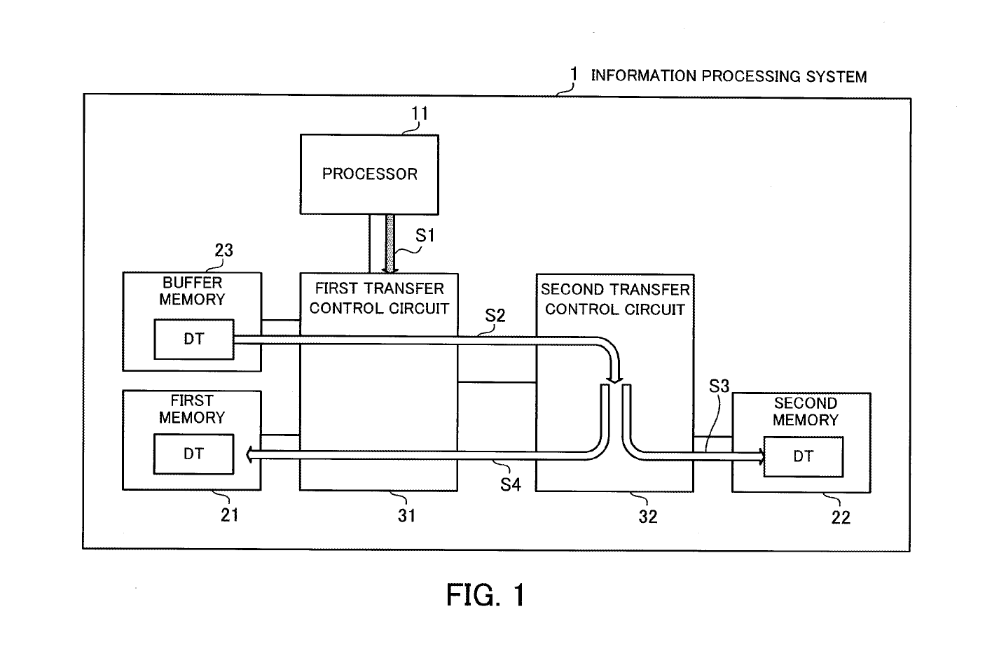

FIG. 1 illustrates an example of a construction and an example of a sequence of operations of a control system according to the first embodiment. The information processing system 1 illustrated in FIG. 1 includes a processor 11, a first memory 21, a second memory 22, a first transfer control circuit 31, and a second transfer control circuit 32.

The information processing system 1 doubly records data DT in the first and second memories 21 and 22 in order to improve the safety of the data DT. The second memory 22 is provided for backing up the data stored in the first memory 21.

In the example of FIG. 1, the data DT to be duplexed is assumed to be temporarily stored in a buffer memory 23. In addition, the memory area of the buffer memory 23 and the memory area of the first memory 21 may be realized in a semiconductor memory device.

The first transfer control circuit 31 is connected to the processor 11, the first memory 21, and the second transfer control circuit 32. The first transfer control circuit 31 is configured to be capable of performing, independently of the processor 11, writing of data in the first memory 21 and transmission of data between the first transfer control circuit 31 and the second transfer control circuit 32.

The second transfer control circuit 32 is connected to the second memory 22 and the first transfer control circuit 31. The second transfer control circuit 32 is configured to be capable of performing, independently of the processor 11, writing of data in the second memory and transmission of data between the first transfer control circuit 31 and the second transfer control circuit 32.

Hereinbelow, processing for duplexing of the data DT temporarily stored in the buffer memory 23 in the first and second memories 21 and 22 in the information processing system 1 is explained step by step.

In step S1, the processor 11 requests the first transfer control circuit 31 to transfer the data DT addressed to the first memory 21. On receipt of the request, in step S2, the first transfer control circuit 31 reads out the data DT from the buffer memory 23, and sends the data DT to the second transfer control circuit 32 instead of the first transfer control circuit 31. The operation in step S2 is performed, for example, by transmission of a write-request packet requesting to store data in the first memory 21.

When the second transfer control circuit 32 receives the data DT sent from the first transfer control circuit 31, the second transfer control circuit 32 stores the received data DT in the second memory 22 in step S3, and also stores the received data DT in the first memory 21 through the first transfer control circuit 31 in step S4. For example, the second transfer control circuit 32 temporarily stores the received data DT in a buffer memory (not illustrated). Thereafter, the second transfer control circuit 32 reads out the data DT from the buffer memory, and transfers the data DT to the first and second memories 21 and 22. The operation in step S4 is performed by transferring the write-request packet received from the first transfer control circuit 31, from the second transfer control circuit 32 to the first transfer control circuit 31.

According to the above processing, the data DT is doubly stored in the first and second memories 21 and 22 in response to only one request from the processor 11 to the first transfer control circuit 31 for data transfer. Therefore, the time needed for the data duplexing according to the above processing can be reduced compared with, for example, the case where the processor 11 requests transfer of the data DT from the buffer memory 23 to the first memory 21 and thereafter requests transfer of the data DT from the buffer memory 23 to the second memory 22.

For example, when the processor 11 requests the first transfer control circuit 31 to transfer data, an overhead time having a length comparable with the actual time needed for the data transfer occurs. Therefore, in the information processing system 1, the processor 11 issues only one request for data transfer. In response to the request, the second transfer control circuit 32, which is a hardware unit arranged independently of the processor 11, transfers the data in two directions, so that the length of the overhead time is reduced. Therefore, it is possible to reduce the time needed for the duplexing of data.

In addition, the first transfer control circuit can be realized, for example, by a common memory controller or a bus controller, which is arranged between the memories and the processor and transmits and receives data to and from peripheral devices other than the memories and the processor. Since the second transfer control circuit 32 can be connected as a peripheral device to the first transfer control circuit 31 arranged as above, the data duplexing can be performed at high speed without greatly changing the basic positions of the internal components of the information processing system.

### 2. Second Embodiment

2.1 System Configuration

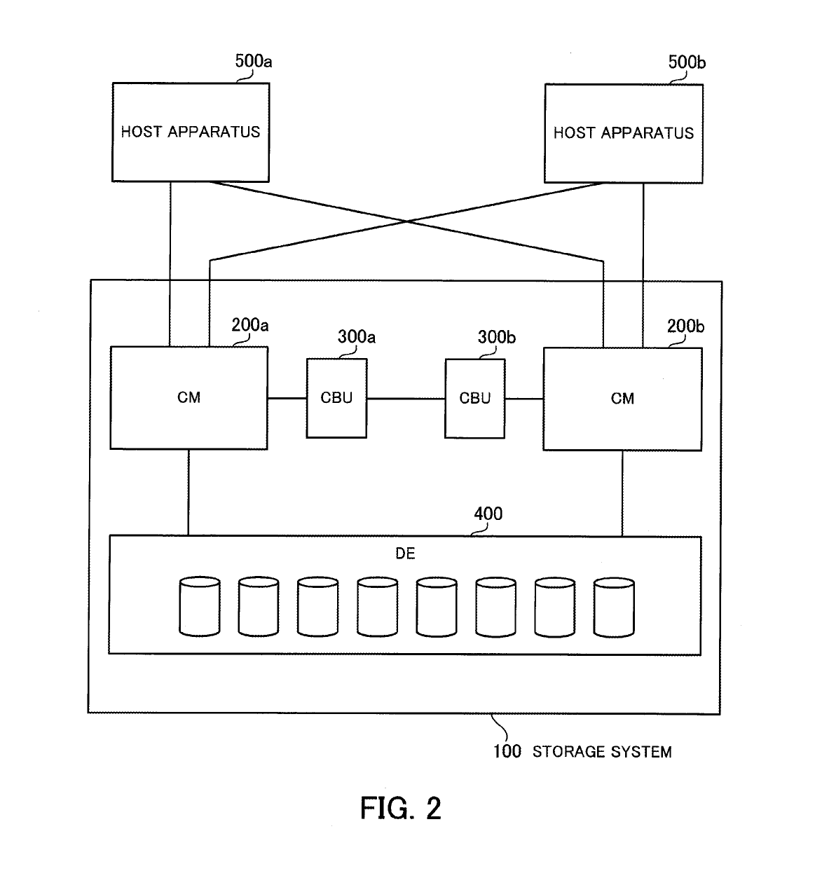

FIG. 2 illustrates an example of a configuration of a storage system according to the second embodiment.

The storage system 100 includes CMs (controller modules) 200a and 200b, CBUs (cache backup units) 300a and 300b, and a DE (drive enclosure) 400. In addition, host apparatus 500a and 500b are connected to the CMs 200a and 200b.

Each of the CMs 200a and 200b reads and writes data from and in storage devices in the DE 400 according to IO (In/Out) requests from the host apparatuses. For example, each of the CMs 200a and 200b can receive IO requests from either of the host apparatuses 500a and 500b. The number of host apparatuses connected to each of the CMs 200a and 200b is not limited to two (although the number of host apparatuses in the configuration of FIG. 2 is two).

In addition, the CM 200a uses a part of the memory area of the RAM (random access memory) in the CM 200a as a cache area, and temporarily stores, in the cache area, data (write data) requested by one of the host apparatuses to be written in the DE 400 and data (read data) read out from the DE 400. Similarly, the CM 200a uses a part of the memory of the RAM (random access memory) in the CM 200a as a cache area, and temporarily stores, in the cache area, data (write data) requested by one of the host apparatuses to be written in the DE 400 and data (read data) read out from the DE 400.

The DE 400 includes multiple storage devices which are subject to access control by the CMs 200a and 200b. The DE 400 in the present embodiment is a disk array including HDDs (hard disk drives) as storage devices. The storage devices included in the DE 400 may be other types of nonvolatile storage devices such as SSDs (solid state drives). Further, more than one DE may connected to each of the CMs 200a and 200b.

In response to a manipulation by a user, the host apparatus 500a requests one of the CMs 200a and 200b to access the HDDs in the DE 400. For example, in response to a manipulation by a user, the host apparatus 500a can perform operations for reading data from the HDDs in the DE 400 or operations for writing data in the HDDs in the DE 400, through one of the CMs 200a and 200b. The host apparatus 500b can also perform similar operations to the host apparatus 500a.

The PCIe bus connects the CM 200a and the CBU 300a, the CBUs 300a and 300b, and the CBU 300b and the CM 200b. In addition, each of the CBUs 300a and 300b includes a NAND flash memory as a nonvolatile memory.

When data is written in the cache area in the CM 200a, the CBU 300a backs up the data in the NAND flash memory in the CBU 300a in synchronization with the writing in the CM 200a. In addition, when data is written in the cache area in the CM 200b, the CBU 300b backs up the data in the NAND flash memory in the CBU 300b in synchronization with the writing in the CM 200b.

2.2 Outline of Features

As explained later in details, the storage system 100 according to the present embodiment has the following features (1) to (6).

(1) Since the data stored in the cache area in each CM is backed up in the NAND flash memory as a nonvolatile memory, it is possible to prevent loss of the data stored in the cache area even when the CM abnormally stops. For example, when the operation of the CM is stopped by power cut, it is unnecessary to continue power supply to the memory devices realizing the backup area.

(2) The data stored in the cache area in each CM is backed up in the NAND flash memory in the corresponding CBU. Therefore, for example, when one of the CMs abnormally stops and is thereafter restored, the restored CM can immediately start the access control operation by writing back the data stored in the NAND flash memory in the corresponding CBU, into the cache area in the CM. Further, it is possible to avoid occurrence of a situation in which dirty data (which is not written in the HDDs in the DE 400) among the data stored in the cache area in the CM is lost. Thus, the reliability of the storage system 100 increases.

(3) The CBU 300a, which backs up the data stored in the cache area in the CM 200a, is arranged separately from the CM 200a. Therefore, for example, when the CM 200a abnormally stops, the other CM 200b can read out data from the NAND flash memory in the CBU 300a. In this case, the CM 200b can store the data read out as above, in the cache area in the CM 200b, and can immediately take over the access control which has been performed by the CM 200a.

(4) In the system in which data stored in a cache area in each of CMs is backed up in the RAM in another of the CMs, for example, as in the technique disclosed in Japanese Patent Laid-Open No. 2005-70995, it is necessary to secure in the RAM in each CM a backup area for the other CM. On the other hand, in the configuration according to the present embodiment, the data stored in the cache area in each CM is backed up in the NAND flash memory in the corresponding CBU. Therefore, the amount of use of the RAM in each CM can be decreased.

(5) Incidentally, when data transmitted from a host apparatus is written in the cache area in one of CMs in response to a write request from the host apparatus, two write operations, data writing in the cache area and data writing in the NAND flash memory, are required to be performed. Therefore, there is a possibility that the reply to the host apparatus is delayed.

On the other hand, in the storage system 100 according to the present embodiment, when the CPU in one of the CM issues a request for DMA transfer for writing data in the cache area in the CM, a memory controller in the CM transfers the data to the corresponding CBU by DMA. Then, the CBU writes the received data in the cache area in the CM and the NAND flash memory in the CBU in parallel. That is, the data is doubly written in the cache area and the NAND flash memory in response to only one request for DMA transfer. Therefore, the response time to the host apparatus can be reduced.

(6) Generally, data written in the NAND flash memory is required to be erased before the data is overwritten, and the NAND flash memory has a characteristic that the minimum area in which all data can be erased by one operation is greater than each of the minimum area in which data can be written by one operation and the minimum area from which data can be read out by one operation. Therefore, the rate at which random data is written in the NAND flash memory is lower than the rate at which random data is written in the nonvolatile memory such as the DRAM (dynamic random access memory) which is used for the cache area.

On the other hand, in the CBUs according to the present embodiment, the memory area of the NAND flash memory are managed by dividing the memory area into division areas having different sizes, e.g., division areas each corresponding to a single page or multiple pages. Further, when data stored in the cache area is written by each CBU in the NAND flash memory, the data is written in a division area which matches the data in size. Since the writing is controlled as above, pages partially containing invalid data become unlikely to randomly occur, so that the time needed for writing including overwriting decreases.

2.3 Hardware Construction

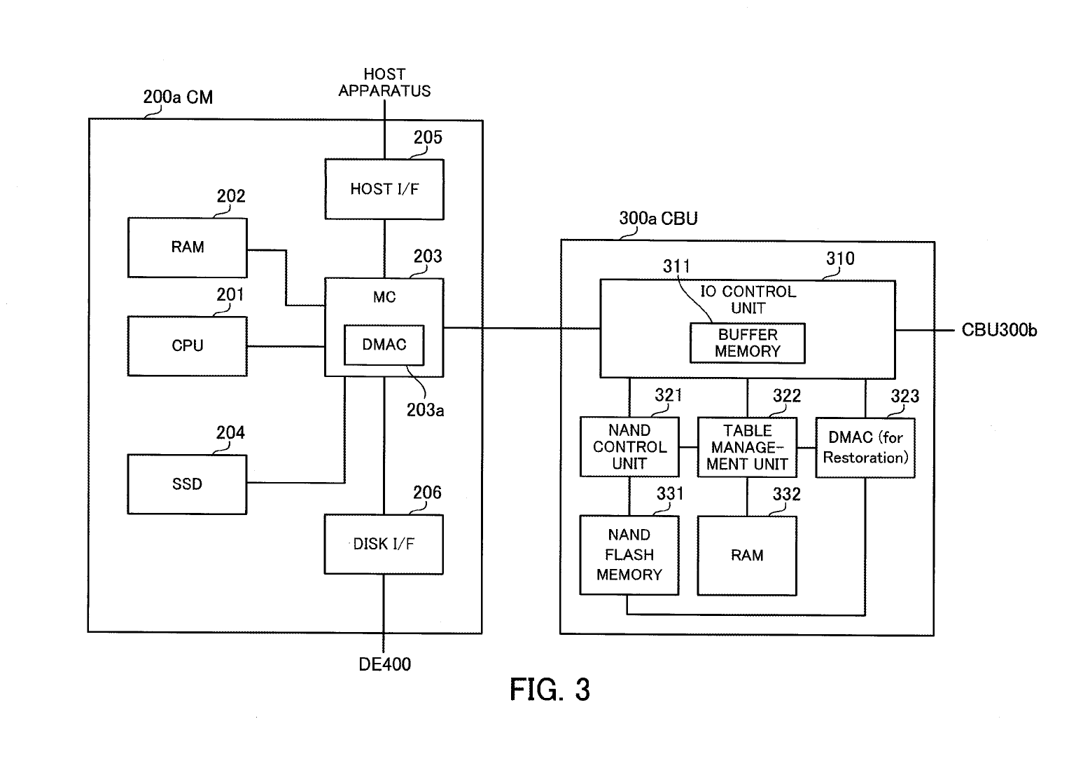

FIG. 3 illustrates examples of hardware constructions of the CM and the CBU. Although only the CM 200a and the CBU 300a are illustrated in FIG. 3, the CM 200b and the CBU 300b can also be realized by constructions similar to the CM 200a and the CBU 300a, respectively. In addition, the CM 200b can perform operations similar to the CM 200a, and the CBU 300b can perform operations similar to the CBU 300a. Therefore, hereinafter, the explanations on the constructions and operations are mainly focused on the CM 200a and the CBU 300a, and explanations on the constructions and operations of the CM 200b and the CBU 300b are presented only when necessary.

A CPU 201 controls the entire CM 200a. A RAM 202 and peripheral devices are connected to the CPU 201 through a memory controller (MC) 203. The RAM 202 is used as a main memory device of the CM 200a and temporarily stores at least portions of programs to be executed by the CPU 201 and various data needed for processing performed with the programs. In the example of FIG. 3, an SSD (solid-state device) 204, a host interface (I/F) 205, and a disk interface (I/F) 206, as the peripheral devices, are connected to the CPU 201.

The SSD 204 is used as a secondary memory device of the CM 200a and stores the programs to be executed by the CPU 201 and various data needed for the processing performed in accordance with the programs. Alternatively, other types of nonvolatile memory devices such as the HDD may be used as the secondary memory device.

The host interface 205 performs interface processing for transmitting data to and from the host apparatus. The disk interface 206 performs interface processing for transmitting data to and from the HDDs in the DE 400.

The memory controller 203 is connected to the CBU 300a through the PCIe bus. The memory controller 203 controls data transfer between the CPU 201 and the peripheral devices in the CM 200a and data transfer between the CPU 201 and the CBU 300a.

In addition, the memory controller 203 includes a DMA controller (DMAC) 203a. In response to a request from the CPU 201 for DMA transfer, the DMA controller 203a performs, independently of the CPU 201, processing for writing data stored in an area in the RAM 202, into another area in the RAM 202, and processing for transferring data stored in the RAM 202 to the CBU 300a. In addition, the DMA controller 203a can perform, independently of the CPU 201, data transfer processing according to information received from the other CM 200b through the CBUs 300b and 300a.

The CBU 300a includes an IO control unit 310, a NAND control unit 321, a table management unit 322, a DMA controller (DMAC) 323, a NAND flash memory 331, and a RAM 332.

The IO control unit 310 is a control circuit controlling transmission and reception of data through the PCIe bus. The IO control unit 310 recognizes the destination of the information received through the PCIe bus, and transfers the received information to the memory controller 203 in the CM 200a, or the CBU 300b, or the NAND control unit 321. In addition, according to an instruction from the CM 200a, the IO control unit 310 can request the DMA controller 323 to make a DMA transfer for transferring data stored in the NAND flash memory 331 to the CM 200a under control of the DMA controller 323. Further, a buffer memory 311 is arranged in the IO control unit 310. The IO control unit 310 temporarily stores in the buffer memory 311 data received through the PCIe bus and data to be transmitted through the PCIe bus. A part of the RAM 332 may be used as the memory area of the buffer memory 311.

The NAND control unit 321 and the table management unit 322 are control circuits for realizing access control for access to the NAND flash memory 331. The NAND control unit 321 and the table management unit 322 may be realized by individual semiconductor devices, or may be realized by a single semiconductor device. In addition, the functions of at least one of the NAND control unit 321 and the table management unit 322 may be realized by the same semiconductor device as the IO control unit 310.

The table management unit 322 records in the RAM 332 tables for managing the memory area of the NAND flash memory 331. As explained later, the table management unit 322 separately manages areas each corresponding to a page, areas each corresponding to one or more pages, and areas each corresponding to a block, in the memory area of the NAND flash memory 331, by using the above tables. The page is the minimum unit of data in data writing and reading, and has a capacity of, for example, 4 kilobytes. The block is the minimum unit of data in data erasing, and has a capacity of, for example, 512 kilobytes.

The NAND control unit 321 receives from the table management unit 322 an indication of a write address at which data is to be written or a read address from which data is to be read out, and writes and reads data in and from the NAND flash memory 331.

The DMA controller 323 in the CBU 300a is provided for transferring the data stored in the cache area in the CM 200a to the other CM 200b, when the CM 200a abnormally stops, in order to restore the IO processing which has been performed by the CM 200a. The DMA controller 323 in the CBU 300a transfers to the CM 200b the data stored in the cache area (which is backed up in the NAND flash memory 331) in accordance with an instruction from the CM 200b. During the transfer, the DMA controller 323 can acquire through the table management unit 322 table information stored in the RAM 332.

2.4 Operations

Hereinbelow, the operations performed in the storage system 100 are explained in detail. Specifically, operations for duplexing data stored in the cache areas in the CMs are explained first, operations for controlling access to the NAND flash memories in the CBUs are explained next, and operations performed over the entire storage system 100 for realizing the above operations for duplexing and operations for controlling access are explained finally.

2.4.1 Duplexing Data in Cache Areas

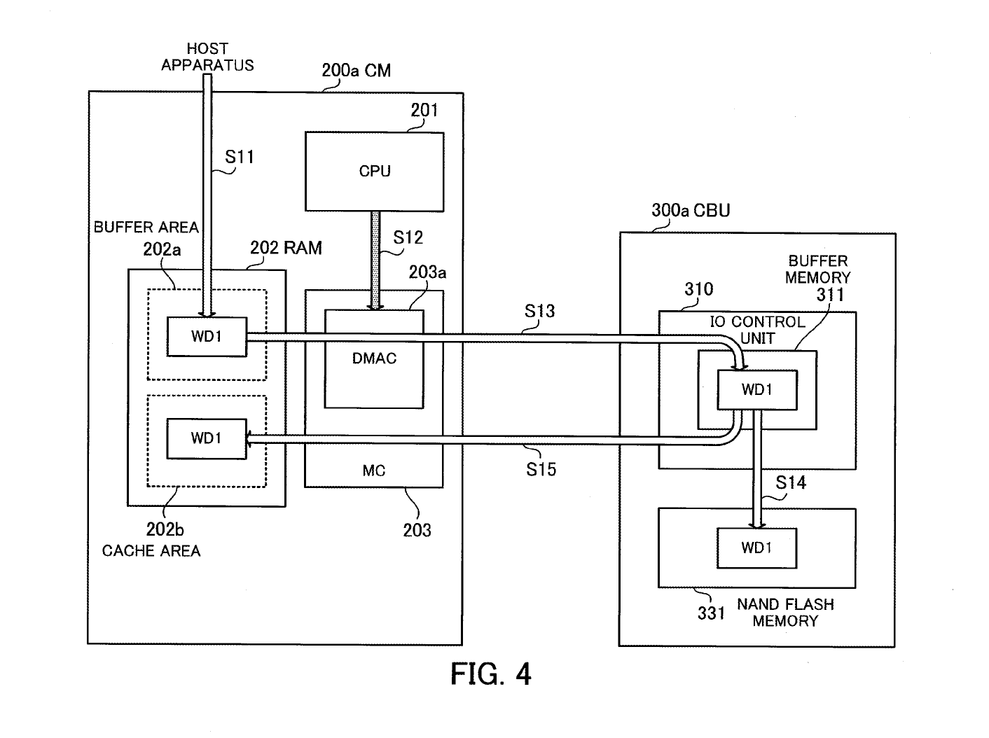

FIG. 4 is an explanatory diagram for explaining duplexing of data stored in a cache area. A buffer area 202a and a cache area 202b are arranged in the RAM 202 in the CM 200a. Either of the host apparatuses requests the CM 200a to perform data writing, and transmits write data (i.e., data to be written) to the CM 200a. The transmitted write data is temporarily stored in the buffer area 202a in the CM 200a. Thereafter, the CM 200a writes in the cache area 202b the write data stored in the buffer area 202a. At this time, the CM 200a also writes the same write data in the NAND flash memory 331 in the CBU 300a. Thus, the write data is duplexed.

The operations for transferring the write data from the buffer area 202a to both of the cache area 202b and the NAND flash memory 331 are performed by DMA (direct memory access), and can therefore be performed at high speed independently of the operation of the CPU 201. In the conventional manner in which data is DMA transferred from the buffer area 202a to both of the cache area 202b and the NAND flash memory 331, the CPU 201 separately issues a request for a DMA transfer for writing the data in the cache area 202b and a request for a DMA transfer for writing the data in the NAND flash memory 331. That is, the CPU 201 requests a DMA transfer twice, so that it takes a long time until a reply informing of completion of writing is returned by the CPU 201 to the host apparatus.

On the other hand, in the storage system 100 according to the present embodiment, both of the DMA transfer to the cache area 202b and the DMA transfer to the NAND flash memory 331 are performed when the CPU 201 issues only one request for DMA transfer. Therefore, the time needed for the data duplexing is reduced, and thus the response time of the CM 200a in response to the request from the host apparatus for data writing is improved.

A sequence of operations performed when a request for data writing is transmitted from the host apparatus 500a or 500b to the CM 200a is explained below step by step.

When the host apparatus 500a or 500b requests the CM 200a to perform data writing, write data WD1 transmitted from the host apparatus is temporarily written in the buffer area 202a in the CM 200a, in step S11. Then, in step S12, the CPU 201 in the CM 200a issues to the DMA controller 203a a write request in which the buffer area 202a is designated as the source from which data is to be read out and the cache area 202b is designated as the destination in which the data is to be written.

In response to the request from the CPU 201, in step S13, the DMA controller 203a reads out the write data WD1 from the buffer area 202a, and transfers the write data WD1 to the CBU 300a instead of the cache area 202b. Specifically, the DMA controller 203a generates a write-request packet containing the write data WD1 (which is read out from the buffer area 202a), a write command, and a predetermined address in the cache area 202b as the destination address, and transmits the write-request packet to the CBU 300a.

The IO control unit 310 in the CBU 300a temporarily stores in the buffer memory 311 the write-request packet received from the CM 200a. In step S14, the IO control unit 310 writes in the NAND flash memory 331 in the CBU 300a the write data WD1 contained in the write-request packet. In addition, in step S15, the IO control unit 310 transfers the write-request packet stored in the buffer memory 311 to the memory controller 203 in the CM 200a. The data writing in the NAND flash memory 331 and the transfer of the write-request packet to the CM 200a are performed, for example, in parallel. The memory controller 203 in the CM 200a extracts the write data WD1 from the write-request packet transferred from the CBU 300a, and writes the write data WD1 in the cache area 202b.

In the above sequence of operations, when the CPU 201 in the CM 200a issues a request for DMA transfer, the write data WD1 is automatically transferred to the CBU 300a. Then, the write data WD1 is transferred to both of the NAND flash memory 331 and the cache area 202b by the operations of the IO control unit 310 in the CBU 300a. That is, in the above sequence of operations, the overhead time in the CPU 201 for requesting DMA transfer occurs only once. Therefore, it is possible to reduce the time taken until duplexing of the write data WD1 is completed and the CPU 201 becomes ready to return to the host apparatus a reply informing of the completion of the writing.

Incidentally, the function of the DMA controller 203a transferring the write data WD1 stored in the buffer area 202a to the outside of the CM 200a can be regarded as a function of transferring the write data WD1 to an external backup area. For example, in the technique disclosed in Japanese Patent Laid-Open No. 2005-70995, a function as above is used when one of the controllers (which may correspond to the CM 200a) stores the data stored in a cache area in the controller, into a cache area in the other of the controllers (which may correspond to the CM 200b).

In the storage system 100 according to the present embodiment, the above function of transferring the write data WD1 to an external backup area is used and information indicating that the received request is a request for duplexing is set in a header area in a write-request packet as explained later, so that the CBU 300a can perform the operations for duplexing as in steps S14 and S15 when the CBU 300a receives the write-request packet. In addition, the cache area 202b, instead of the backup area, is set in the write-request packet as the destination in which the data is to be written, so that the memory controller 203 in the CM 200a can store the write data WD1 in the cache area 202b when the CM 200a receives the write-request packet transferred from the CBU 300a.

Further, the CM 200a is assigned in advance to control access to part of multiple logical volumes presented to the user while both of the CMs 200a and 200b are in normal operation, and the CM 200b is assigned in advance to control access the remaining part of the multiple logical volumes while both of the CMs 200a and 200b are in normal operation. (The logical volume is a logical storage area realized by a physical storage area in the HDDs in the DE 400.)

In the above situation, for example, when the CM 200a receives from the host apparatus 500a or 500b a write request for writing in a logical volume the access control to which is assigned to the CM 200a per se, the CM 200a writes the write data received from the host apparatus, in the cache area 202b in the CM 200a and the NAND flash memory 331 in the CBU 300a. In addition, when the CM 200b receives from the host apparatus 500a or 500b a write request for writing in a logical volume the access control to which is assigned to the CM 200b, the CM 200b writes the write data received from the host apparatus, in the cache area 202b in the CM 200b and the NAND flash memory 331 in the CBU 300b. That is, the write data to be written in the logical volume the access control to which is assigned to the CM 200a is backed up in the NAND flash memory 331 in the CBU 300a, and the write data to be written in the logical volume the access control to which is assigned to the CM 200b is backed up in the NAND flash memory 331 in the CBU 300b.

However, one of the CMs receives a request for access to a logical volume the access control to which is assigned to the other of the CMs in some cases, for example, in the case where a heavy burden is imposed on the transmission line between one of the host apparatuses and the other of the CMs, or in the case where a trouble occurs on the transmission line between the host apparatus and the other of the CMs. In such cases, the write data received by the one of the CMs from the host apparatus is written in the cache area 202b in the other of the CMs and the NAND flash memory 331 in the CBU belonging to the other CM.

In the storage system 100 according to the present embodiment, even in the above cases, duplexing of the write data in the cache area 202b and the NAND flash memory 331 is performed in response to a single request for DMA transfer, so that the operations for the duplexing is performed at high speed.

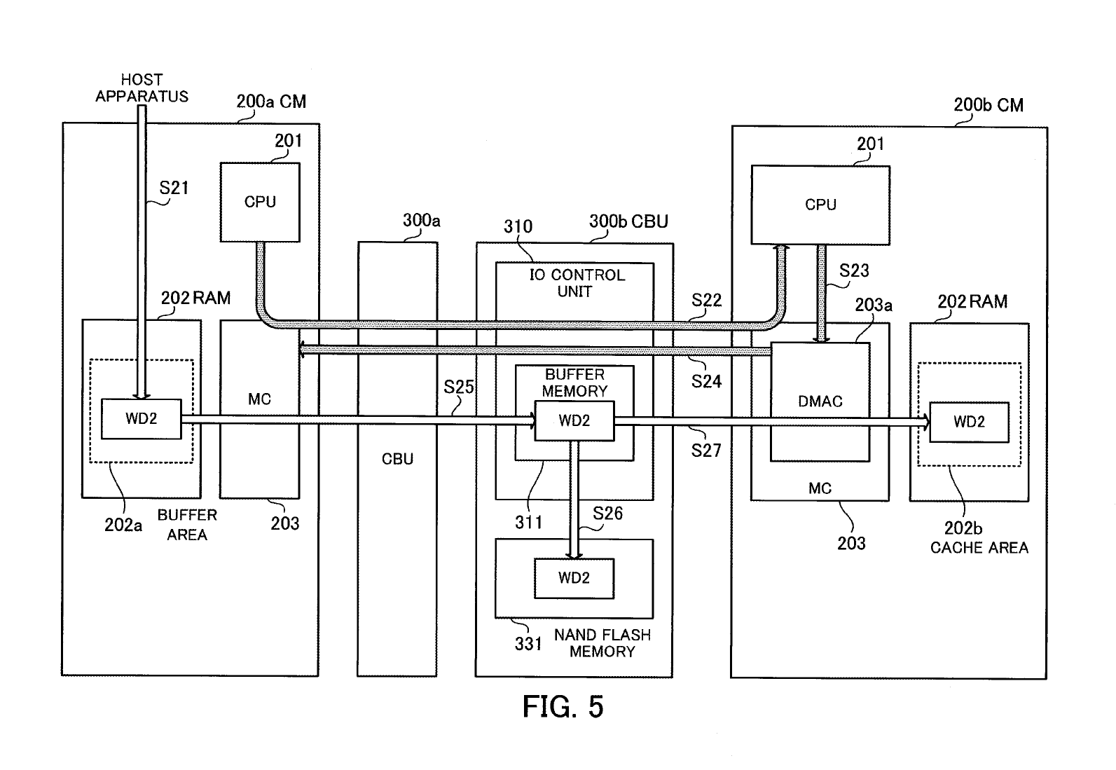

FIG. 5 is an explanatory diagram for explaining duplexing of data when one of the CMs receives a request for accessing a logical volume the access control to which is assigned to the other of the CMs.

When one of the host apparatuses requests the CM 200a to perform data writing, write data WD2 transmitted from the host apparatus is temporarily written in the buffer area 202a in the CM 200a in step S21. In the case where the request from the host apparatus is for writing in a logical volume the access control to which is assigned to the CM 200b, in step S22, the CPU 201 in the CM 200a transmits a PCIe packet to the CM 200b for sending information indicating the logical volume as the destination in which the writing is requested and the address of the destination.

The above PCIe packet from the CM 200a is transferred to the CM 200b through the IO control unit 310 (not illustrated in FIG. 5) in the CBU 300a and the IO control unit 310 in the CBU 300b. When the CPU 201 in the CM 200b receives the PCIe packet from the CM 200a, the CPU 201 in the CBU CM 200b indicates to the DMA controller 203a in the CM 200b the CM 200a as the source (from which the data is to be read out) and the cache area 202b in the CM 200b as the destination (to which the data is to be transferred), and requests the DMA controller 203a in the CM 200b to perform an operation for readout in accordance with the above indication in step S23.

In response to the request from the CPU 201 in the CM 200b, in step S24, the DMA controller 203a in the CM 200b requests the CM 200a to read out the write data WD2. Specifically, the DMA controller 203a in the CM 200b transmits to the CM 200a a read-request packet containing a readout command and a predetermined address in the cache area 202b in the CM 200b as the destination in which the write data WD2 is to be written.

The read-request packet transmitted from the DMA controller 203a in the CM 200b is transferred to the CM 200a through the IO control unit 310 in the CBU 300b and the IO control unit 310 (not illustrated in FIG. 5) in the CBU 300a. When the CM 200a receives the read-request packet from the CM 200b, the memory controller 203 in the CM 200a reads out the write data WD2 from the buffer area 202a in the CM 200a, and returns a reply packet containing the write data WD2, in step S25. The reply packet is transferred to the CBU 300b through the IO control unit 310 (not illustrated in FIG. 5) in the CBU 300a.

The IO control unit 310 in the CBU 300b temporarily stores in the buffer memory 311 the reply packet received from the CM 200a. Then, in step S26, the control unit 310 in the CBU 300b writes in the NAND flash memory 331 in the CBU 300b the write data WD2 contained in the reply packet. In addition, in step S27, the IO control unit 310 in the CBU 300b transfers the reply packet stored in the buffer memory 311 to the DMA controller 203a in the CM 200b. The data writing in the NAND flash memory 331 and the transfer of the reply packet to the CM 200b are performed, for example, in parallel. The DMA controller 203a in the CM 200b extracts the write data WD2 from the reply packet transferred from the CBU 300b, and writes the write data WD2 in the cache area 202b in the CM 200a.

According to the above sequence of operations, the time needed for the operations performed by the CPU 201 in the CM 200b until the duplexing of the write data WD2 is completed is reduced compared with the case where the DMA transfer of the write data WD2 from the buffer area 202a in the CM 200a to the cache area 202b in the CM 200b and the DMA transfer of the write data WD2 from the buffer area 202a in the CM 200a to the NAND flash memory 331 in the CM CBU 300b are separately requested by the CPU 201 in the CM 200b. Therefore, the CM 200a, which receives the write request from the host apparatus, can return, in a short time, to the host apparatus a replay informing of completion of the writing.

The sequence of operations illustrated in FIG. 5 can be regarded as a sequence enabling the CBU 300b (as well as the CM 200b) to acquire the write data WD2, by causing the CBU 300b (located on the transmission path to the CM 200b) to capture the reply packet replying to the read-request packet (which is transmitted from the DMA controller 203a for acquiring the write data WD2 from the other CM 200a). In the present embodiment, information indicating that the duplexing is requested is set in a header area in the read-request packet, so that the CBU 300b can acquire the write data WD2 from the reply packet and write the write data WD2 in the NAND flash memory 331.

2.4.2 Control of Access to NAND Flash Memories in CBUs

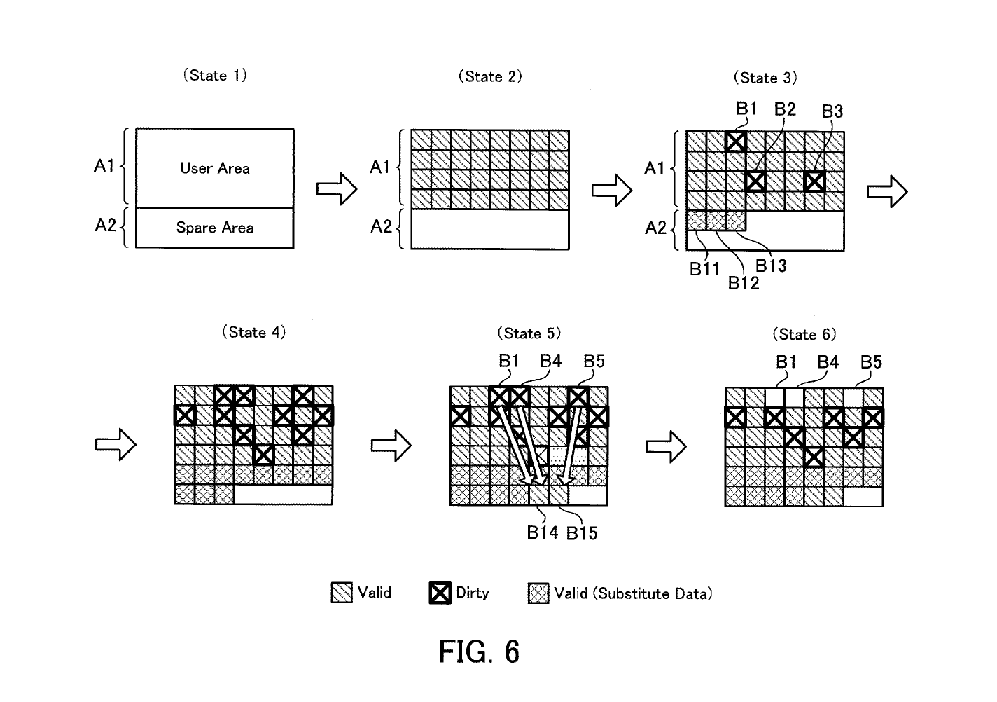

Next, the operations for controlling access to the NAND flash memories in the CBUs are explained below. Before explaining the operations for controlling access to the NAND flash memories according to the present embodiment, a comparison example of a procedure for controlling access to a NAND flash memory is explained with reference to FIG. 6, and the problems in the NAND flash memory are indicated below.

FIG. 6 illustrates a comparison example of a procedure for writing in a NAND flash memory on a block-by-block basis.

In general, the NAND flash memory has the following characteristics. The first characteristic is that in order to overwrite a NAND flash memory with some data, it is necessary to temporarily erase the data which are already written in the NAND flash memory. The second characteristic is that the minimum area in which all data can be erased by one operation is greater than each of the minimum area in which data can be written by one operation and the minimum area from which data can be read out by one operation. The minimum area in which all data can be written in or read out from by one operation is called a page, and the minimum area in which all data can be erased by one operation is called a block. In the example taken in the following explanations, the size of one page is assumed to be 4 kilobytes, and the size of one block is assumed to be 512 kilobytes. The first and second characteristics of the NAND flash memory cause the problem that the data access speed is lowered as the use of the NAND flash memory continues for a certain duration from the initial state.

In the comparison example of FIG. 6, a user area A1 and a spare area A2 are arranged in the NAND flash memory. When data writing is requested in the NAND flash memory in the initial state (in which no data is written as in “State 1” illustrated in FIG. 6), a controller (not illustrated) in the NAND flash memory successively write data in the user area A1 in the NAND flash memory as in “State 2” illustrated in FIG. 6. At this time, the controller changes the status of each block in which data is written, to “Valid”.

In addition, when overwriting of data which is already written in the NAND flash memory is requested, the controller in the NAND flash memory writes substitute data (with which the already written data is to be overwritten) in one or more vacant blocks other than the blocks in which data are already written. At this time, according to the present embodiment, the CM receives a request for reading and writing on an LBA-by-LBA basis, where LBA stands for the logical block address, and an LBA is allocated for every 512 bytes. Therefore, in some cases, only a portion of data stored in a block in the NAND flash memory or only part of pages in a block is subject to overwriting. When overwriting of data stored in part of pages in a block in the NAND flash memory is requested, the controller of the NAND flash memory writes substitute data (with which the above data stored in the part of the pages in the block are requested to be overwritten) in a vacant block other than the blocks in which data are already written. Then, the controller of the NAND flash memory changes the status of the block in which the (old) data to be overwritten is stored, to “Dirty”, which indicates that a part of pages in the block is invalid.

In the “State 3” illustrated in FIG. 6, when overwriting of a portion of the data corresponding to part of the pages in the block B1 is requested, the controller in the NAND flash memory writes substitute data (with which the above data stored in the part of the pages in the block B1 are requested to be overwritten) in a vacant block B11. Then, the controller of the NAND flash memory changes the status of the block B1 to “Dirty”. Similarly, when overwriting of a portion of the data corresponding to part of the pages in the block B2 is requested, the controller in the NAND flash memory writes substitute data (with which the above data stored in the part of the pages in the block B2 are requested to be overwritten) in a vacant block B12. Then, the controller of the NAND flash memory changes the status of the block B2 to “Dirty”. Further, when overwriting of a portion of the data corresponding to part of the pages in the block B3 is requested, the controller in the NAND flash memory writes substitute data (with which the above data stored in the part of the pages in the block B3 are requested to be overwritten) in a vacant block B13. Then, the controller of the NAND flash memory changes the status of the block B3 to “Dirty”. Hereinafter, blocks having the status “Dirty” are referred to as dirty blocks.

As explained above, dirty blocks in the NAND flash memory increase as use of the NAND flash memory continues. As dirty blocks in the NAND flash memory increase, the actually available data capacity of the NAND flash memory, relative to the total storage capacity of the NAND flash memory, decreases. Therefore, when the number of vacant blocks in the NAND flash memory decreases to a certain number, for example, as in “State 4” illustrated in FIG. 6, the controller in the NAND flash memory performs an operation for increasing vacant blocks. For example, as in “State 5” illustrated in FIG. 6, the controller in the NAND flash memory copies into the vacant block B14 the data stored in one or more valid pages in the dirty blocks B1 and B4, and copies into the vacant block B15 the data stored in one or more valid pages in the dirty block B5. When the above operations of copying the data are completed, all the pages in the blocks B1, B4, and B5 become invalid. Then, the controller in the NAND flash memory erases the data in the blocks B1, B4, and B5 as in “State 6” illustrated in FIG. 6, and regards the blocks B1, B4, and B5 as vacant blocks.

As in the example of FIG. 6, in order to secure vacant blocks in the NAND flash memory, copying of data stored in valid pages in one or more blocks and data erasion in the one or more blocks after the copying are performed. Since the bandwidth of the internal bus in the NAND flash memory is used for data copying and erasion as above, the speed of external access to the NAND flash memory is lowered. Further, in order to overcome this problem, a technique of arranging a cache memory at the front end of the NAND flash memory has been proposed. However, this technique increases the circuit size and the manufacturing cost. Therefore, the present embodiment increases the speed of random data writing in the NAND flash memory without use of the cache memory, by performing, by the CBUs, access control to the NAND flash memory as explained below. Although only the operations of the CBU 300a are explained below, the CBU 300b can also perform similar operations.

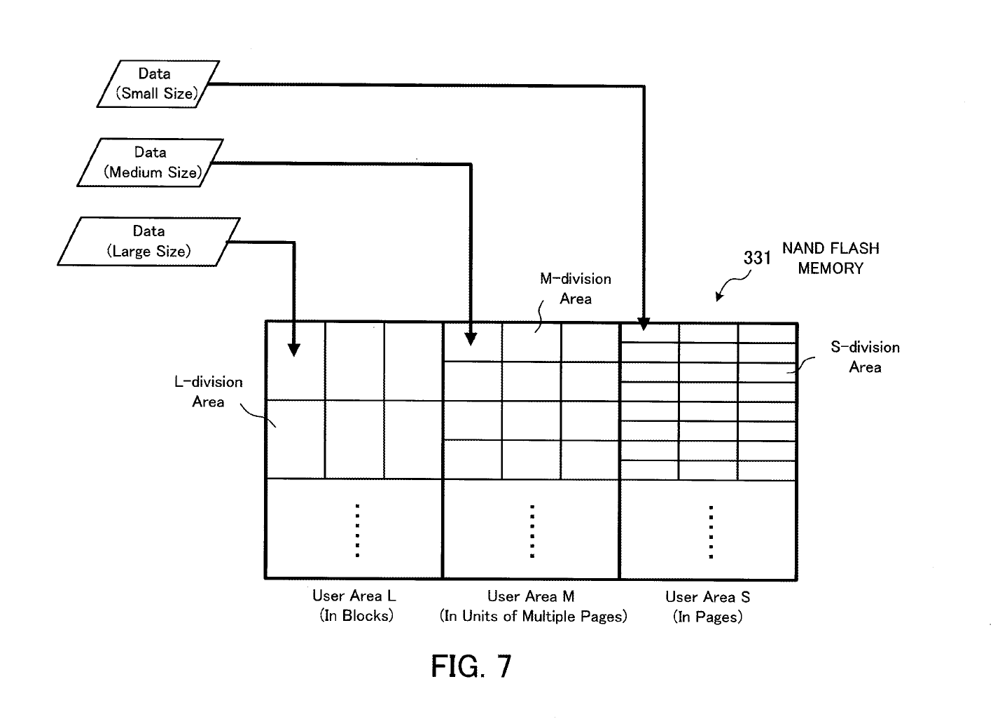

FIG. 7 is an explanatory diagram for explaining an area management method for a NAND flash memory in a CBU.

The CBU 300a manages the NAND flash memory 331 by dividing the inside of the NAND flash memory 331 into three user areas L, M, and S. The CBU 300a manages the user area S in such a manner that data can be written on a page-by-page basis as in the comparison example illustrated in FIG. 6. The CBU 300a manages the user area L in such a manner that data can be written on a block-by-block basis. The CBU 300a manages the user area M in such a manner that data can be written in units of multiple pages. That is, each unit area in writing in the user area M is smaller than the block.

Hereinafter, the unit areas in writing in the user area L are referred to as L-division areas, the unit areas in writing in the user area M are referred to as M-division areas, and the unit areas in writing in the user area S are referred to as S-division areas. In FIG. 7, the L-, M-, and S-division areas are schematically illustrated, and the dimensions of the illustrated L-, M-, and S-division areas are different from the actual dimensions.

When the CBU 300a receives from the CM 200a a request for writing data in the NAND flash memory 331, the CBU 300a distributes write data to one of the L-, M-, and S-division areas according to the size of the write data. When the write data is equal to or smaller in size than each S-division area, the CBU 300a writes the write data in one of the S-division areas. When the write data is equal to or smaller in size than each M-division area and greater in size than each S-division area, the CBU 300a writes the write data in one of the M-division areas. When the write data is equal to or smaller in size than each L-division area and greater in size than each M-division area, the CBU 300a writes the write data in one of the L-division areas. When the write data is greater in size than each L-division area, for example, the CBU 300a divides the write data, from the leading position of the write data, into one or more portions each having the size equal to the L-division area, and further divides a remaining portion of the write data (if any) into one or more portions each having the size equal to or smaller than the M-division area and/or S-division area. Thus, the divided portions are written in one or more L-division areas and one or more M-division areas and/or one or more S-division areas.

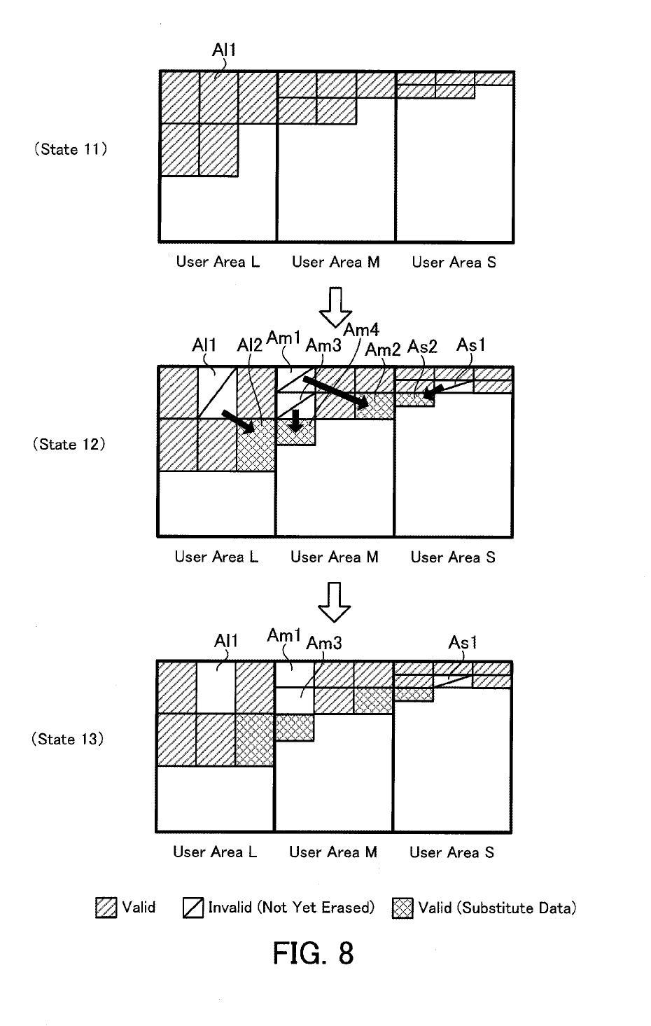

FIG. 8 illustrates an example of writing of data in each user area.

When the CBU 300a receives a data-write request in an initial state (in which all of the user areas L, M, and S are vacant), the CBU 300a writes the write data in the L-, M-, and S-division areas in the user areas according to the size of the write data, for example, as illustrated in “State 11” in FIG. 8. Further, when the CBU 300a receives such a data-write request as to overwrite all the data already written in one of the L-, M-, and S-division areas in the NAND flash memory 331, the CBU 300a performs a control operation as illustrated in “State 12” in FIG. 8.

For example, when the CBU 300a receives such a data-write request as to overwrite all the data already written in the L-division area Al1, the CBU 300a first writes new write data in another L-division area Al2, and changes the status of the L-division area Al1 to “Invalid”, which indicates that no effective data is stored in the L-division area Al1. Thereafter, when a vacant block is required to be secured in the user area L, the CBU 300a can erase the data in the L-division area Al1 (the status of which is “Invalid”) without copying the data into another division area, as illustrated in “State 13” in FIG. 8.

Further, for example, when the CBU 300a receives such a data-write request as to overwrite all the data already written in the S-division area As1, the CBU 300a first writes new write data in another S-division area As2 as illustrated in “State 12” in FIG. 8, and changes the status of the S-division area As1 to “Invalid”. Thereafter, when a block including the S-division area As1 is required to be secured as a vacant block, the CBU 300a is required to copy the data stored in the other S-division areas in the block including the S-division area As1, into another vacant block, as in “State 13” illustrated in FIG. 8.

In particular, in many cases where the host apparatus 500a or 500b requests the CM 200a to write a set of data and thereafter requests an update of the set of data, the entire set of original data is overwritten. Therefore, in the case where overwriting of a set of data stored in an L-division area is requested, the status of every page in the L-division area storing the original set of data is likely to become “Invalid”. Thus, in comparison to the user area S, the possibility of random occurrence of invalid pages is low in the user area L and therefore the data copying operation for securing a vacant area is unlikely to be performed on the user area L, and the speed of random data writing can be increased in the user area L in comparison to the user area S.

Next, an example of overwriting of data in the user area M is explained. In this example, the size of the M-division area is assumed to be half the size of the L-division area (i.e., half the size of the block).

For example, when the CBU 300a receives a write request for overwriting an entire set of data written in the M-division area Am1, the CBU 300a writes new write data in another M-division area Am2 as in “State 12” illustrated in FIG. 8, and changes the status of the M-division area Am1 to “Invalid”. Further, for example, when the CBU 300a receives a write request for overwriting an entire set of data written in the M-division area Am3, the CBU 300a writes new write data in another M-division area Am4 as in “State 12” illustrated in FIG. 8, and changes the status of the M-division area Am3 to “Invalid”.

In the case where both of the M-division areas Am1 and Am3 are contained in a block, when a vacant block is required to be secured in the user area M, the CBU 300a can erase the data in each of the M-division areas Am1 and Am3 (having the status “Invalid”) without copying the data into other division areas, as in “State 13” illustrated in FIG. 8.

The possibility of random occurrence of invalid areas smaller than the blocks in the user area M is high in comparison to the user area L. However, since data are written in units of multiple pages in the user area M, as illustrated in FIG. 8, the possibility that the status of every M-division area constituting a block becomes “Invalid” is high in the user area M in comparison to the user area S. Therefore, the provision of the user area M (in which data are written in units of areas being smaller than the blocks and corresponding to multiple pages) lowers the possibility of occurrence of data copying for securing a vacant area, and therefore increases the speed of random data writing.

Although operations performed in data overwriting are explained above, the above manner of management of the NAND flash memory further has an advantage that invalid pages are also unlikely to randomly occur when the CM 200a performs a writeback operation. The writeback operation is an operation performed by the CM 200a for writing the data stored in the cache area in the CM 200a, back into a backend storage area (e.g., the DE 400 in the present embodiment). For example, when the usage rate of the cache area in the CM 200a increases to a certain value, the CM 200a performs a writeback operation in order to increase the vacant area in the cache area. In addition, the CM 200a requests the CBU 300a to invalidate the data being stored in the NAND flash memory 331 and corresponding to the written-back data. At this time, it is desirable that the data which is requested to be invalidated be erased as soon as possible for increasing the vacant area (in which new data can be written).

As explained above, the CBU 300a distributes the write data to the user areas L, M, and S. When one or more writeback operations are completed, areas to be invalidated in the NAND flash memory 331 can occur on the division area basis in the user areas L, M, and S. In other words, none of the division areas in the user areas L, M, and S contains both of a part in which data is to be invalidated and another part in which valid data is written.

For example, when the data stored in the L-division area Al1 in “State 11” illustrated in FIG. 8, among the data stored in the cache area in the CM 200a, are written back, all the data in the entire L-division area Al1 become unnecessary and are therefore invalidated. Thus, the CBU 300a can immediately erase the data stored in the L-division area Al1, without copying into another division area, so that the CBU 300a can secure a vacant block in a short time. In addition, the load imposed on the data bus in the NAND flash memory 331 is not increased when the CBU 300a secures the vacant block as above. Therefore, it is possible to increase the speed of random data writing in the NAND flash memory 331.

Further, for example, when portions of the data stored in the cache area in the CM 200a corresponding to the data stored in the M-division areas Am1 and Am3 in “State 11” illustrated in FIG. 8 are written back, all the data in the entire M-division areas Am1 and Am3 become unnecessary and are therefore invalidated. Thus, the CBU 300a can immediately erase the data stored in the block constituted by the M-division areas Am1 and Am3, without copying into other division areas.

When a writeback operation is performed as in the above example of the M-division areas Am1 and Am3, the possibility of occurrence of invalid areas on the block-by-block basis in the user area M is higher than in the user area S. Therefore, the possibility of occurrence of data copying for securing a vacant area in the user area M is lower than in the user area S, and therefore the speed of random data writing in the user area M is higher than in the user area S.

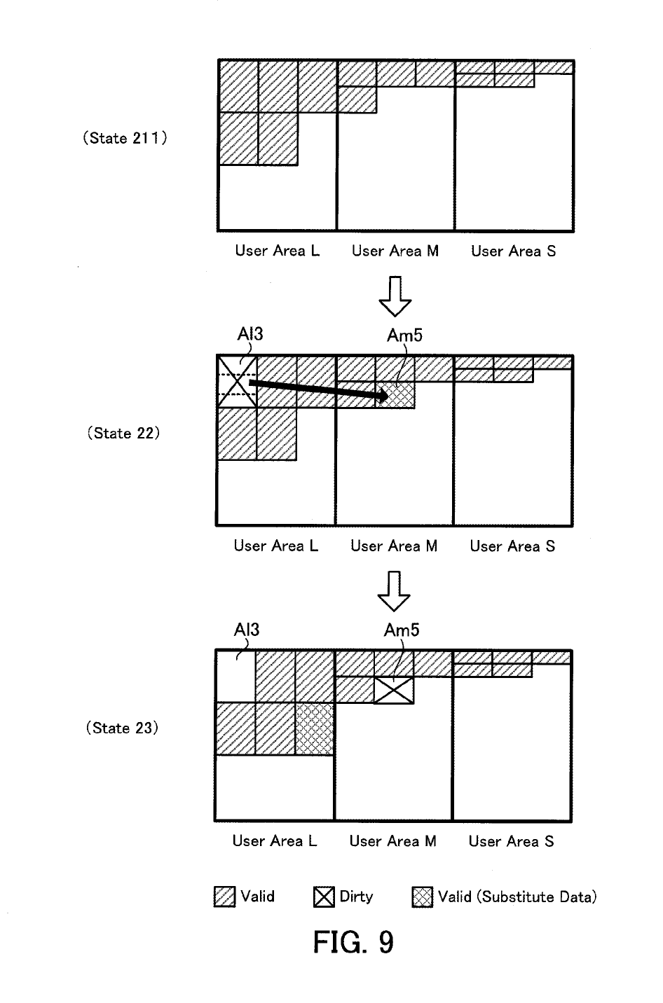

Furthermore, the advantage that invalid pages are unlikely to randomly occur in a writeback operation also occurs in the case where only part of data stored in a division area in th NAND flash memory 331 is overwritten as explained below with reference to FIG. 9. FIG. 9 illustrates an example of processing performed when only a part of data in a division area is overwritten.

Assume, for example, that the CBU 300a receives from the CM 200a a write request to overwrite only a part of the data stored in the L-division area Al3, in the state in which data are written in the user areas L, M, and S as in “State 21” illustrated in FIG. 9. In this case, the CBU 300a selects one or more division areas corresponding to the size of the substitute data with which the overwriting is requested, for example, as in “State 22” illustrated in FIG. 9. When the size of the substitute data with which the overwriting is requested is greater than the size of the page and equal to or smaller than the size of the M-division area, the CBU 300a writes in the M-division area Am5 in the user area M the substitute data with which the overwriting is requested. In addition, the CBU 300a invalidates only one or more pages in which the data requested to be overwritten, among the pages constituting the L-division area Al3. Then, the status of the L-division area Al3 is changed to “Dirty”, which indicates only part of the data in the L-division area Al3 is valid.

Further, assume that the CM 200a starts, in “State 22” as above, an operation of writing back the data corresponding to the L-division area Al3 and the L-division area Am5. In this case, all the data stored in the L-division area Al3 and the M-division area Am5 become unnecessary. At this time, the L-division area Al3 comes into a state in which the data can be immediately erased, while the status of the M-division area Am5 becomes “Dirty”, which indicates that the M-division area Am5 contains invalid data. Therefore, the CBU 300a can immediately erase the data stored in the L-division area Al3 as in “State 23” illustrated in FIG. 9, without copying into another division area.

As explained above, since the CM 200a performs the writeback operation, invalid pages are unlikely to randomly occur when the corresponding data in the NAND flash memory 331 is invalidated. Therefore, the possibility of occurrence of data copying for securing a vacant area is lowered, and therefore the speed of random data writing increases.

As mentioned before, when the CBU 300a writes data in the NAND flash memory 331, the CBU 300a writes the data in one or more division areas corresponding to the size of the data. Therefore, when the CM 200a performs a writeback operation, the data to be invalidated occurs on the division area basis in the NAND flash memory 331.

Assume, for example, that the host apparatus requests the CM 200a to write data D1, and the data D1 is written in the L-division area Al1 in the arrangement of the NAND flash memory 331 as illustrated in FIG. 8. Thereafter, in the case where the CM 200a writes back the data D1 stored in the cache area in the CM 200a, it is sufficient for the CBU 300a to invalidate the L-division area Al1 in the NAND flash memory 331.

On the other hand, assume, for example, that the host apparatus requests the CM 200a to write data D2, and the data D2 is written in the L-division area Al3 in the situation of the NAND flash memory 331 as illustrated in FIG. 9. Further assume that after the data D2 is written in the L-division area Al3, the host apparatus requests the CM 200a to overwrite a part of the data D2, and substitute data (new data) with which the part of the data D2 is to be overwritten is written in the M-division area Am5 as in “State 22” illustrated in FIG. 9. Thereafter, when the CM 200a writes back the data D2 stored in the cache area in the CM 200a, the CBU 300a is required only to invalidate the L-division area Al3 and the M-division area Am5 in the NAND flash memory 331.

As described above, when the CM 200a performs a writeback operation, data to be invalidated occur in the NAND flash memory 331 on the division area basis. Therefore, according to the present embodiment, the CM 200a manages division areas in the NAND flash memory 331 storing data which are also stored in the cache area, by using IDs identifying the division areas. When the CM 200a writes back data, the CM 200a requests the CBU 300a to invalidate data in the NAND flash memory 331 corresponding to the written-back data by informing the CBU 300a of a value of the ID corresponding to the written-back data.

In the case where the ID received from the CM 200a indicates an L-division area, the CBU 300a can immediately erase the data in the L-division area. In addition, the possibility that the CBU 300a can immediately erase data in a block containing an M-division area indicated by the ID being received from the CM 200a and indicating the M-division area is higher than the possibility that the CBU 300a can immediately erase data in a block containing an S-division area indicated by the ID being received from the CM 200a and indicating the S-division area. Therefore, according to the manner of management of the NAND flash memory 331 in the present embodiment, it is possible to reduce the average time needed by the CBU 300a for securing a vacant area in the NAND flash memory 331 when the CM 200a performs a writeback operation. In addition, since the load imposed on the data bus in the NAND flash memory 331 during the operation for securing a vacant area in the NAND flash memory 331 can be reduced, it is possible to suppress deterioration of the performance of random data writing in the NAND flash memory 331. Thus, when the CM 200a performs a writeback operation, the CM 200a can also write write data received from the host apparatus, in the NAND flash memory 331 at high speed, and can therefore return a reply to the host apparatus in a short time.

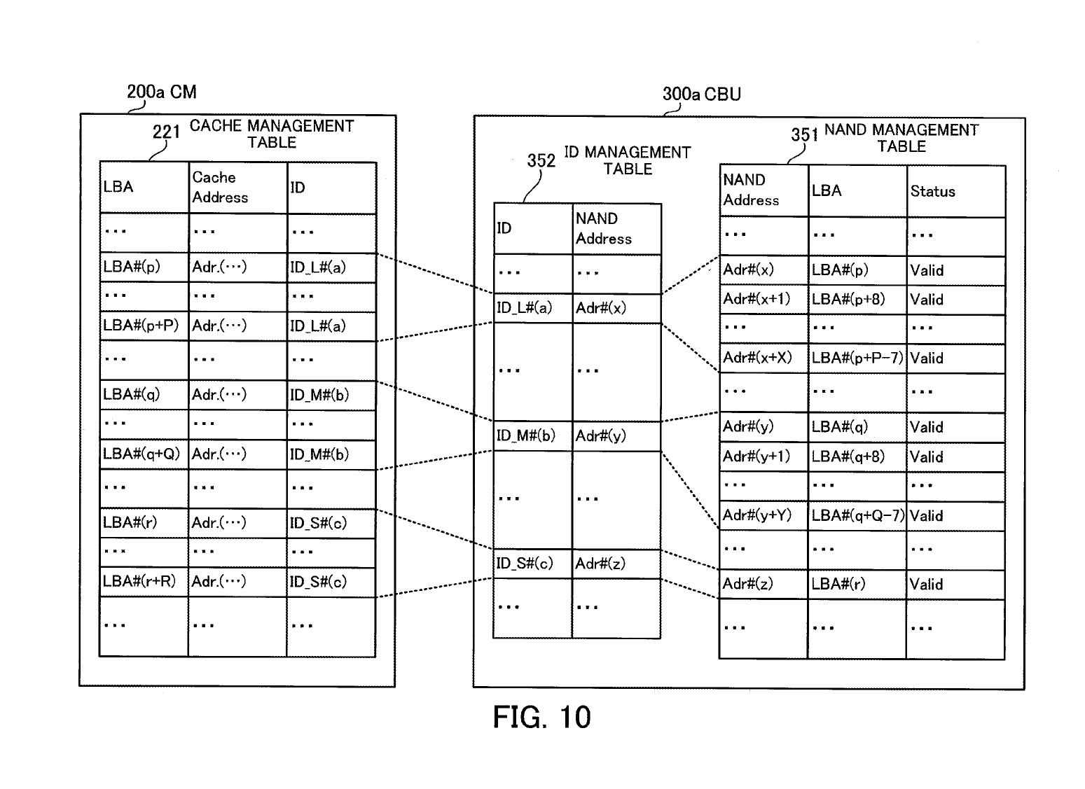

FIG. 10 illustrates examples of data tables for management of memory areas in the NAND flash memory. In order to facilitate the write control operations as explained with reference to FIGS. 7 to 9, a cache management table 221, a NAND management table 351, and an ID management table 352 illustrated in FIG. 10 are used in the storage system 100.

When the CPU 201 in the CM 200a starts execution of firmware for realizing the IO operations, the CPU 201 generates the cache management table 221 in the RAM 202 in the CM 200a. The cache management table 221 is used for managing the data stored in the cache area in the CM 200a.

The cache management table 221 contains records respectively corresponding to all the LBAs (logical block addresses) allocated to the data stored in the cache area. The LBA is a logical address indicating the minimum unit of data in access from the host apparatus 500a or 500b to the logical volumes provided by the CM 200a. As mentioned before, an LBA is allocated for every 512 bytes. In FIG. 10, for example, LBA#(p) indicates the LBA having the value “p”.

For example, when the host apparatus 500a or 500b requests the CM 200a to write data (write data) over multiple LBAs, records respectively corresponding to the multiple LBAs are held in the cache management table 221.

In each record in the cache management table 221, a cache address and an ID are recorded in association with each LBA. The cache address is an address at which the corresponding data is stored in the cache area (i.e., in the RAM 202), and the ID is identification information for identifying one or more division areas in the NAND flash memory 331 in the CBU 300a which backs up the corresponding set of data. As explained later, the table management unit 322 in the CBU 300a informs the CM 200a of the ID in the record in the cache management table 221.

On the other hand, when the CBU 300a is started by power-on or the like, the table management unit 322 in the CBU 300a generates in the RAM 202 in the CBU 300a the NAND management table 351 and the ID management table 352.

In the NAND management table 351, records respectively corresponding to all the pages in the NAND flash memory 331 are recorded in the NAND management table 351. In each record in the NAND management table 351, the LBA and the status in association with a value of a NAND address are recorded, where the NAND address is the address of the corresponding page in the NAND flash memory 331. In the following explanations, for example, “Adr#(x)” indicates the address in the NAND flash memory 331 having the value “x”.

The LBA in each record in the NAND management table 351 indicates a piece of data stored in the cache area in the CM 200a corresponding to the data stored in a page in the NAND flash memory 331. The status in each record in the NAND management table 351 is information indicating the data storing state in the corresponding page in the NAND flash memory 331, and is one of “Unused”, “Valid”, or “Invalid”, where “Unused” indicates that no data is stored, “Valid” indicates that valid data is stored, and “Invalid” indicates that invalid data is stored. Specifically, the status “Invalid” indicates that new data with which the data stored in the corresponding page is to be overwritten is stored in another page. When a data erasion operation is performed on a page the status of which is “Invalid”, the status of the page is changed to “Unused”.

The LBA in each record in the NAND management table 351 is recorded only when the status in the record is “Valid”. For example, when the CM 200a abnormally stops and the data backed up in the NAND flash memory 331 in the CBU 300a is read by the other CM 200b and written into the cache area in the CM 200b, the LBA in each record in the NAND management table 351 is read by the CM 200b together with data backed up in the NAND flash memory 331 in the CBU 300a. In this case, the CM 200b can take over the IO operations using the read data by using one or more LBAs which are read by the CBU 300b. Further, the values of the LBA in the records in the NAND management table 351 are referred to by the table management unit 322 when part of the data stored in the division areas in the NAND flash memory 331 is overwritten.

In the present embodiment, the size of data associated with each LBA is one-eighth of the page size. Therefore, in the case where a set of data is written over multiple adjacent pages, LBAs in increments of eight are recorded in association with the multiple adjacent pages in the NAND management table 351.

The ID management table 352 is used by the table management unit 322 for managing division areas in which data are written, among the division areas in the NAND flash memory 331. The ID management table 352 holds records respectively for the division areas in which valid or invalid data are written. A value of the ID and a value of the NAND address are recorded in each record in the ID management table 352.

The ID in the ID management table 352 is identification information which is uniquely assigned to a corresponding division area by the table management unit 322. The ID in the ID management table 352 contains information which enables identification of the type of the corresponding division area (L-, M-, or S-division area). In FIG. 10, for example, ID_L#(a) indicates an ID being assigned to an L-division area and having the value “a”, ID_M#(b) indicates an ID being assigned to an M-division area and having the value “b”, and ID_S#(c) indicates an ID being assigned to an S-division area and having the value “c”.

The NAND address in the ID management table 352 is the leading address of the corresponding division area in the NAND flash memory 331. For example, in FIG. 10, the L-division area to which ID_L#(a) is assigned corresponds to the pages having the NAND addresses Adr#(x) to Adr#(x+X).

Before receiving a data-write request from the CM 200a, the table management unit 322 in the CBU 300a generates one or more IDs indicating one or more division areas corresponding to the size of the write data, and informs the CM 200a of the one or more IDs. When the write data transferred from the CM 200a is written in the one or more division areas, the table management unit 322 in the CBU 300a records in the ID management table 352 one or more records containing the one or more leading addresses of the one or more division areas (in which the write data is written) and the one or more IDs (of which the CM 200a is informed).

On the other hand, the CM 200a records in the cache management table 221 the one or more IDs of which the CM 200a is informed by the CBU 300a, in correspondence with one or more LBAs of the write data in the cache area. Thereafter, when the data stored in the cache area is written back into a backend memory area, the CM 200a requests the CBU 300a to invalidate the invalidated data. When the written-back data is invalidated, the CM 200a informs the CBU 300a of the one or more IDs corresponding to the written-back data (which are recorded in the cache management table 221) instead of the one or more LBAs of the written-back data.

As explained above, since the CM 200a is informed of the one or more IDs indicating one or more division areas in the NAND flash memory 331 in which data stored in the cache area is backed up, when data writeback is performed, the CM 200a can easily indicate to the CBU 300a an area in the NAND flash memory 331 in which backup data corresponding to the written-back data is stored.

2.4.3 Details of Operations in Entire Storage System

Hereinbelow, details of operations performed in the entire storage system 100 for realizing the operations explained in the above sections 2.4.1 and 2.4.2 are explained.

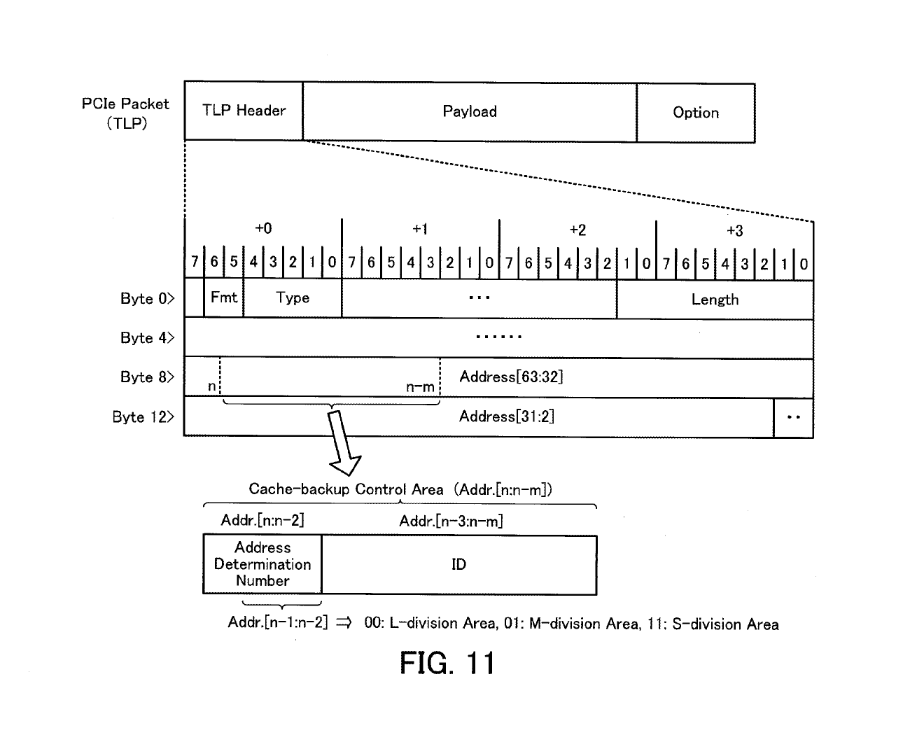

FIG. 11 illustrates an example of a structure of a packet transmitted or received through the PCIe bus. According to the PCI Express standard, the PCIe packet in the transaction layer (i.e., transaction layer packet (TLP)) contains a TLP header, a payload, and an option, where data are contained in the payload.

The TLP header contains the fields of “Fmt”, “Type”, “Length”, and “Address”. The type of each PCIe packet is determined by the information set in the fields “Fmt” and “Type”. In the present embodiment, the PCIe packets are a write-request packet, a read-request packet, or a control packet.

In the field “Address”, a write address is set when the PCIe packet is a write-request packet, and a read address is set when the PCIe packet is a read-request packet. In many cases, a certain number of significant bits in the field “Address” are not used. Therefore, according to the present embodiment, the CMs and CBUs use the most significant (m+1) bits in the field “Address” as a cache-backup control area. In the following explanations, the cache-backup control area of significant (m+1) bits with the most significant bit n (the n-th bits) may be indicated as “Addr[n:n−m]”.

An address determination number is set in the significant three bits “Addr[n:n−2]” in the cache-backup control area. As explained later, the IO control unit 310 can determine the destination of a PCIe packet received through the PCIe bus, on the basis of the combination of the position (the CM side or the CBU side) of the port through which the PCIe packet is received, the packet type determined by the information “Fmt” and “Type”, and the address determination number.

The CMs and CBUs can set the ID for identifying a division area in the least significant (m−2) bits “Addr[n−3:n−m]” in the cache-backup control area. In other words, each of the CMs and CBUs can inform another of the CMs and CBUs of the ID by using the least significant (m−2) bits in the cache-backup control area. In the case where the ID is set in the least significant (m−2) bits in the cache-backup control area, a value unique to the type of the division area (L-, M-, or S-division area) indicated by the ID is set in the least significant two bits “Addr[n−1:n−2]” in the address determination number. As indicated in FIG. 11, it is assumed that the value “00” in the least significant two bits indicates the L-division area, the value “01” in the least significant two bits indicates the M-division area, and the value “11” in the least significant two bits indicates the S-division area.

Further, in some cases, a value which is set in the area (which is hereinafter simply referred to as “less-significant area”) located on the less significant side of the cache-backup control area in the field “Address” is used for identifying the operation which the recipient of the packet is requested to perform.

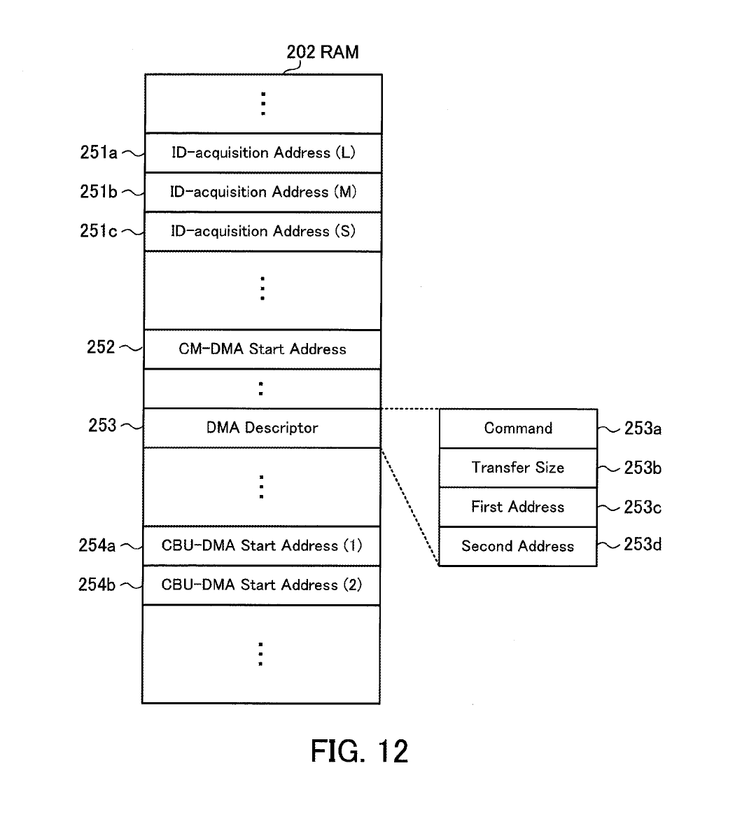

FIG. 12 illustrates examples of a control area allocated on a RAM in a CM.

The CPU 201 in the CM 200a secures the control area in the RAM 202 and stores values in the control area as illustrated in FIG. 12, by executing firmware. Specifically, predetermined values of ID-acquisition addresses 251a to 251c, a CM-DMA start address 252, and CBU-DMA start addresses 254a and 254b are written in the RAM 202 by the CPU 201 executing the firmware.

When the CPU 201 in the CM 200a receives a new data-write request from the host apparatus 500a or 500b, the ID-acquisition addresses 251a to 251c are read out by the CPU 201 for acquiring the ID from the CBU 300a. The ID-acquisition addresses 251a to 251c are respectively used for acquiring the values of the ID of the L-, M-, and S-division areas.

The CPU 201 requests the CBU 300a to send the ID of a division area corresponding to one of the ID-acquisition addresses 251a to 251c, by transmitting a read-request packet onto the PCIe bus in which the one of the ID-acquisition addresses 251a to 251c is set in the less-significant area in the field “Address”. After the CPU 201 acquires the ID, the CPU 201 informs the CBU 300a of one or more LBAs associated with the acquired ID, by transmitting onto the PCIe bus a write-request packet in which the same ID-acquisition address is set in the less-significant area in the field “Address”.

The CM-DMA start address 252 and the DMA descriptor 253 are used when the CPU 201 requests the DMA controller 203a to perform DMA transfer. The CM-DMA start address 252 is read out by the CPU 201 in order to start the DMA controller 203a. In the DMA descriptor 253, information referred to by the DMA controller 203a is written by the CPU 201. Specifically, a command 253a, transfer size 253b, a first address 253c, and a second address 253d are set in the DMA descriptor 253.

The command 253a indicates the direction of the DMA transfer, i.e., whether the DMA transfer is a transfer from the RAM 202 to the outside of CM 200a or a transfer from the outside of the CM 200a to the RAM 202. The transfer size 253b indicates the size of the data subject to the DMA transfer.

In the case where a transfer from the RAM 202 to the outside of CM 200a is requested, the source address in the RAM 202 is set as the first address 253c, and the destination address outside the CM 200a is set as the second address 253d. In this case, the DMA controller 203a transmits onto the PCIe bus a write-request packet requesting writing of data read out from the RAM 202 at an address in an external memory area which is set as the second address 253d.

On the other hand, in the case where a transfer from the outside of CM 200a to the RAM 202 is requested, the destination address in the RAM 202 is set as the first address 253c, and the source address outside the CM 200a is set as the second address 253d. In this case, the DMA controller 203a transmits onto the PCIe bus a read-request packet requesting readout of data from an address in an external memory area which is set as the second address 253d.

In either of the above cases, the value which is set in the transfer size 253b is contained in the field “Length” in the write-request packet or the read-request packet.

One or both of the CBU-DMA start addresses 254a and 254b are read out by the CPU 201 in the CM 200a in order to start the DMA controller 323 in the CBU 300b. The DMA controller 323 in the CBU 300b is started by the CPU 201 in the CM 200a when the other CM 200b abnormally stops, for writing back into the DE 400 the data stored in the NAND flash memory 331 in the CBU 300b and restoring IO operations which have been performed in the CM 200b before the abnormal stop of the CM 200b. The CBU-DMA start addresses 254a and 254b indicate the leading addresses of buffer areas secured in the RAM 202 in the CM 200a by the CPU 201 in the CM 200a for writing back data. The multiple CBU-DMA start addresses 254a and 254b are provided for enabling provision of multiple buffer areas. The CPU 201 in the CM 200a causes the DMA controller 323 in the CBU 300b to transmit data stored in the NAND flash memory 331, by sending to the CBU 300b a read-request packet in which one or both of the CBU-DMA start addresses read out from the RAM 202 are set in the field “Address”.

2.4.4 Sequences for Duplexing Write Data

Hereinbelow, sequences of operations for duplexing write data are explained mainly with reference to sequence diagrams.

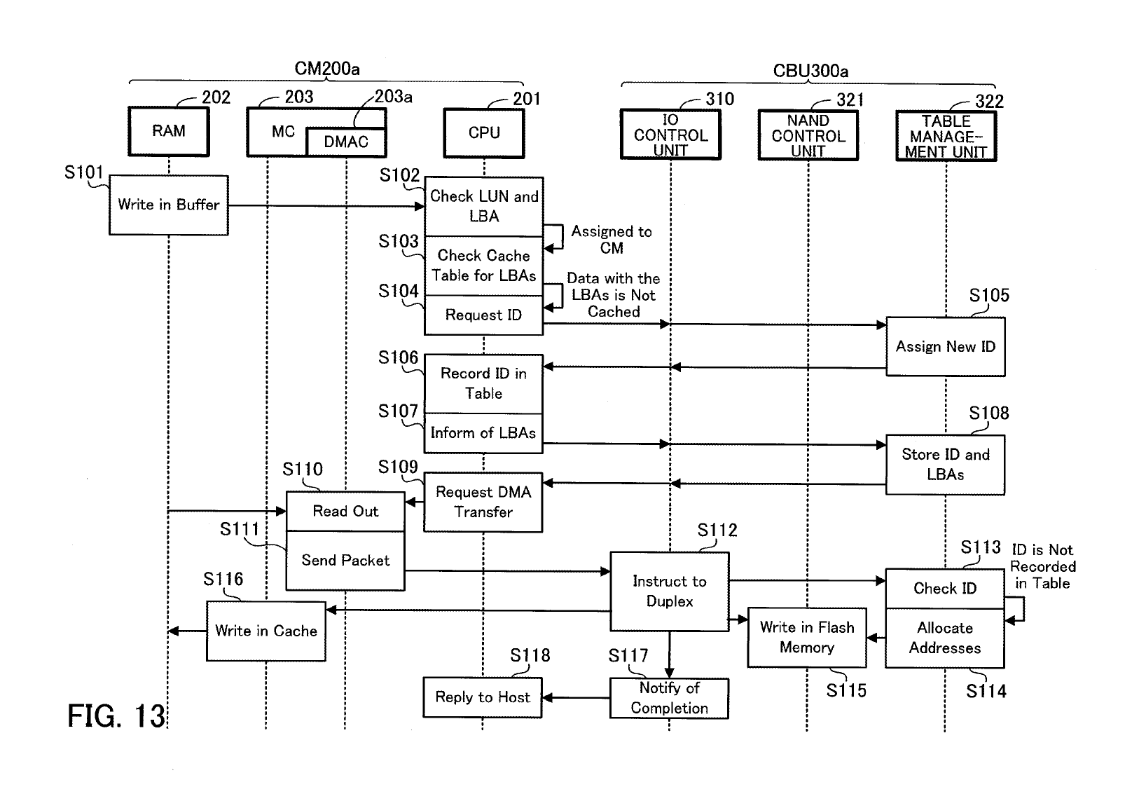

First, examples of sequences of operations performed, for example, when the CM 200a receives a request for writing in a logical volume the access control to which is assigned to the CM 200a per se are explained below with reference to FIGS. 13 to 18.

2.4.4.1 First Sequence for Duplexing Write Data

FIG. 13 is a first sequence diagram indicating a first example of a sequence of operations performed when a CM receives a request for writing in a logical volume the access control to which is assigned to the CM per se.

<Step S101> The host apparatus 500a or 500b requests the CM 200a to perform a write operation and transmit write data to the CM 200a. The write data received by the CM 200a is written in the buffer area 202a in the RAM 202 through the host interface 205 and the memory controller 203.

<Step S102> The CPU 201 in the CM 200a refers to the number (specifically, the logical unit number (LUN)) of the logical volume to which the write data requested to be written belongs and one or more LBAs of the write data, and determines whether or not the write data belongs to a logical volume the access control to which is assigned to the CM 200a per se. In the example of FIG. 13, the write data is assumed to belong to a logical volume the access control to which is assigned to the CM 200a.

<Step S103> The CPU 201 determines whether or not the one or more LBAs of the received write data are recorded in the cache management table 221. In the example of FIG. 13, the one or more LBAs of the received write data are assumed not to be recorded in the cache management table 221. In this case, the CPU 201 determines that the received write data is data to be newly written in the cache area 202b. The CPU 201 generates in the cache management table 221 one or more records corresponding to the one or more LBAs of the received write data, and records the one or more LBAs in the respectively corresponding records. In the example of FIG. 13, it is assumed that the CPU 201 records LBA#(p) to LBA#(p+P) in the cache management table 221 in step S103.

<Step S104> The CPU 201 sends a PCIe packet to the CBU 300a for requesting the CBU 300a to inform the CPU 201 of the ID. Specifically, the CPU 201 determines the type of the division area (L-, M-, or S-division area) in which the write data is to be stored in the NAND flash memory 331 of the CBU 300a, on the basis of the size of the received write data. Specifically, when the size of the write data is equal to or smaller than the size of the S-division area, the CPU 201 determines that the write data is to be stored in an S-division area. When the size of the write data is greater than the size of the S-division area and equal to or smaller than the size of the M-division area, the CPU 201 determines that the write data is to be stored in an M-division area. When the size of the write data is greater than the size of the M-division area and equal to or smaller than the size of the L-division area, the CPU 201 determines that the write data is to be stored in an L-division area.

The CPU 201 requests the CBU 300a to inform the CPU 201 of the ID indicating the determined type of division area. For example, assume that the write data is determined to be stored in an L-division area. The CPU 201 generates a read-request packet which contains, in the area of the address determination number in the cache-backup control area, a value for designating the CBU 300a as the destination and also designating the L-division area as the type of division area. In addition, the CPU 201 reads out from the control area on the RAM 202 the ID-acquisition address 251a for the L-division area, and sets the ID-acquisition address 251a in the less-significant area in the field “Address” in the above read-request packet. Then, the CPU 201 sends the read-request packet to the CBU 300a through the memory controller 203 and the PCIe bus.

<Step S105> The IO control unit 310 in the CBU 300a receives the above read-request packet. The table management unit 322 in the CBU 300a recognizes that informing of an ID is requested, on the basis of the value which is set in the less-significant area in the field “Address” and the recognition that the received packet is a read-request packet.

The table management unit 322 determines, on the basis of the value represented by the least significant two bits of the address determination number, that informing of an ID of the L-division area is requested. Then, the table management unit 322 generates an ID having a unique value to be assigned to an L-division area. For example, assume that ID_L#(a) as illustrated in FIG. 10 is generated. The table management unit 322 sends a reply packet to the CM 200a through the control unit 310, where the generated ID is set in the least significant bits (“Addr[n−3:n−m]”) in the cache-backup control area in the reply packet.

Although, in the present embodiment, the CPU 201 in the 200a determines the type of the division area corresponding to the size of the write data in step S104, alternatively, the type of the division area may be determined by the CBU 300a. In this case, for example, in step S104, the CPU 201 in the CM 200a informs the CBU 300a of the size of the write data. Thereafter, in step S105, the table management unit 322 in the CBU 300a determines the type of the division area corresponding to the size of which the CBU 300a is informed, generates an ID corresponding to the determined type, and informs the CM 200a of the ID.

<Step S106> The CPU 201 in the CM 200a extracts the ID from the reply packet sent from the CBU 300a, and records the extracted ID in the one or more records generated in the cache management table 221 in step S103. In this example, ID_L#(a) is assigned in correspondence with each of LBA#(p) to LBA#(p+P) as illustrated in FIG. 10. Thus, the ID is associated with the write data.

<Step S107> The CPU 201 informs the CBU 300a of one or more LBAs associated with the ID of which the CPU 201 is informed by the CBU 300a, by transmitting a PCIe packet addressed to the CBU 300a. Specifically, the CPU 201 generates a write-request packet. The CPU 201 sets a value for designating the CBU 300a as the destination in the cache-backup control area in the write-request packet, and sets the ID-acquisition address 251a for the L-division area in the less significant area in the field “Address” in the write-request packet. Furthermore, the CPU 201 sets the leading LBA and the size of the write data in the payload and the field “Length”, respectively, in the write-request packet, and sends the write-request packet to the CBU 300a through the memory controller 203 and the PCIe bus.

<Step S108> The IO control unit 310 in the CBU 300a receives the above write-request packet. Then, the table management unit 322 in the CBU 300a recognizes that the CBU 300a is informed of the one or more LBAs, on the basis of the type of the received packet as a write-request packet and the value which is set in the less-significant area in the field “Address”. The table management unit 322 extracts from the write-request packet the leading LBA and the size of the write data, and temporarily stores in the RAM 332 the extracted information in association with the ID assigned in step S105. In addition, the table management unit 322 sends a reply packet to the CM 200a through the IO control unit 310.

<Step S109> When the CPU 201 in the CM 200a receives the above reply packet, the CPU 201 starts the DMA controller 203a, and requests DMA transfers for duplexing the write data. Specifically, the CPU 201 starts the DMA controller 203a by reading out the CM-DMA start address 252 (as illustrated in FIG. 12) from the RAM 202 and informing the memory controller 203 of the CM-DMA start address 252. In addition, the CPU 201 causes the DMA controller 203a to perform a DMA write operation in the cache area 202b in the RAM 202 as the destination, by making the following settings in the DMA descriptor 253 (as illustrated in FIG. 12).

That is, the CPU 201 sets as the command 253a a value indicating a transfer from the RAM 202 to the outside, so that the DMA controller 203a can generate a write-request packet on the basis of the setting of the command 253a. In addition, the CPU 201 sets as the transfer size 253b the size of the write data which is to be duplexed, so that the DMA controller 203a includes in the field “Length” in the write-request packet the value which is set as the transfer size 253b. Further, the CPU 201 sets as the first address 253c one or more addresses in the buffer area 202a in the RAM 202 at which the write data is to be stored. Furthermore, the information which is set as the second address 253d is inserted in the field “Address” in the write-request packet transmitted from the DMA controller 203a. For this purpose, the CPU 201 determines one or more (write) addresses in the cache area 202b in the RAM 202 at which the write data is to be stored, and sets the leading one of the determined one or more (write) addresses, in an area of the second address 253d which corresponds to the less-significant area in the field “Address”. At the same time, the CPU 201 sets, in an area of the second address 253d which corresponds to the cache-backup control area in the field “Address”, an address determination number indicating the CBU 300a as the destination and the ID of which the CBU 300a is to be informed. In addition to the above settings, the CPU 201 records the one or more (write) addresses in the cache area 202b determined as above, in the one or more records generated in the cache management table 221 in step S103.

<Step S110> The DMA controller 203a reads out from the buffer area 202a in the RAM 202 the write data written in step S101.

<Step S111> The DMA controller 203a generates a write-request packet containing the write data which is read out in step S110, on the basis of the information which is set in the DMA descriptor 253 in step S109. In the write-request packet, the ID of which the CBU 300a is informed in step S105 (which is ID_L#(a) in this example), the one or more (write) addresses in the cache area 202b, the size of the write data, and other information are set. Then, the DMA controller 203a sends the write-request packet to the CBU 300a.

<Step S112> The IO control unit 310 in the CBU 300a receives the above write-request packet, stores the received write-request packet in the buffer memory 311, and performs operations for duplexing the write data contained in the write-request packet. Specifically, the control unit 310 instructs the NAND control unit 321 and the table management unit 322 to perform operations for writing the write data in the NAND flash memory 331. For example, the IO control unit 310 instructs the table management unit 322 to read the ID which is set in the write-request packet, and instructs the NAND control unit 321 to write the write data at the one or more addresses in the NAND flash memory 331 of which the NAND control unit 321 is informed by the table management unit 322. In addition, the IO control unit 310 transfers the received write-request packet to the CM 200a for requesting the CM 200a to write the write data in the cache area 202b.

<Step S113> The table management unit 322 determines whether or not the ID which is set in the write-request packet is recorded in the ID management table 352. In the example of FIG. 13, the ID is newly assigned in step S105, so that the ID is not yet recorded in the ID management table 352 at this stage.

<Step S114> When it is determined in step S113 that the ID is not recorded in the ID management table 352, the table management unit 322 records the ID in the ID management table 352 in such a manner that the type of the division area (L-, M-, or S-division area) corresponding to the ID can be recognized.

In addition, the table management unit 322 allocates one or more addresses of a division area for the ID. Specifically, by reference to the NAND management table 351, the table management unit 322 chooses a division area in which the status of every page is “Unused”, from among the division areas of the type corresponding to the ID. In this example, the ID is ID_L#(a), which indicates the L-division area, so that the table management unit 322 chooses an L-division area in which the status of every page is “Unused”. The table management unit 322 generates a record in the ID management table 352, and records in the generated record the ID and the leading address of the chosen division area in the NAND flash memory 331. In this example, a record in which ID_L#(a) is associated with Adr#(x) as illustrated in FIG. 10 is recorded in the ID management table 352. Further, the table management unit 322 records in the NAND management table 351 the one or more LBAs of the write data respectively in correspondence with one or more addresses of the chosen division area. Specifically, the table management unit 322 reads out the leading LBA and the size which are temporarily stored in the RAM 332 in step S108. Then, the table management unit 322 records the leading LBA read out as above, in the record corresponding to the leading address of the chosen division area. Subsequently, in the case where the write data is stored in multiple pages in the NAND flash memory 331, the table management unit 322 repeats an operation of recording an LBA greater than the LBA recorded in the preceding record by eight in a record corresponding to the next address in the NAND management table 351 until LBAs are recorded in all the records in the number corresponding to the size read out from the RAM 332 in step S108. Thus, in the NAND management table 351, the one or more LBAs corresponding to the write data are respectively associated with one or more addresses of the portions, corresponding to the one or more LBAs, of the write data in the NAND flash memory 331. In the case where the chosen division area is an S-division area, the LBA is recorded in only one record in the NAND management table 351.

For example, assume that the table management unit 322 assigns to ID_L#(a) the L-division area which is located at the addresses from Adr#(x) through Adr#(x+X) in the NAND flash memory 331 as indicated in FIG. 10. In addition, for example, in the case where the size of the write data is equal to the size of the L-division area, the LBAs are recorded in all the records corresponding to the addresses Adr#(x) to Adr#(x+X) in the NAND management table 351. In the case where the size of the write data is smaller than the size of the L-division area, one or more LBAs are recorded in records corresponding to only part of the addresses Adr#(x) to Adr#(x+X).

<Step S115> The table management unit 322 informs the NAND control unit 321 of the one or more addresses in the NAND flash memory 331 which are recorded in the NAND management table 351 in step S114. The NAND control unit 321 successively reads out the write data from the payload in the write-request packet stored in the buffer memory 311 in step S112, and writes the write data at the one or more addresses in the NAND flash memory 331 of which the NAND control unit 321 is informed by the table management unit 322. In addition, the table management unit 322 updates to “Valid” the status of the one or more records corresponding to the one or more addresses at which the write data is written by the NAND control unit 321. For example, in the case where the write data is written over all the areas corresponding to the addresses Adr#(x) to Adr#(x+X), the status of every record corresponding to one of the addresses Adr#(x) to Adr#(x+X) is updated to “Valid”.

<Step S116> When the CM 200a receives the write-request packet transferred in step S112 by the CBU 300a, the memory controller 203 in the CM 200a writes the write data contained in the write-request packet, at the one or more addresses in the cache area 202b which are set in the write-request packet.

As a result of the above operations, the write data is duplexed in the cache area 202b in the CM 200a and the NAND flash memory 331 in the CBU 300a. Further, the operation in step S112 for sending the write-request packet from the IO control unit 310 in the CBU 300a to the CM 200a may be performed in parallel with the operation in step S115 for transferring the write data from the buffer memory 311 to the NAND flash memory 331.

<Step S117> The IO control unit 310 in the CBU 300a notifies the CM 200a of completion of the duplexing, by an interruption through the PCIe bus.

<Step S118> When the CPU 201 in the CM 200a receives from the CBU 300a the notification of the completion of the duplexing, the CPU 201 returns to the host apparatus a reply notifying the host apparatus of the completion of the writing.

2.4.4.2 Second Sequence for Duplexing Write Data

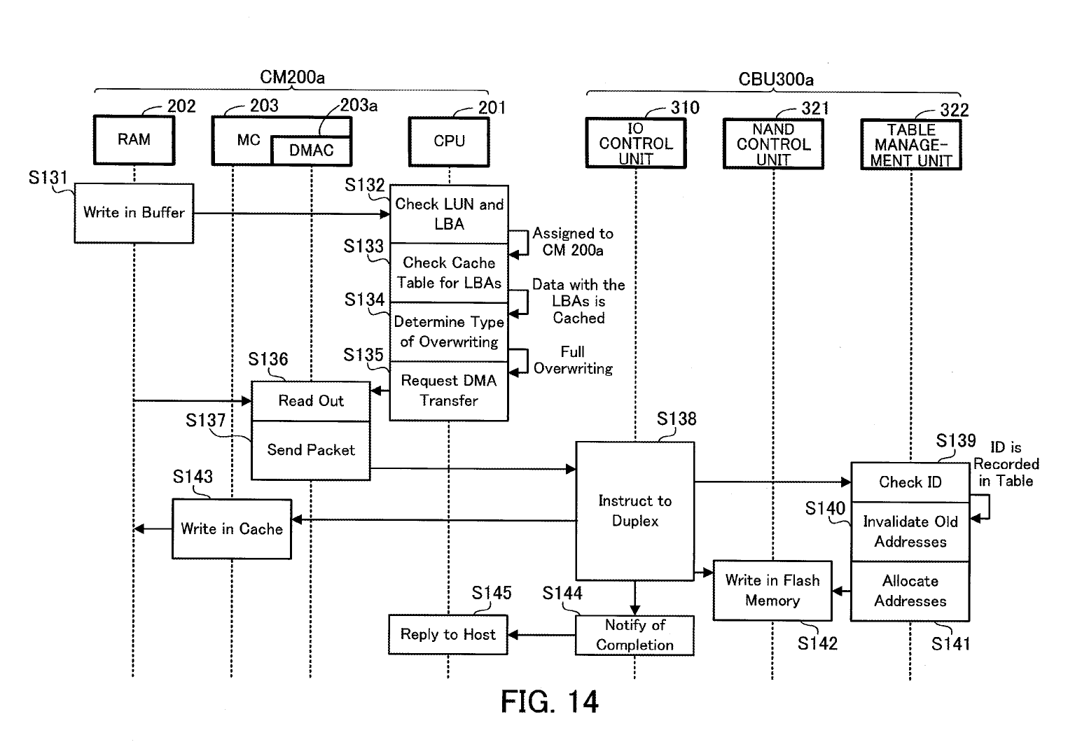

FIG. 14 is a second sequence diagram indicating a second example of a sequence of operations performed when a CM receives a request for writing in a logical volume the access control to which is assigned to the CM per se. The operations indicated in FIG. 14 are performed when a write request for overwriting of the whole data which has been written by the sequence of FIG. 13 is transmitted from the host apparatus 500a or 500b to the CM 200a.

<Step S131> The host apparatus transmits to the CM 200a substitute data corresponding to one or more LBAs identical to the one or more IBAs of the aforementioned data written in response to the aforementioned write request made by the host apparatus in step S101 illustrated in FIG. 13, and requests the CM 200a to write the transmitted substitute data. The substitute data received by the CM 200a is written in the buffer area 202a in the RAM 202 through the host interface 205 and the memory controller 203.

<Step S132> The CPU 201 in the CM 200a refers to the LUN of the logical volume to which the substitute data requested to be written belongs and one or more LBAs of the substitute data, and determines whether or not the substitute data belongs to a logical volume the access control to which is assigned to the CM 200a per se. In the example of FIG. 14, the substitute data is assumed to belong to a logical volume the access control to which is assigned to the CM 200a.

<Step S133> The CPU 201 determines whether or not the one or more LBAs of the received substitute data are recorded in the cache management table 221. In the example of FIG. 14, the one or more LBAs of the received substitute data are assumed to be LBA#(p) to LBA#(p+P), which are recorded in the cache management table 221. In this case, the CPU 201 determines that data being already stored in the cache area 202b and corresponding to LBA#(p) to LBA#(p+P) is to be overwritten with the received substitute data.

<Step S134> The CPU 201 determines whether the type of the overwriting requested by the host apparatus is full overwriting or partial overwriting. For example, the CPU 201 determines that partial overwriting is requested, in the case where the address range of the received substitute data is within the address range of a set of data which is cached in the cache area 202b and the size of the received substitute data is smaller than the size of the set of data. Specifically, the CPU 201 determines that partial overwriting is requested, in the case where the range of LBAs of the received substitute data is included in and is not identical to the range of a set of consecutive LBAs recorded in the cache management table 221.

On the other hand, the CPU 201 determines that full overwriting is requested, in the case where the range of LBAs of the received substitute data is identical to the range of LBAs of a set of data which is cached in the cache area 202b. Further, the CPU 201 can also determine that full overwriting is requested, in the case where the range of LBAs of the received substitute data is included in the range of LBAs of a set of data which is cached in the cache area 202b and the size of the received substitute data is greater than the range of LBAs of the set of data which is cached in the cache area 202b.

As mentioned before, in the example of FIG. 14, both of the range of LBAs of the received substitute data and the range of LBAs of a set of data which is cached in the cache area 202b are LBA#(p) to LBA#(p+P), the CPU 201 can determine that full overwriting is requested. In this case, operations for duplexing the received substitute data are started, without acquiring a new ID from the CBU 300a, as indicated in the following step S135.

<Step S135> The CPU 201 starts the DMA controller 203a, and requests DMA transfers for duplexing the received substitute data. The operations in step S135 are similar to the operations in step S109 in FIG. 13 except the following operations.

That is, the CPU 201 reads out from the cache management table 221 the ID associated with the one or more LBAs of the received substitute data, and sets the ID in an area in the second address 253d in the DMA descriptor 253 corresponding to the cache-backup control area. Therefore, the CPU 201 can determine, by itself, the ID of the division area in the NAND flash memory 331 in which the (received) substitute data is to be written, and indicate the determined ID to the CBU 300a. In this example, the ID which is set in the DMA descriptor 253 is ID_L#(a).

<Step S136> The DMA controller 203a reads out the substitute data written in step S131, from the buffer area 202a in the RAM 202.

<Step S137> The DMA controller 203a sends to the CBU 300a a write-request packet containing the substitute data which is read out in step S136. In the write-request packet, the ID (ID_L#(a) in this example) which is set in the DMA descriptor 253 by the CPU 201 in step S135, the one or more write addresses in the cache area 202b, the size of the substitute data, and other information are set.

<Step S138> The IO control unit 310 in the CBU 300a stores the received write-request packet in the buffer memory 311, and performs operations for duplexing the substitute data contained in the write-request packet. The IO control unit 310 instructs the NAND control unit 321 and the table management unit 322 to perform operations for writing the substitute data in the NAND flash memory 331. In addition, the IO control unit 310 transfers the received write-request packet to the CM 200a for requesting the CM 200a to write the substitute data in the cache area 202b.

<Step S139> The table management unit 322 determines whether or not the ID which is set in the write-request packet is recorded in the ID management table 352. In the example of FIG. 14, ID_L#(a) is set in the write-request packet and is already recorded in the ID management table 352. In this case, the operations in step S140 are performed.

<Step S140> The table management unit 322 chooses from the ID management table 352 a record containing the ID which is set in the write-request packet, and extracts the address in the NAND flash memory 331 which is recorded in the chosen record. Then, the table management unit 322 chooses from the NAND management table 351 one or more records corresponding to the division area indicated by the ID which is set in the write-request packet, on the basis of the address extracted from the ID management table 352, and changes the status of each of the one or more records chosen as above to “Invalid”.

<Step S141> The table management unit 322 allocates the address of a new division area for the ID which is set in the write-request packet. Specifically, by reference to the NAND management table 351, the table management unit 322 chooses a division area in which the status of every page is “Unused”, from among the division areas of the type corresponding to the ID.

The table management unit 322 updates one of the records in the ID management table 352 containing the ID which is set in the write-request packet, by overwriting with the leading address of the newly chosen division area. In addition, the table management unit 322 records in the NAND management table 351 the one or more LBAs of the substitute data respectively in correspondence with the one or more addresses of the newly chosen division area. At this time, the table management unit 322 copies the one or more LBAs recorded in the one or more records the status of which is changed to “Invalid” in step S140, into one or more records containing the one or more addresses of the newly chosen division area.

<Step S142> The table management unit 322 informs the NAND control unit 321 of the one or more addresses in the NAND flash memory 331 which are recorded in the NAND management table 351 in step S141. The NAND control unit 321 successively reads out the substitute data from the payload in the write-request packet stored in the buffer memory 311 in step S138, and writes the substitute data at the one or more addresses in the NAND flash memory 331 of which the NAND control unit 321 is informed by the table management unit 322 as above. In addition, the table management unit 322 updates to “Valid” the status of the one or more records corresponding to the one or more addresses at which the substitute data is written by the NAND control unit 321.

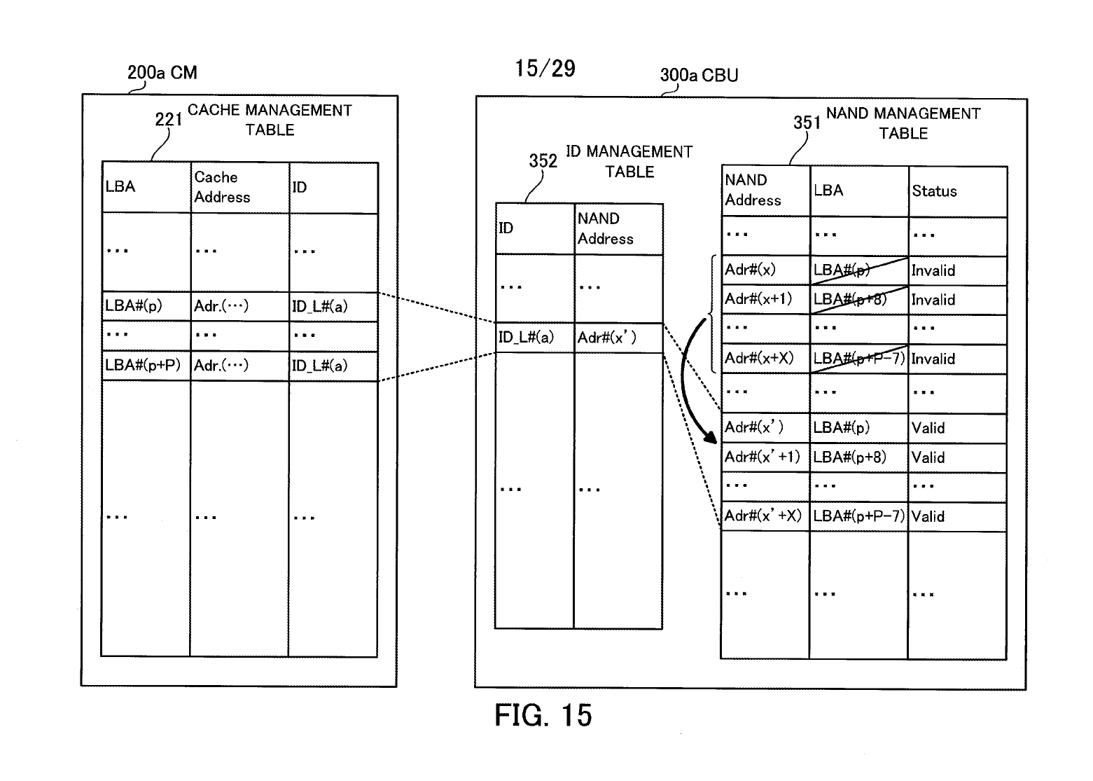

FIG. 15 illustrates examples of states of the tables when operations for full overwriting are performed.

ID_L#(a) is set in the write-request packet received by the IO control unit 310 in step S138. In step S140 in FIG. 14, the table management unit 322 extracts, from the ID management table 352, Adr#(x) associated with ID_L#(a) (as illustrated in FIG. 10), and determines the area in the NAND flash memory 331 allocated for ID_L#(a). As indicated in FIG. 15, the table management unit 322 updates to “Invalid” the status of each of the records corresponding to Adr#(x) to Adr#(x+X), which are the addresses of the L-division area to which ID_L#(a) is assigned.

In addition, in step S141 in FIG. 14, the table management unit 322 chooses an L-division area in which the status of every page is “Unused”. In the example of FIG. 15, the addresses of the new L-division area are Adr#(x′) to Adr#(x′+X). The table management unit 322 updates the address recorded in the record containing ID_L#(a) among the records in the ID management table 352 to Adr#(x′), which is the leading address of the newly chosen L-division area.

Further, in step S142 in FIG. 14, the table management unit 322 copies the LBAs (LBA#(p) to LBA#(p+P-7)) associated with the addresses (Adr#(x) to Adr#(x+X)) of the precedingly used L-division area, into the records containing the addresses (Adr#(x′) to Adr#(x′+X)) of the new L-division area, in the NAND management table 351. After the copying of the LBAs is completed, the table management unit 322 deletes from the NAND management table 351 the LBAs (LBA#(p) to LBA#(p+P−7)) associated with the addresses (Adr#(x) to Adr#(x+X)) of the precedingly used L-division area.

As explained above, in the case of full overwriting, the ID for identifying the division area is not changed, and the physical area corresponding to the division area is changed. In addition, the status of every page in the precedingly used division area (before the change) becomes “Invalid” or “Unused”. Therefore, in the case where the data in an L-division area is fully overwritten, the CBU 300a can erase the data in the precedingly used L-division area (block) without copying the data into another block. In the example of FIG. 15, the addresses Adr#(x) to Adr#(x+X) constitute a block. Therefore, the CBU 300a can erase the data stored in the block without copying the data into another block.

Referring back to FIG. 14, the operation goes to step S143 after completion of the operation in step S142.

<Step S143> When the CM 200a receives the write-request packet transmitted in step S138 by the CBU 300a, the memory controller 203 in the CM 200a writes the substitute data contained in the write-request packet, at the one or more addresses in the cache area 202b which are set in the write-request packet. Thus, the whole data previously stored at the one or more addresses in the cache area 202b are updated with the substitute data.

As a result of the above operations, the substitute data is duplexed in the cache area 202b in the CM 200a and the NAND flash memory 331 in the CBU 300a.

<Step S144> The IO control unit 310 in the CBU 300a notifies the CM 200a of completion of the duplexing, by an interruption through the PCIe bus.

<Step S145> When the CPU 201 in the CM 200a receives from the CBU 300a the notification of the completion of the duplexing, the CPU 201 returns to the host apparatus a reply notifying the host apparatus of the completion of the writing.

2.4.4.3 Third Sequence for Duplexing Write Data

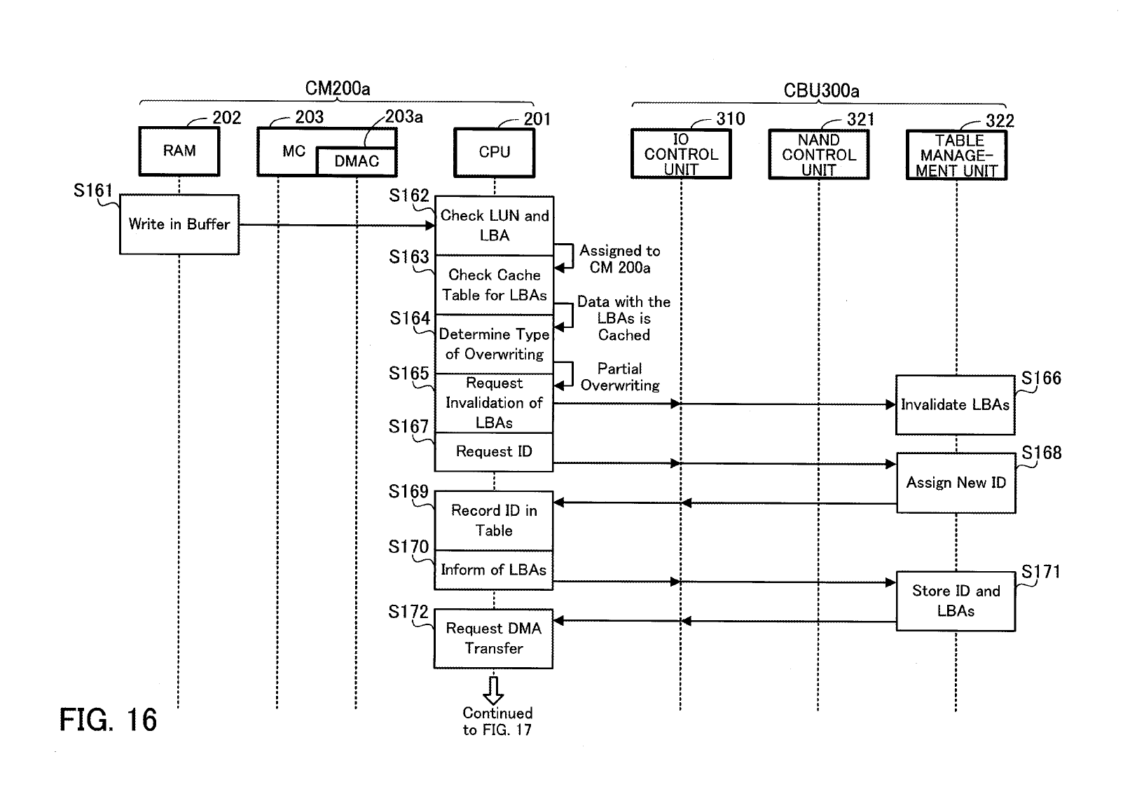

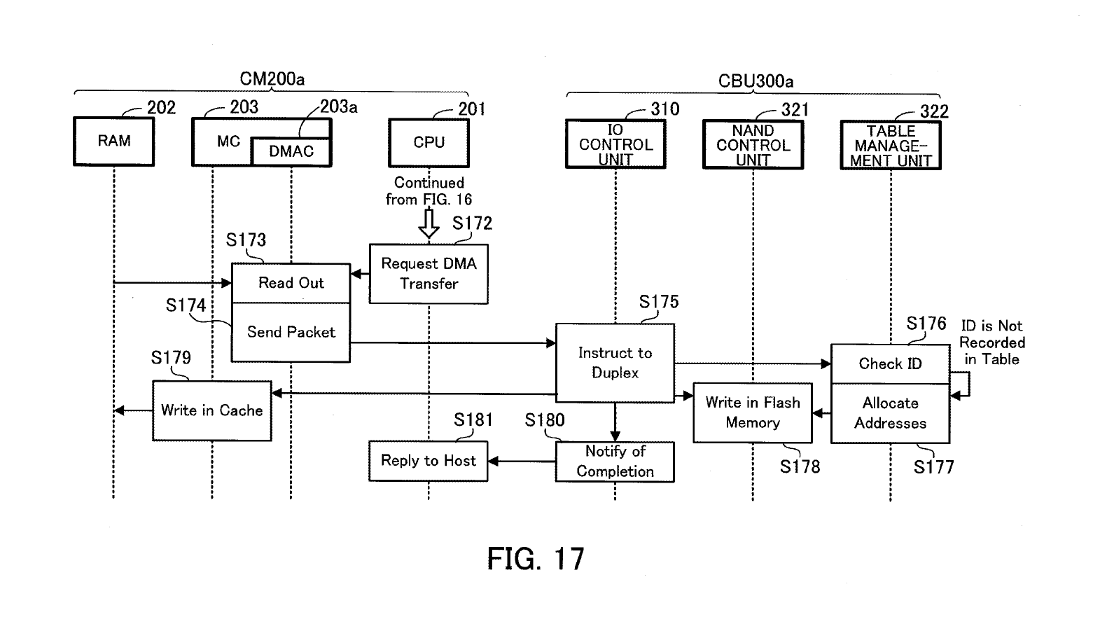

FIGS. 16 and 17 illustrate a third sequence diagram indicating a third example of a sequence of operations performed when a CM receives a request for writing in a logical volume the access control to which is assigned to the CM per se. The operations indicated in FIGS. 16 and 17 are performed when a write request for overwriting of part of the data which has been written by the sequence of FIG. 13 or 14 is transmitted from the host apparatus 500a or 500b to the CM 200a.

<Step S161> The host apparatus transmits to the CM 200a substitute data with which the aforementioned substitute data written in response to the aforementioned write request made (by the host apparatus) in step S101 illustrated in FIG. 13 or in step S131 illustrated in FIG. 14 is to be overwritten and requests the CM 200a to write the transmitted substitute data. The substitute data received by the CM 200a is written in the buffer area 202a in the RAM 202 through the host interface 205 and the memory controller 203.

For example, assume that substitute data corresponding to LBA#(p′) to LBA#(p′+P′) is transmitted from the host apparatus while a series of pieces of data corresponding to LBA#(p) to LBA#(p+P) (including LBA#(p′) to LBA#(p′+P′)) are stored in the cache area 202b, where p<p′<p+P and p′+P′<p+P. Hereinafter, the series of pieces of data corresponding to LBA#(p′) to LBA#(p′+P′) and transmitted from the host apparatus are referred to as substitute data.

<Step S162> The CPU 201 in the CM 200a refers to the LUN of the logical volume to which the substitute data received from the host apparatus belongs and one or more LBAs of the substitute data, and determines whether or not the substitute data belongs to a logical volume the access control to which is assigned to the CM 200a per se. In the example of FIGS. 16 and 17, the substitute data is assumed to belong to a logical volume the access control to which is assigned to the CM 200a.

<Step S163> The CPU 201 determines whether or not the one or more LBAs of the received substitute data are recorded in the cache management table 221. In the example of FIGS. 16 and 17, the one or more LBAs of the received substitute data are assumed to be LBA#(p′) to LBA#(p′+P′), which are recorded in the cache management table 221. In this case, the CPU 201 determines that data being already stored in the cache area 202b and corresponding to LBA#(p′) to LBA#(p′+P′) are to be overwritten with the received substitute data.

<Step S164> The CPU 201 determines whether the type of the overwriting requested by the host apparatus is full overwriting or partial overwriting. In this example, the range of LBAs of the received substitute data is LBA#(p′) to LBA#(p′+P′). This range of LBAs of the received substitute data is included in and is not identical to the range LBA#(p) to LBA#(p+P) of the series of LBAs of the data previously recorded in the cache management table 221. Therefore, the CPU 201 determines that partial overwriting is requested.

<Step S165> When it is determined in step S164 that partial overwriting is requested, the CPU 201 informs the CBU 300a of the range of LBAs of the data to be overwritten, and requests the CBU 300a to invalidate the data being stored in the NAND flash memory 331 and corresponding to the range of LBAs of the data to be overwritten. The CPU 201 generates a write-request packet addressed to the CBU 300a for invalidating designated LBAs. Specifically, the CPU 201 reads out from the cache management table 221 an ID associated with the one or more LBAs of the substitute data, and sets the ID in the cache-backup control area in the write-request packet. In addition, the CPU 201 sets the leading LBA of the substitute data in the payload in the write-request packet, and the size of the substitute data in the field “Length” in the write-request packet. Then, the CPU 201 sends the above write-request packet to the CBU 300a through the memory controller 203 and the PCIe bus.

<Step S166> The IO control unit 310 in the CBU 300a receives the above write-request packet from the CM 200a. The table management unit 322 in the CBU 300a determines the one or more LBAs corresponding to the substitute data on the basis of the leading LBA and the size of the substitute data, which are set in the write-request packet. The table management unit 322 updates to “Invalid” the status of each of one or more records containing the one or more LBAs corresponding to the substitute data among the records in the NAND management table 351. After the update of the status, the table management unit 322 sends a reply packet (in reply to the above write-request packet) to the CM 200a through the IO control unit 310.

In addition, when the table management unit 322 recognizes the one or more LBAs corresponding to the substitute data, the table management unit 322 may read out the ID which is set in the write-request packet, and narrow down the extent of a search for the one or more LBAs corresponding to the substitute data in the NAND management table 351, on the basis of the address associated with the above ID in the ID management table 352.

<Step S167> The CPU 201 sends a read-request packet to the CBU 300a for requesting the CBU 300a to inform the CPU 201 of a new ID corresponding to a division area in which the substitute data is to be written. Specifically, the CPU 201 determines the type of the division area (L-, M-, or S-division area) in which the substitute data is to be stored, on the basis of the size of the received substitute data by using a criterion similar to step S104 in FIG. 13. In this example, it is assumed that the division area in which the substitute data is determined to be stored in an M-division area.

The CPU 201 generates a read-request packet, and sets as the address determination number in the cache-backup control area in the read-request packet a value for designating the CBU 300a as the destination and also designating the M-division area as the type of division area. In addition, the CPU 201 reads out from the control area on the RAM 202 the ID-acquisition address 251b for the M-division area, and sets the ID-acquisition address 251b in the less-significant area in the field “Address” in the read-request packet. Then, the CPU 201 sends the above read-request packet to the CBU 300a through the memory controller 203 and the PCIe bus.

<Step S168> The IO control unit 310 in the CBU 300a receives the above read-request packet. The table management unit 322 in the CBU 300a recognizes, on the basis of the value represented by the least significant two bits of the address determination number, that informing of an ID of an M-division area is requested. Then, the table management unit 322 generates an ID having a unique value to be assigned to an M-division area. The table management unit 322 sends a reply packet to the CM 200a through the IO control unit 310, where the generated ID is set in the least significant bits (“Addr[n−3:n−m]”) in the cache-backup control area in the reply packet.

Alternatively, the determination of the type of the division area corresponding to the size of the substitute data may be made by the table management unit 322 in the CBU 300a in step S168, instead of S167.

<Step S169> The CPU 201 in the CM 200a extracts the ID from the reply packet sent from the CBU 300a, and records, by overwriting, the extracted ID in the one or more records in the cache management table 221 containing the one or more LBAs of the substitute data.

<Step S170> The CPU 201 informs the CBU 300a of the one or more LBAs associated with the ID of which the CPU 201 is informed by the CBU 300a, by transmitting a PCIe packet addressed to the CBU 300a. Specifically, the CPU 201 generates a write-request packet. The CPU 201 sets a value for designating the CBU 300a as the destination in the cache-backup control area in the write-request packet, and sets the ID-acquisition address 251b for the M-division area in the less significant area in the field “Address” in the write-request packet. Furthermore, the CPU 201 sets the leading LBA and the size of the substitute data in the payload and the field “Length”, respectively, in the write-request packet, and sends the write-request packet to the CBU 300a through the memory controller 203 and the PCIe bus.

<Step S171> The IO control unit 310 in the CBU 300a receives the above write-request packet. Then, the table management unit 322 in the CBU 300a extracts from the write-request packet the leading LBA and the size of the substitute data, and temporarily stores in the RAM 332 the extracted information in association with the ID assigned in step S168. In addition, the table management unit 322 sends a reply packet to the CM 200a through the IO control unit 310.

<Step S172> When the CPU 201 in the CM 200a receives the above reply packet, the CPU 201 starts the DMA controller 203a, and requests DMA transfers for duplexing the substitute data. Specifically, the CPU 201 starts the DMA controller 203a by reading out the CM-DMA start address 252 from the RAM 202 and informing the memory controller 203 of the CM-DMA start address 252. In addition, the CPU 201 causes the DMA controller 203a to perform a DMA write operation in the cache area 202b in the RAM 202 as the destination, by settings information in the DMA descriptor 253. At this time, the one or more write addresses in the cache area 202b are the one or more cache addresses which are associated with the leading LBA of the substitute data in the cache management table 221.

<Step S173> The DMA controller 203a reads out from the buffer area 202a in the RAM 202 the substitute data written in step S161.

<Step S174> The DMA controller 203a generates a write-request packet containing the substitute data which is read out in step S173. In the write-request packet, the information which is set in the DMA descriptor 253 in step S172, the ID of which the CBU 300a is informed in step S168, the one or more write addresses in the cache area 202b, the size of the substitute data, and other information are set. Then, the DMA controller 203a sends the write-request packet to the CBU 300a.

<Step S175> The IO control unit 310 in the CBU 300a receives the above write-request packet, stores the received write-request packet in the buffer memory 311, and performs operations for duplexing the substitute data contained in the write-request packet. The IO control unit 310 instructs the NAND control unit 321 and the table management unit 322 to perform operations for writing the substitute data in the NAND flash memory 331. In addition, the IO control unit 310 transfers the received write-request packet to the CM 200a for requesting the CM 200a to write the substitute data in the cache area 202b.

<Step S176> The table management unit 322 determines whether or not the ID which is set in the write-request packet is recorded in the ID management table 352. In the example of FIGS. 16 and 17, the ID is newly assigned in step S168, so that the ID is not yet recorded in the ID management table 352 at this stage.

<Step S177> When it is determined in step S176 that the ID is not recorded in the ID management table 352, the table management unit 322 records the ID in the ID management table 352. In addition, the table management unit 322 allocates one or more addresses of a division area for the ID. Specifically, by reference to the NAND management table 351, the table management unit 322 chooses a division area in which the status of every page is “Unused”, from among the division areas of the type corresponding to the ID. In this example, the ID is ID_M#(a), which indicates the M-division area, so that the table management unit 322 chooses an M-division area in which the status of every page is “Unused”. The table management unit 322 generates a record in the ID management table 352, and records in the generated record the ID and the leading address of the chosen division area in the NAND flash memory 331.

Further, the table management unit 322 records in the NAND management table 351 the one or more LBAs of the substitute data respectively in correspondence with the one or more addresses of the chosen division area. At this time, the table management unit 322 copies the one or more LBAs recorded in one or more records the status of which is changed to “Invalid” in step S166, into the records containing the one or more addresses of the newly chosen division area.

<Step S178> The table management unit 322 informs the NAND control unit 321 of the one or more addresses in the NAND flash memory 331 which are recorded in the NAND management table 351 in step S177. The NAND control unit 321 successively reads out the substitute data from the payload in the write-request packet stored in the buffer memory 311 in step S175, and writes the substitute data at the one or more addresses in the NAND flash memory 331 of which the NAND control unit 321 is informed by the table management unit 322. In addition, the table management unit 322 updates to “Valid” the status of the one or more records corresponding to the one or more addresses at which the substitute data is written by the NAND control unit 321.

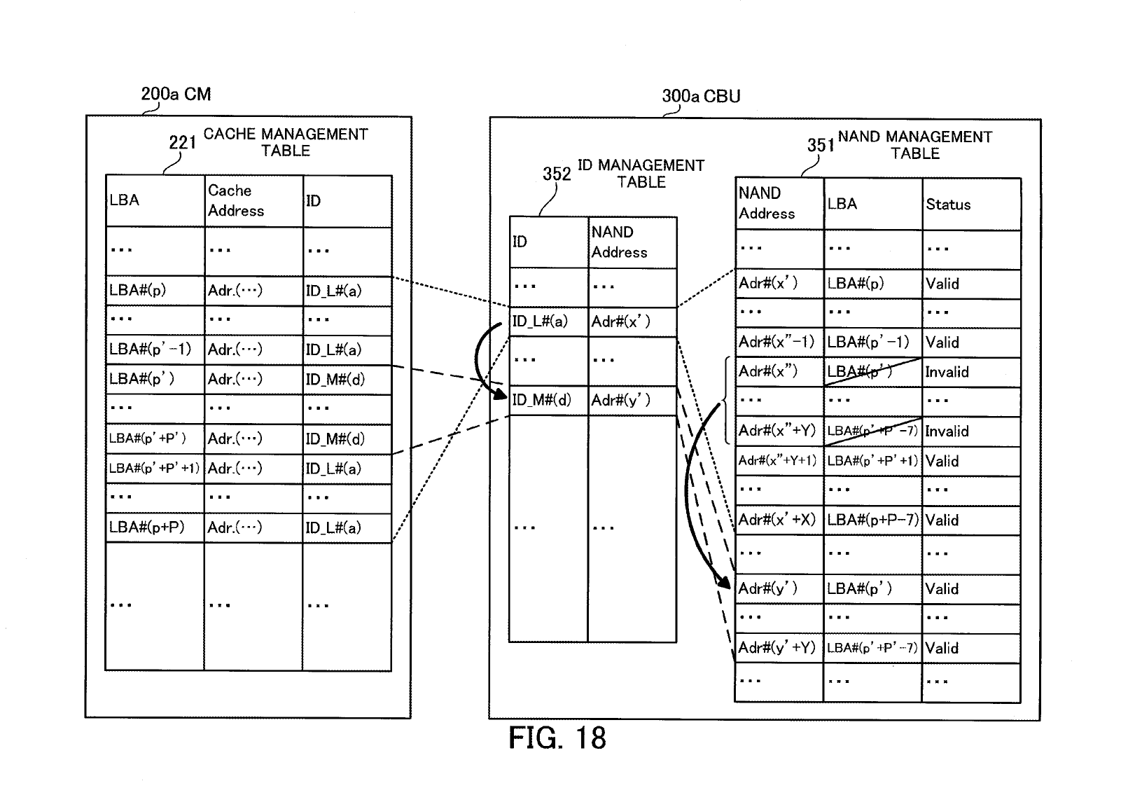

FIG. 18 illustrates examples of states of the tables when operations for partial overwriting are performed.

In step S166 in FIG. 16, the table management unit 322 updates to “Invalid” the status of each of the records containing LBA#(p′) to LBA#(p′+P′) corresponding to the substitute data, among the records in the NAND management table 351, on the basis of the LBAs and the size of the substitute data of which the CBU 300a is informed by the CM 200a. After that, in step S168 in FIG. 16, the table management unit 322 generates the new ID (which is assumed to be ID_M#(d) in this example). In this case, in step S169, the CPU 201 in the CM 200a updates the ID in each of the records respectively containing LBA#(p′) to LBA#(p′+P′) in the cache management table 221, from ID_L#(a) to ID_M#(d) as indicated in FIG. 18. Thus, the two different IDs, ID_L#(a) and ID_M#(d), are associated with the data corresponding to the LBAs ranging from LBA#(p) to LBA#(p+P).

Thereafter, in step S177 in FIG. 17, the table management unit 322 in the CBU 300a generates a record in the ID management table 352 as indicated in FIG. 18, and records, in the generated record, the value ID_M#(d) of the ID of which the CBU 300a is informed by the CM 200a and the leading address Adr#(y′) of the chosen division area in the NAND flash memory 331. In addition, the table management unit 322 copies the LBAs (LBA#(p′) to LBA#(p′+P′−7)) associated with the addresses (Adr#(x″) to Adr#(x″+Y)) at which the data to be overwritten is stored, into the records containing the addresses (Adr#(y′) to Adr#(y′+Y)) of the M-division area, in the NAND management table 351. After the copying of the LBAs is completed, the table management unit 322 deletes from the NAND management table 351 the LBAs (LBA#(p′) to LBA#(p′+P′−7)) associated with the addresses (Adr#(x″) to Adr#(x″+Y)) at which the data to be overwritten is stored.

Referring back to FIG. 17, the operation goes to step S179 after completion of the operation in step S178.

<Step S179> When the CM 200a receives the write-request packet transmitted in step S175 by the CBU 300a, the memory controller 203 in the CM 200a writes the substitute data contained in the write-request packet, at the one or more addresses in the cache area 202b which are set in the write-request packet. Thus, only the data stored at the LBAs (LBA#(p′) to LBA#(p′+P′)), among the data stored in the cache area 202b, are updated with the substitute data.

As a result of the above operations, the substitute data is duplexed in the cache area 202b in the CM 200a and the NAND flash memory 331 in the CBU 300a.

<Step S180> The IO control unit 310 in the CBU 300a notifies the CM 200a of completion of the duplexing, by an interruption through the PCIe bus.

<Step S181> When the CPU 201 in the CM 200a receives from the CBU 300a the notification of the completion of the duplexing, the CPU 201 returns to the host apparatus a reply notifying the host apparatus of the completion of the writing.

2.4.4.4 Advantages of Sequences

As explained above with reference to FIGS. 13, 14, 16, and 17, in the storage system 100 according to the present embodiment, the data which is requested to be written can be duplexed in the cache area 202b and the NAND flash memory 331 in the CBU 300a in response to only one request for DMA transfer which is sent from the CPU 201 in the CM 200a to the DMA controller 203a after the CM 200a receives a data-write request from the host apparatus 500a or 500b. Therefore, the overhead time in the CPU 201 for requesting DMA transfer is reduced, so that the time needed for performing all the operations for duplexing of the write data is reduced. Thus, it is possible for the CM 200a to return to the host apparatus a reply reporting completion of the writing, in a short time.

In addition, the CBU 300a writes the write data transferred from the CM 200a, in a division area in the NAND flash memory 331 according to the size of the write data. Therefore, invalid pages are unlikely to randomly occur in the NAND flash memory 331, so that the possibility of occurrence of copying of data between blocks for securing a vacant area in the NAND flash memory 331 is lowered. Thus, the load imposed on the data bus in the NAND flash memory 331 can be reduced, and the speed of data writing in the NAND flash memory 331 increases. Consequently, it is possible to reduce the time needed for performing all the operations for duplexing of the write data.

Although the CBU 300a assigns only one ID to each division area in the above example, alternatively, the CBU 300a may assign, for example, consecutive IDs to the respective pages in a division area. In this case, for example, in step S107, S165, or S170, the CPU 201 in the CM 200a can designate the LBA by informing of the ID.

2.4.5 Sequences for Logical Volume Corresponding to Other CM

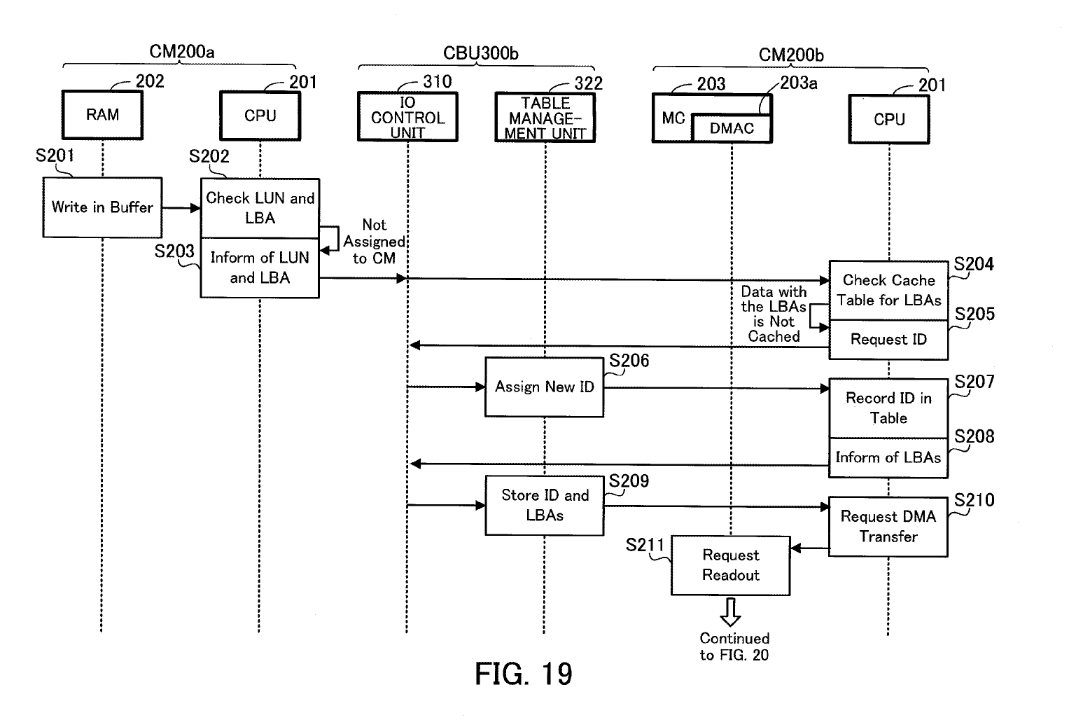

Hereinbelow, sequences of operations for duplexing write data in the case where a CM receives a request for writing in a logical volume the access control to which is assigned to another CM are explained. Specifically, examples of sequences of operations performed when the CM 200a receives a request for writing in a logical volume the access control to which is assigned to the CM 200b are explained below with reference to FIGS. 19 to 24.

2.4.5.1 First Sequence for Duplexing Write Data

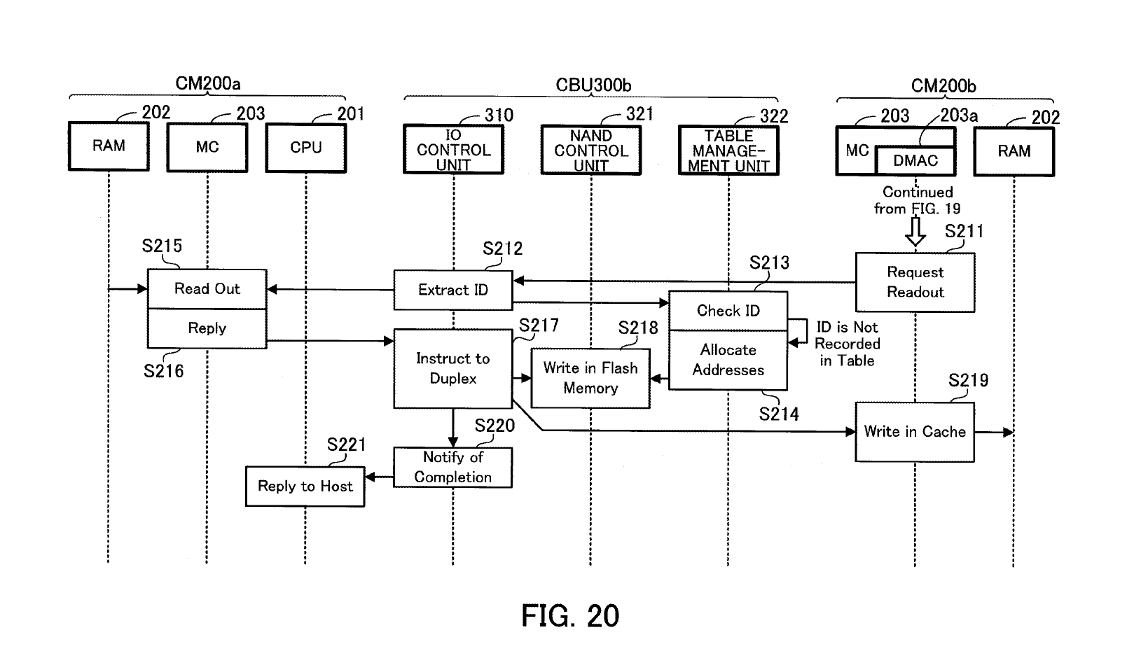

FIGS. 19 and 20 illustrate a first sequence diagram indicating a first example of a sequence of operations performed when the CM 200a receives a request for writing in a logical volume the access control to which is assigned to the other CM 200b.

<Step S201> The host apparatus requests the CM 200a to perform a write operation and transmit write data to the CM 200a. The write data received by the CM 200a is written in the buffer area 202a in the RAM 202 through the host interface 205 and the memory controller 203.

<Step S202> The CPU 201 in the CM 200a refers to the number (specifically, the logical unit number (LUN)) of the logical volume to which the write data requested to be written belongs and one or more LBAs of the write data, and determines whether or not the write data belongs to a logical volume the access control to which is assigned to the CM 200a per se. In the example of FIGS. 19 and 20, the write data is assumed not to belong to a logical volume the access control to which is assigned to the CM 200a.

<Step S203> The CPU 201 in the CM 200a informs the other CM 200b of the LUN and the one or more LBAs of the write data by sending to the CM 200b a write-request packet which contains the LUN and the leading LBA of the write data in the payload and the size of the write data in the field “Length”.

<Steps S204 to S209> The write-request packet from the CM 200a is transferred to the CM 200b through the IO control units 310 in the CBUs 300a and 300b. Thereafter, in steps S204 to S209, the CM 200b and the CBU 300b perform operations similar to the operations performed by the CM 200a and the CBU 300a in steps S103 to S108 in the sequence of FIG. 13. That is, the CPU 201 in the CM 200b determines in step S204 that the write data is not yet stored in the cache area 202b in the CM 200b, and requests the CBU 300b to inform the CM 200b of the ID of a division area according to the type of the write data in step S205. In step S206, the table management unit 322 in the CBU 300b generates the ID and returns the generated ID to the CM 200b. In step S207, the CPU 201 in the CM 200b records the returned ID in the cache management table 221.

In step S208, the CPU 201 in the CM 200b informs the CBU 300b of the one or more LBAs of the write data. In step S209, the table management unit 322 in the CBU 300b temporarily records in the RAM 332 the assigned ID and the one or more LBAs of which the CBU 300b is informed, and sends a reply packet to the CM 200b.

<Step S210> When the CM 200b receives the reply packet, the CPU 201 in the CM 200b starts the DMA controller 203a in the CM 200b, and requests the DMA controller 203a in the CM 200b to make DMA transfers for duplexing the write data. Specifically, the CPU 201 in the CM 200b starts the DMA controller 203a in the CM 200b by reading out the CM-DMA start address 252 from the RAM 202 in the CM 200b and informing the memory controller 203 in the CM 200b of the CM-DMA start address 252. In addition, the CPU 201 in the CM 200b causes the DMA controller 203a in the CM 200b to perform a DMA read operation in which the cache area 202b in the RAM 202 is the destination, by making the following settings in the DMA descriptor 253 in the CM 200b.

That is, the CPU 201 sets a value indicating a transfer from the outside to the RAM 202 as the command 253a in the DMA descriptor 253, and sets the size of the write data as the transfer size 253b. In addition, the CPU 201 sets as the first address 253c in the DMA descriptor 253 one or more addresses in the cache area 202b in the RAM 202 in the CM 200b. At this time, the CPU 201 records the one or more addresses in the cache area 202b in the RAM 202 in the CM 200b, in one or more records generated in the cache management table 221 in step S204. Further, the information which is set as the second address 253d in the DMA descriptor 253 is to be contained in the field “Address” in a read-request packet transmitted from the DMA controller 203a. The CPU 201 sets, in an area of the second address 253d corresponding to the cache-backup control area in the field “Address”, an address determination number indicating the CBU 300b as the destination and the ID of which the CBU 300b is to be informed. Furthermore, the buffer area 202a in the CM 200a is fixedly secured on the RAM 202 in the CM 200a, the CPU 201 in the CM 200b sets as a read address a predetermined address indicating the buffer area 202a in the CM 200a, in an area of the second address 253d which corresponds to the less-significant area in the field “Address”.

<Step S211> The DMA controller 203a in the CM 200b generates a read-request packet on the basis of the information which is set in the DMA descriptor 253. In the read-request packet, the buffer area 202a in the RAM 202 in the CM 200a is designated as the data source. The DMA controller 203a transmits the read-request packet to the CBU 300b via PCIe bus.

<Step S212> When the CBU 300b receives the above read-request packet from the CM 200b, the IO control unit 310 in the CBU 300b extracts the ID from the read-request packet, and informs the table management unit 322 in the CBU 300b of the ID. In addition, the IO control unit 310 transfers the received read-request packet to the CM 200a.

<Step S213> The table management unit 322 in the CBU 300b determines whether or not the ID which is extracted from the read-request packet is recorded in the ID management table 352 recorded in the RAM 332 in the CBU 300b. In the example of FIGS. 19 and 20, the ID is newly assigned in step S206, so that the ID is not yet recorded in the ID management table 352 at this stage.

<Step S214> When it is determined in step S213 that the ID is not recorded in the ID management table 352, the table management unit 322 in the CBU 300b records the ID in the ID management table 352 in such a manner that the type of the division area (L-, M-, or S-division area) corresponding to the ID can be recognized.

In addition, the table management unit 322 in the CBU 300b allocates one or more addresses of a division area for the ID. Specifically, by reference to the NAND management table 351, the table management unit 322 chooses a division area in which the status of every page is “Unused”, from among the division areas of the type corresponding to the ID. In this example, the ID is ID_L#(a), which indicates the L-division area, so that the table management unit 322 chooses an L-division area in which the status of every page is “Unused”. Then, the table management unit 322 generates a record in the ID management table 352, and records in the generated record the ID and the leading address of the chosen division area in the NAND flash memory 331. Further, the table management unit 322 records in the NAND management table 351 the one or more LBAs of the write data respectively in correspondence with one or more addresses of the chosen division area, on the basis of the leading LBA and the size which are temporarily stored in the RAM 332 in step S209.

<Step S215> When the CM 200a receives the read-request packet transferred from the IO control unit 310 in the CBU 300b in step S212, the memory controller 203 in the CM 200a reads out the write data written in step S201, from the buffer area 202a in the CM 200a.

<Step S216> The memory controller 203 in the CM 200a generates a reply packet (for replying to the read-request packet) containing the write data which is read out from the buffer area 202a, and sends the reply packet to the CBU 300b.

<Step S217> The IO control unit 310 in the CBU 300b stores the reply packet received from the CM 200a, in the buffer memory 311 in the CBU 300b, and performs operations for duplexing the write data contained in the reply packet.

Specifically, the IO control unit 310 in the CBU 300b instructs the NAND control unit 321 in the CBU 300b to write the write data in the NAND flash memory 331 in the CBU 300b. In addition, the IO control unit 310 in the CBU 300b transfers the received reply packet to the CM 200b for requesting the CM 200b to write the write data in the cache area 202b in the CM 200b.

<Step S218> The NAND control unit 321 in the CBU 300b writes the write data extracted from the reply packet, in the NAND flash memory 331 in the CBU 300b at the one or more addresses recorded in the one or more records in the NAND management table 351 in which the table management unit 322 records the one or more LBAs of the write data in step S214. At this time, the table management unit 322 in the CBU 300b updates to “Valid” the status of each of the one or more records corresponding to the one or more addresses at which the write data is written by the NAND control unit 321, among the records in the NAND management table 351.

<Step S219> When the CM 200b receives the reply packet sent from the CBU 300b in step S217, the DMA controller 203a in the CM 200b writes the write data contained in the received reply packet, at the one or more addresses in the cache area 202b which are set as the first address 253c of the DMA descriptor 253.

As a result of the above operations, the write data is duplexed in the cache area 202b in the CM 200b and the NAND flash memory 331 in the CBU 300b. Further, the operation in step S217 for sending the reply packet from the IO control unit 310 in the CBU 300b to the CM 200b may be performed in parallel with the operation in step S218 for transferring the write data from the buffer memory 311 to the NAND flash memory 331.

<Step S220> The IO control unit 310 in the CBU 300b notifies the CM 200a of completion of the duplexing, by an interruption through the PCIe bus.

<Step S221> When the CPU 201 in the CM 200a receives from the CBU 300b the notification of the completion of the duplexing, the CPU 201 returns to the host apparatus a reply notifying the host apparatus of the completion of the writing.

2.4.5.2 Second Sequence for Duplexing Write Data

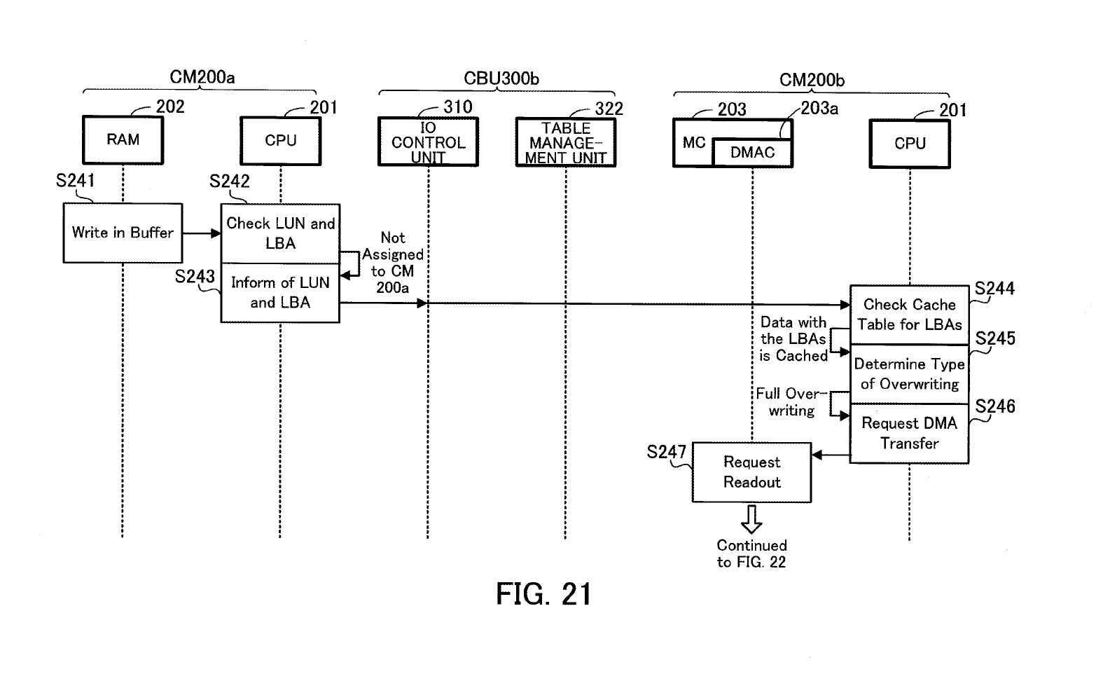

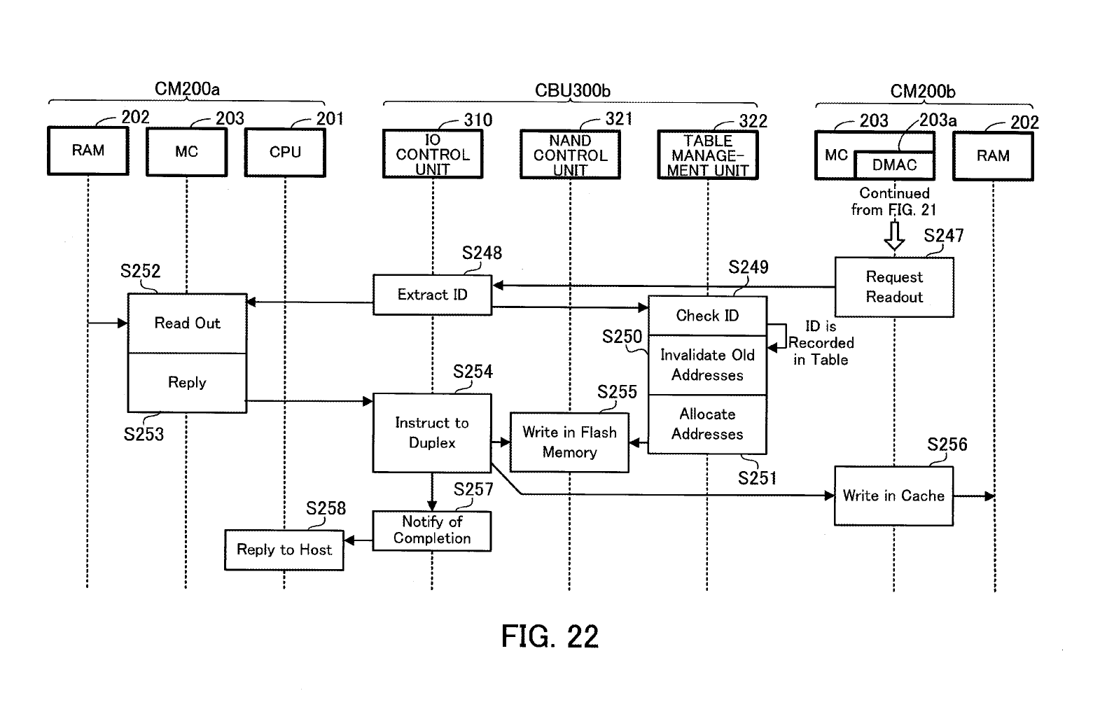

FIGS. 21 and 22 illustrate a second sequence diagram indicating a second example of a sequence of operations performed when the CM receives a request for writing in a logical volume the access control to which is assigned to another CM. The operations indicated in FIGS. 21 and 22 are performed when a write request for overwriting of the whole data which has been written by the sequence of FIGS. 19 and 20 is transmitted from the host apparatus 500a or 500b to the CM 200a.

<Step S241> The host apparatus transmits to the CM 200a substitute data corresponding to one or more LBAs identical to the one or more IBAs of the aforementioned write data written in response to the aforementioned write request made by the host apparatus in step S201 illustrated in FIG. 19, and requests the CM 200a to write the transmitted substitute data. The substitute data received by the CM 200a is written in the buffer area 202a in the RAM 202 in the CM 200a.

<Step S242> The CPU 201 in the CM 200a refers to the LUN of the logical volume to which the substitute data requested to be written belongs and one or more LBAs of the substitute data, and determines whether or not the substitute data belongs to a logical volume the access control to which is assigned to the CM 200a per se. In the example of FIGS. 21 and 22, the substitute data is assumed not to belong to a logical volume the access control to which is assigned to the CM 200a.

<Step S243> The CPU 201 in the CM 200a informs the other CM 200b of the LUN, the leading LBA, and the size of the substitute data by sending to the other CM 200b a write-request packet.

<Step S244> The CPU 201 in the CM 200b recognizes the one or more LBAs of the substitute data received from the host apparatus by the CM 200a, on the basis of the information which is set in the write-request packet received from the CM 200a by the CM 200b. The CPU 201 in the CM 200b determines whether or not the one or more LBAs of the substitute data are recorded in the cache management table 221 in the CM 200b. In this example, the CPU 201 determines that the one or more LBAs of the received substitute data are recorded in the cache management table 221 in the CM 200b.

<Step S245> The CPU 201 in the CM 200b determines whether the type of the overwriting requested by the host apparatus is full overwriting or partial overwriting with reference to the cache management table 221. For example, the CPU 201 is assumed to determine that full overwriting is requested. In this case, operations for duplexing the received substitute data are started, without acquiring a new ID from the CBU 300a, as indicated in the following step S246.

<Step S246> The CPU 201 in the CM 200b starts the DMA controller 203a in the CM 200b, and requests DMA transfers for duplexing of the substitute data. The operations in step S246 are similar to operations in step S210 in FIG. 19 except the following operations.

That is, the CPU 201 in the CM 200b reads out from the cache management table 221 the ID associated with the one or more LBAs of the received substitute data, and sets the ID in an area in the second address 253d in the DMA descriptor 253 corresponding to the cache-backup control area. Therefore, the CPU 201 can determine, by itself, the ID of the division area in the NAND flash memory 331 in which the substitute data is to be written, and indicate the determined ID to the CBU 300b.

<Step S247> The DMA controller 203a in the CM 200b generates a read-request packet indicating the buffer area 202a in the RAM 202 as the data source on the basis of the information which is set in the DMA descriptor 253, and sends the generated read-request packet to the CBU 300b through the PCIe bus.

<Step S248> When the IO control unit 310 in the CBU 300b receives the above read-request packet from the CM 200b, the IO control unit 310 in the CBU 300b extracts the ID from the read-request packet, and informs the table management unit 322 in the CBU 300b of the ID. In addition, the IO control unit 310 transfers the received read-request packet to the CM 200a.

<Step S249> The table management unit 322 in the CBU 300b determines whether the ID extracted from the received read-request packet is recorded in the ID management table 352 which is held in the RAM 332 in the CBU 300b. In the example of FIGS. 21 and 22, the table management unit 322 is assumed that the ID is recorded in the ID management table 352. In this case, the operation goes to step S250.

<Step S250> The table management unit 322 in the CBU 300b chooses from the ID management table 352 in the CBU 300b the record containing the ID which is set in the above read-request packet, and extracts an address of the NAND flash memory 331 recorded in the chosen record. The table management unit 322 chooses from the NAND management table 351 the record corresponding to the division area indicated by the ID which is set in the read-request packet, on the basis of the address extracted from the ID management table 352, and changes the status of the chosen record to “Invalid”.

<Step S251> The table management unit 322 in the CBU 300b allocates, for the ID which is set in the read-request packet, one or more addresses of a new division area of the type corresponding to the ID which is set in the read-request packet. The table management unit 322 records the leading address of the newly chosen division area in the record containing the ID which is set in the read-request packet, among the records in the ID management table 352. In addition, the table management unit 322 records in the NAND management table 351 the one or more LBAs of the substitute data respectively in correspondence with one or more addresses of the newly chosen division area. At this time, the table management unit 322 copies the one or more LBAs recorded in the one or more records the status of which is updated to “Invalid” in step S250, into the one or more records containing the one or more addresses of the newly chosen division area.

<Step S252> When the CM 200a receives the read-request packet transferred from the IO control unit 310 in the CBU 300b in step S248, the memory controller 203 in the CM 200a reads out the substitute data written in step S241, from the buffer area 202a in the CM 200a.

<Step S253> The memory controller 203 in the CM 200a generates a reply packet for replying to the read-request packet received in step S252 so as to contain the substitute data read out from the buffer area 202a, and sends the reply packet to the CBU 300b.

<Step S254> The IO control unit 310 in the CBU 300b receives the above reply packet from the CM 200a, stores the reply packet in the buffer memory 311 in the CBU 300b, and performs operations for duplexing the substitute data contained in the reply packet. The IO control unit 310 instructs the NAND control unit 321 in the CBU 300b to write the substitute data in the NAND flash memory 331 in the CBU 300b. In addition, the IO control unit 310 transfers the received reply packet to the CM 200b and requests the CM 200b to write the substitute data in the cache area 202b in the CM 200b.

<Step S255> The NAND control unit 321 in the CBU 300b writes the substitute data extracted from the reply packet received in step S254, in the NAND flash memory 331 in the CBU 300b at the one or more addresses recorded in the one or more records in the NAND management table 351 in which the table management unit 322 records the one or more LBAs of the substitute data in step S251. At this time, the table management unit 322 in the CBU 300b updates to “Valid” the status of each of the one or more records corresponding to the one or more addresses at which the substitute data is written by the NAND control unit 321, among the records in the NAND management table 351.

<Step S256> When the CM 200b receives the reply packet sent from the CBU 300b in step S254, the DMA controller 203a in the CM 200b writes the substitute data contained in the reply packet at the one or more addresses in the cache area 202b which are set as the first address 253c of the DMA descriptor 253. Thus, the whole data previously stored at the one or more addresses in the cache area 202b in the CM 200b are updated with the new write data (substitute data).

<Step S257> The IO control unit 310 in the CBU 300b notifies the CM 200a of completion of the duplexing, by an interruption through the PCIe bus.

<Step S258> When the CPU 201 in the CM 200a receives from the CBU 300b the notification of the completion of the duplexing, the CPU 201 in the CM 200a returns to the host apparatus a reply notifying the host apparatus of the completion of the writing.

2.4.5.3 Third Sequence for Duplexing Write Data

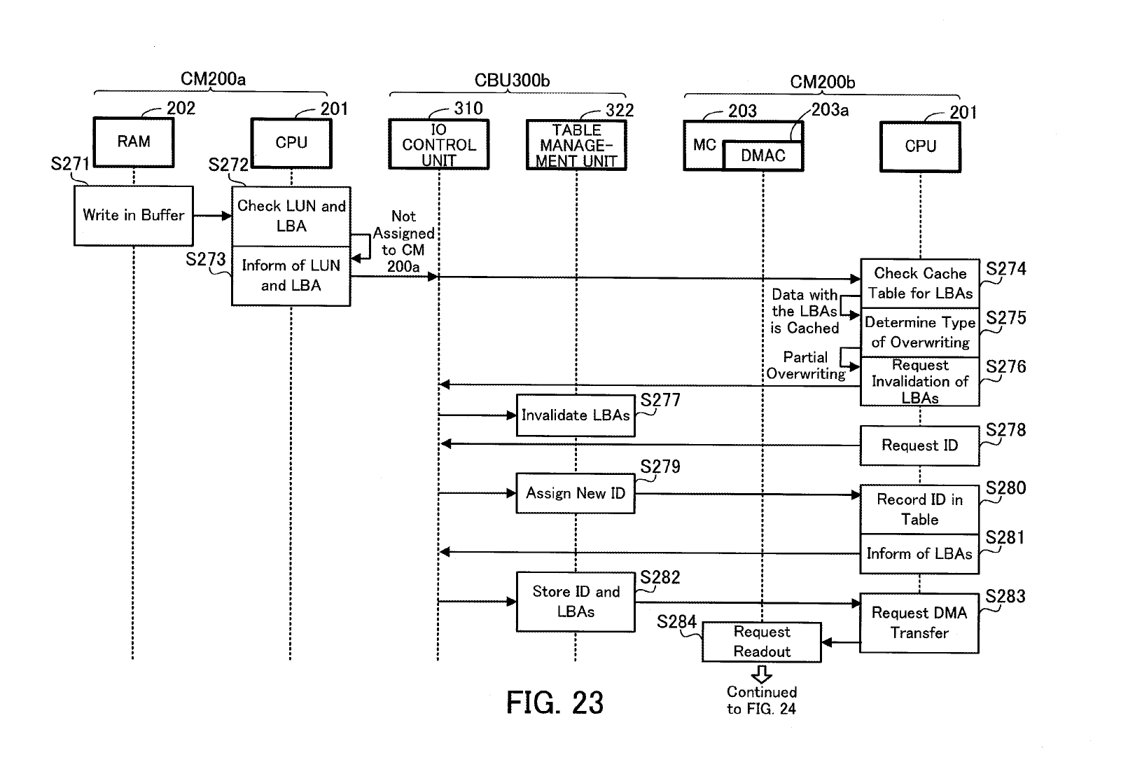

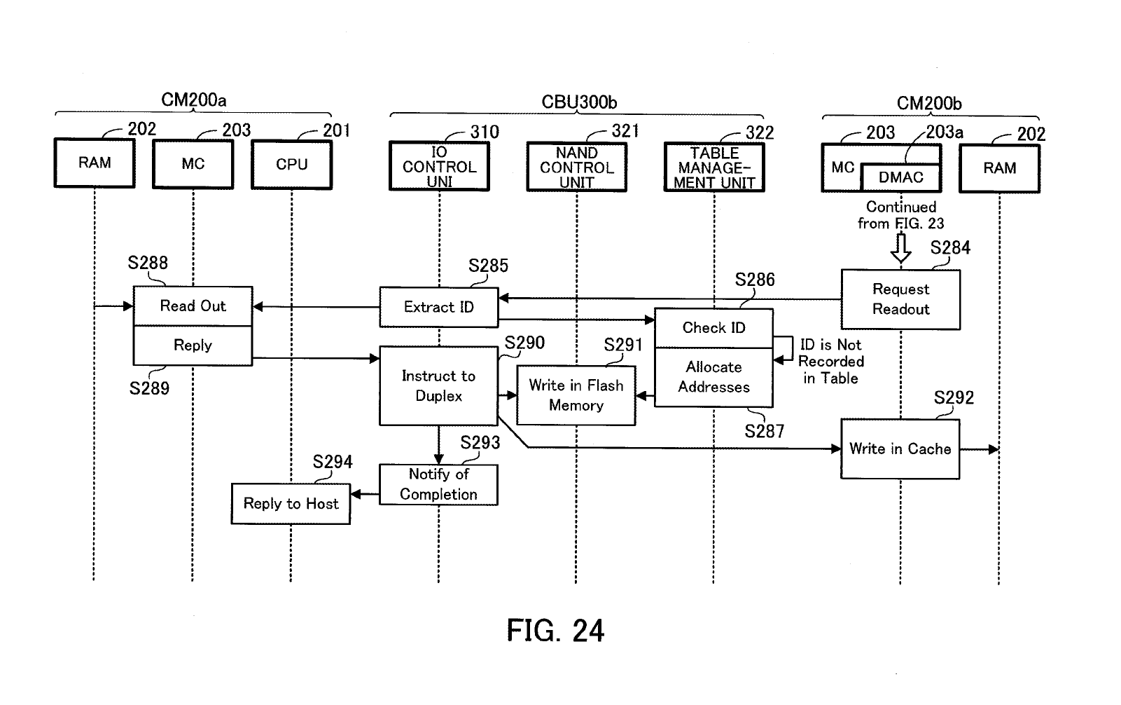

FIGS. 23 and 24 illustrate a third sequence diagram indicating a third example of a sequence of operations performed when the CM receives a request for writing in a logical volume the access control to which is assigned to another CM. The operations indicated in FIGS. 23 and 24 are performed when a write request for overwriting of part of data which has been written by the sequence of FIGS. 19 and 20 or the sequence of FIGS. 21 and 22 is transmitted from the host apparatus 500a or 500b to the CM 200a.

<Step S271> The host apparatus transmits to the CM 200a substitute data with which the aforementioned data written in response to the aforementioned write request made by the host apparatus in step S241 illustrated in FIG. 21 is to be overwritten and requests the CM 200a to write the transmitted substitute data. The substitute data received by the CM 200a is written in the buffer area 202a in the RAM 202 in the CM 200a.

<Step S272> The CPU 201 in the CM 200a refers to the LUN of the logical volume to which the substitute data received from the host apparatus belongs and one or more LBAs of the substitute data, and determines whether or not the substitute data belongs to a logical volume the access control to which is assigned to the CM 200a per se. In the example of FIGS. 23 and 24, the substitute data is assumed not to belong to a logical volume the access control to which is assigned to the CM 200a.

<Step S273> The CPU 201 in the CM 200a informs the other CM 200b of the LUN, the leading LBA, and the size of the substitute data by sending to the other CM 200b a write-request packet.

<Steps S274 to S282> The CPU 201 in the CM 200b recognizes the one or more LBAs of the substitute data received by the CM 200a, on the basis of the information which is set in the write-request packet received from the CM 200a. Thereafter, in steps S274 to S282, the CM 200b and the CBU 300b perform operations similar to the operations performed by the CM 200a and the CBU 300a in steps S163 to S171 in the sequence of FIG. 16.

That is, the CPU 201 in the CM 200b determines in step S274 that the one or more LBAs of the received substitute data are recorded in the cache management table 221, and determines in step S275 that the requested overwriting is partial overwriting. In step S276, the CPU 201 in the CM 200b informs the CBU 300b of the range of LBAs of the data to be overwritten, and requests the CBU 300b to invalidate the data corresponding to the range of LBAs and being stored in the NAND flash memory 331 in the CBU 300b. In step S277, the table management unit 322 in the CBU 300b updates to “Invalid” the status of each of the one or more records containing the one or more LBAs corresponding to the substitute data among the records in the NAND management table 351.

In step S278, the CPU 201 in the CM 200b sends a read-request packet to the CBU 300b for requesting the CBU 300b to inform the CPU 201 of a new ID corresponding to a division area in which the substitute data is to be written. In step S279, the table management unit 322 in the CBU 300b generates an ID of an M-division area, and sends a reply to the CM 200b for informing the CM 200b of the ID. In step S280, the CPU 201 in the CM 200b records in the cache management table 221 the ID of which the CM 200b is informed. In step S281, the CPU 201 in the CM 200b informs the CBU 300b of the one or more LBAs of the substitute data. In step S282, the table management unit 322 in the CBU 300b temporarily stores in the RAM 332 the one or more LBAs of which the CBU 300b is informed, together with the assigned ID, and sends a reply packet to the CM 200b.

<Step S283> When the CM 200b receives the above reply packet, the CPU 201 in the CM 200b starts the DMA controller 203a in the CM 200b, and requests DMA transfers for duplexing the substitute data.

<Step S284> The DMA controller 203a in the CM 200b generates a read-request packet indicating the buffer area 202a in the CM 200a as the data source and containing the ID assigned by the CBU 300b in step S279, and sends the read-request packet to the CBU 300b through the PCIe bus.

<Step S285> When the CBU 300b receives the above read-request packet from the CM 200b, the IO control unit 310 in the CBU 300b extracts the ID from the read-request packet, and informs the table management unit 322 in the CBU 300b of the extracted ID. In addition, the IO control unit 310 transfers the received read-request packet to the CM 200a.

<Step S286> The table management unit 322 in the CBU 300b determines whether or not the ID which is extracted from the read-request packet in step S265 is recorded in the ID management table 352 recorded in the RAM 332 in the CBU 300b. In the example of FIGS. 23 and 24, the ID is not yet recorded in the ID management table 352 at this stage. In this case, the operation goes to step S287.

<Step S287> The table management unit 322 in the CBU 300b records the ID in the ID management table 352. In addition, the table management unit 322 in the CBU 300b allocates one or more addresses of a division area for the ID. Specifically, by reference to the NAND management table 351, the table management unit 322 chooses a division area in which the status of every page is “Unused”, from among the division areas of the type corresponding to the ID. In the example of FIGS. 23 and 24, the ID indicates the M-division area, so that the table management unit 322 chooses an M-division area in which the status of every page is “Unused”. Then, the table management unit 322 generates a record in the ID management table 352, and records in the generated record the ID and the leading address of the chosen division area in the NAND flash memory 331. Further, the table management unit 322 records in the NAND management table 351 the one or more LBAs of the substitute data respectively in correspondence with one or more addresses of the chosen division area. At this time, the table management unit 322 copies the one or more LBAs recorded in the one or more records the status of which is updated to “Invalid” in step S277, into the one or more records containing the one or more addresses of the newly chosen division area.

<Step S288> When the CM 200a receives the read-request packet transferred from the IO control unit 310 in the CBU 300b in step S285, the memory controller 203 in the CM 200a reads out the substitute data written in step S271, from the buffer area 202a in the CM 200a.

<Step S289> The memory controller 203 in the CM 200a generates a reply packet for replying to the read-request packet received in step S288 so as to contain the substitute data read out from the buffer area 202a, and sends the reply packet to the CBU 300b.

<Step S290> The IO control unit 310 in the CBU 300b receives the above reply packet from the CM 200a, stores the reply packet in the buffer memory 311 in the CBU 300b, and performs operations for duplexing the substitute data contained in the reply packet. The IO control unit 310 instructs the NAND control unit 321 in the CBU 300b to write the substitute data in the NAND flash memory 331 in the CBU 300b. In addition, the IO control unit 310 transfers the received reply packet to the CM 200b and requests the CM 200b to write the substitute data in the cache area 202b in the CM 200b.

<Step S291> The NAND control unit 321 in the CBU 300b writes the substitute data extracted from the reply packet received in step S290, in the NAND flash memory 331 in the CBU 300b at the one or more addresses recorded in the one or more records in the NAND management table 351 in which the table management unit 322 records the one or more LBAs of the substitute data in step S287. At this time, the table management unit 322 in the CBU 300b updates to “Valid” the status of each of the one or more records corresponding to the one or more addresses at which the substitute data is written by the NAND control unit 321, among the records in the NAND management table 351.

<Step S292> When the CM 200b receives the reply packet sent from the CBU 300b in step S290, the DMA controller 203a in the CM 200b writes the substitute data contained in the reply packet at the one or more addresses in the cache area 202b which are set as the first address 253c of the DMA descriptor 253. Thus, the aforementioned part of the data previously stored at the one or more addresses in the cache area 202b in the CM 200b is updated with the substitute data.

<Step S293> The IO control unit 310 in the CBU 300b notifies the CM 200a of completion of the duplexing, by an interruption through the PCIe bus.

<Step S294> When the CPU 201 in the CM 200a receives from the CBU 300b the notification of the completion of the duplexing, the CPU 201 in the CM 200a returns to the host apparatus a reply notifying the host apparatus of the completion of the writing.

2.4.5.4 Advantages of Sequences

As explained above with reference to FIGS. 19 to 24, in the storage system 100 according to the present embodiment, even in the case where one of the CMs receives a request for writing data in a logical volume the access control to which is assigned to the other of the CMs, the data which is requested to be written can be duplexed by issuing only one request from the CPU to the DMA controller in the other CM for DMA transfer when the CM 200a receives a data-write request from the host apparatus 500a or 500b. Therefore, the time needed for performing all the operations for duplexing of the write data is reduced. Further, the speed of data writing in the NAND flash memory in the CBU also increases as in the case where a CM receives a request for writing in a logical volume the access control to which is assigned to the CM per se. Thus, the time needed for performing all the operations for duplexing of the write data is further reduced.

2.4.6 Sequence for Writeback

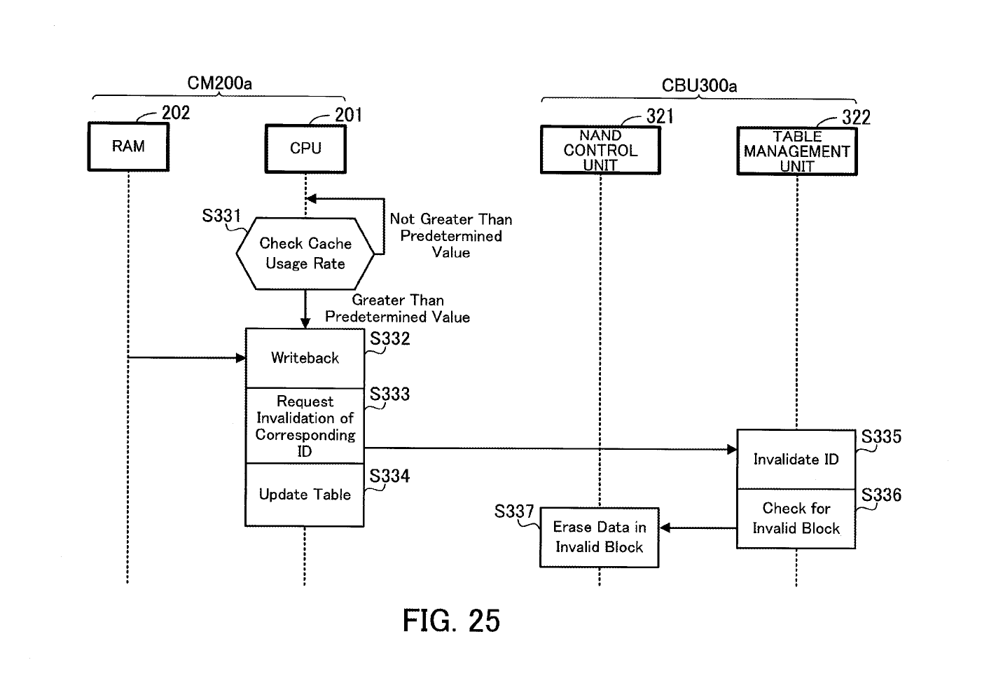

Hereinbelow, a sequence of operations for writing back data is explained. FIG. 25 is a sequence diagram indicating an example of a sequence of operations performed for writing back data. In the example of FIG. 25, the CM 200a performs a writeback operation. On the other hand, in the case where the CM 200b performs a writeback operation, the CM 200b and the CBU 300b perform operations similar to the operations performed by the CM 200a and the CBU 300a in the following sequence.

<Step S331> The CPU 201 in the CM 200a refers to the usage rate of the cache area 202b in the CM 200a. When the usage rate of the cache area 202b is equal to or lower than a predetermined value, the CPU 201 performs the operation in step S331 again after a predetermined time elapses. On the other hand, when the usage rate of the cache area 202b is higher than the predetermined value, the operation goes to step S332.

<Step S332> The CPU 201 in the CM 200a chooses a set of data to which the last access from either of the host apparatuses has been performed earliest, among all sets of data stored in the cache area 202b in the CM 200a. Then, the CPU 201 reads out the chosen set of data from the cache area 202b, and writes back the set of data into the backend memory area (i.e., the HDDs in the DE 400).

<Step S333> The CPU 201 in the CM 200a reads out an ID associated with the written-back set of data, from the cache management table 221. The CPU 201 generates a write-request packet containing the above ID in the cache-backup control area, and sends the write-request packet to the CBU 300a for requesting the CBU 300a to invalidate the division area corresponding to the ID.

For example, in the case where the CPU 201 in the CM 200a writes back a series of pieces of data corresponding to LBA#(p) to LBA#(p+P) in the state illustrated in FIG. 15, the CPU 201 in the CM 200a informs the CBU 300a of ID_L#(a) which is associated with LBA#(p) to LBA#(p+P) in the cache management table 221.

On the other hand, in the case where the CPU 201 in the CM 200a writes back a series of pieces of data corresponding to LBA#(p) to LBA#(p+P) in the state illustrated in FIG. 18, the CPU 201 in the CM 200a informs the CBU 300a of both of ID_L#(a) and ID_M#(d) which are associated with LBA#(p) to LBA#(p+P) in the cache management table 221, for example, by separately sending a write-request packet containing ID_L#(a) and a write-request packet containing ID_M#(d).

<Step S334> The CPU 201 in the CM 200a deletes one or more records corresponding to the data which has been written back, among the records in the cache management table 221.

Alternatively, the operation in step S334 may be performed after invalidation of the division area in the CBU 300a or data erasion in the division area in the CBU 300a is completed.

<Step S335> The IO control unit 310 in the CBU 300a receives the write-request packet sent from the CM 200a in step S333. The table management unit 322 in the CBU 300a reads out the ID from the write-request packet, and reads out an address in the NAND flash memory 331 which is associated with the ID in the ID management table 352. The table management unit 322 updates to “Invalid” the status of one or more records corresponding to the address which is read out from the ID management table 352, among the records in the NAND management table 351, and deletes the one or more LBAs in the one or more records. In addition, the table management unit 322 deletes the record in the ID management table 352 containing the ID which is read out from the write-request packet.

<Step S336> By reference to the NAND management table 351, the table management unit 322 determines whether or not a block in which the status of every page is “Unused” (i.e., a block in which data can be immediately erased) exists. When yes is determined, the table management unit 322 informs the NAND control unit 321 of the address of the block, and requests the NAND control unit 321 to perform data erasion.

<Step S337> The NAND control unit 321 erases the data in the block corresponding to the address of which the NAND control unit 321 is informed by the table management unit 322.

When no is determined in step S336, for example, the table management unit 322 causes the NAND control unit 321 to perform the following operations. That is, the NAND control unit 321 selects multiple blocks in each of which part of pages are valid, and copies the data in the valid pages in the selected multiple blocks into one or more other blocks in which data are already erased. When the copying is completed, the NAND flash memory 331 erases the data stored in the selected multiple blocks, and makes the selected multiple blocks transition to vacant blocks.

For example, in the case where the CPU 201 in the CM 200a informs the CBU 300a of the ID of an L-division area in step S333, the table management unit 322 causes the NAND control unit 321 to erase the data in the block corresponding to the ID of which the table management unit 322 is informed by the table management unit 322, in step S336. In this case, the NAND control unit 321 can immediately erase the data stored in the block without copying the data into another block.

In addition, for example, in the case where the CPU 201 in the CM 200a informs the CBU 300a of the ID of an M-division area in step S333, one or more blocks in each of which the status of every page is “Invalid” or “Unused” are more likely to occur as the result of the operations in step S336 than in the case where the CPU 201 in the CM 200a informs the CBU 300a of the ID of an S-division area in step S333. The data stored in each block in which the status of every page is “Invalid” or “Unused” can be immediately erased without being copied into another block.

As explained above, in the storage system 100 according to the present embodiment, it is likely that the data erasion in the NAND flash memory 331 after a writeback operation can be completed in a short time. Therefore, it is possible to reduce the average time needed for producing a vacant block in the NAND flash memory 331. Thus, the delay in reply to the host apparatus after receipt of a write request from the host apparatus by the CM 200a is less likely to occur, where such delay is caused, for example, by shortage of the backup area on the cache area 202b or the NAND flash memory 331. Consequently, the average response time to the host apparatus can be reduced.

2.4.7 Sequence after Abnormal Stop of CM

Hereinbelow, sequences of operations performed when one of the CMs abnormally stops are explained. In the example taken in the following explanations, it is assumed that the CM 200a abnormally stops. In this case, the other CM 200b reads out backup data for the cache area in the CM 200a, which are stored in the NAND flash memory 331 in the CBU 300a. Then, the CM 200b writes back the backup data into the backup area (i.e., the DE 400). Therefore, the latest data stored in the NAND flash memory 331 in the CBU 300a for the logical volumes the access control to which has been assigned to the CM 200a are not lost, and the CM 200b can take over the access control for the logical volumes the access control to which has been assigned to the CM 200a, where the access control is performed when requested by the host apparatuses.

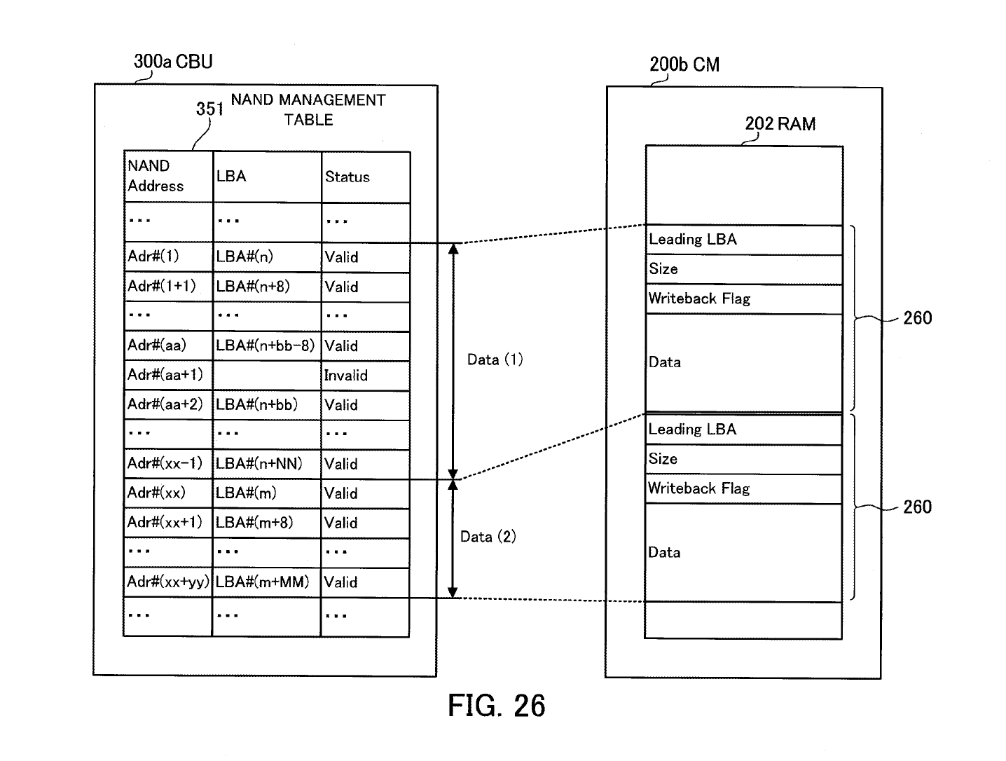

FIG. 26 illustrates examples of control areas allocated on a RAM by a CM which takes over access control, and examples of correspondences between the information in the control areas and information in a NAND management table in a CBU.

Every time a series of pieces of data being stored in the NAND flash memory 331 in the CBU 300a and corresponding to consecutive LBAs is written back into the DE 400, a buffer area 260 for the writeback is secured in the RAM 202 in the CM 200b. Each of the buffer areas 260 includes the areas of “Leading LBA”, “Size”, “Writeback Flag”, and “Data”. The area “Leading LBA” contains the leading LBA of a series of pieces of data, the area “Size” contains the size of the series of pieces of data, the area “Writeback Flag” contains flag information (writeback flag) indicating whether a writeback into the DE 400 is completed or in operation, and the area “Data” contains the series of pieces of data.

Further, the CPU 201 may designate the leading addresses of the respective buffer areas 260 in the RAM 202, in the CBU-DMA start addresses 254a and 254b and the subsequent areas in the control area (illustrated in FIG. 12). Alternatively, it is possible to limit the CBU-DMA start addresses to only the CBU-DMA start address 254a, indicate only the leading address of the leading one of the buffer areas 260 in the CBU-DMA start address 254a, and dynamically designate the leading addresses of the other one or ones of the buffer areas 260.

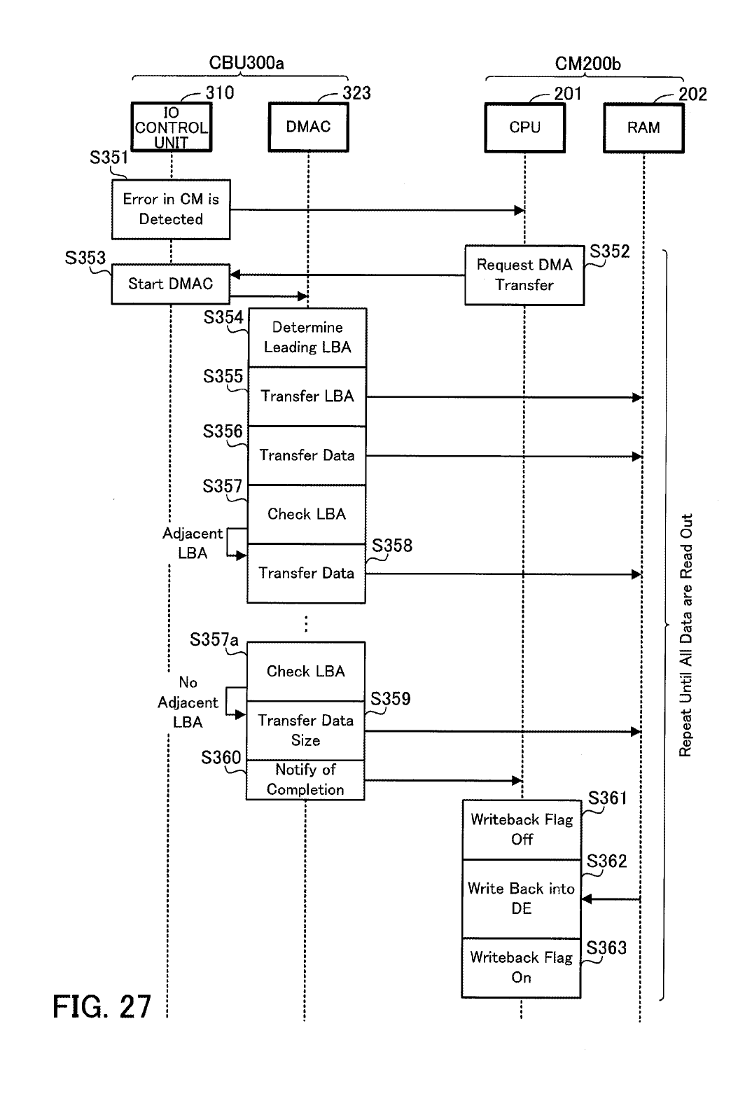

FIG. 27 is a sequence diagram indicating an example of a sequence of operations for writing back data stored in a NAND flash memory.

<Step S351> When the IO control unit 310 in the CBU 300a detects that the CM 200a stops because of occurrence of an error, the IO control unit 310 informs the CM 200b of the occurrence of an error. For example, when the IO control unit 310 is unable to perform communication with the CM 200a, the IO control unit 310 determines that the CM 200a stops. Thereafter, the operations in step S352 and S363 are repeated until all the data stored in the NAND flash memory 331 in the CBU 300a are read out.

<Step S352> The CPU 201 in the CM 200b sends a read-request packet to the CBU 300a for requesting the CBU 300a to perform a DMA transfer of the data stored in the NAND flash memory 331. At this time, the leading addresses of the buffer areas 260 in the CM 200b are set as the destinations of the data in the read-request packet.

<Step S353> When the CBU 300a receives the above read-request packet, the IO control unit 310 in the CBU 300a starts the DMA controller 323. At this time, the IO control unit 310 indicates to the DMA controller 323 the leading addresses of the buffer areas 260 (which are set in the read-request packet) as the destinations of the data.

<Step S354> The DMA controller 323 in the CBU 300a refers to the NAND management table 351 in the RAM 332 through the table management unit 322 in the CBU 300a. The DMA controller 323 searches the LBAs recorded in the NAND management table 351 and detects the leading LBA of each series of pieces of data. For example, the DMA controller 323 determines the smallest one of each series of consecutive LBAs recorded in the NAND management table 351 to be the leading LBA.

<Step S355> The DMA controller 323 in the CBU 300a transfers the determined leading LBA to the buffer areas 260 in the CM 200b by sending a reply packet to the CM 200b.

<Step S356> The DMA controller 323 in the CBU 300a extracts from the NAND management table 351 an address associated with the transferred LBA, reads a piece of data from the extracted address in the NAND flash memory 331, and transfers the piece of data to the buffer areas 260 in the CM 200b. When the data transfer is completed, the DMA controller 323 deletes the LBA corresponding to the transferred piece of data from the NAND management table 351.

<Step S357> The DMA controller 323 in the CBU 300a determines whether or not the NAND management table 351 contains an LBA adjacent to the LBA of the precedingly transferred piece of data, where the LBA adjacent to the LBA of the transferred piece of data is the LBA which is greater than the LBA of the transferred piece of data by eight. When yes is determined, the operation goes to step S358.

<Step S358> The DMA controller 323 in the CBU 300a extracts from the NAND management table 351 an address associated with the adjacent LBA, reads out a piece of data from the extracted address in the NAND flash memory 331, and transfers the piece of data to the buffer areas 260 in the CM 200b. When the data transfer is completed, the DMA controller 323 deletes the LBA corresponding to the transferred piece of data from the NAND management table 351.

Thereafter, the DMA controller 323 in the CBU 300a repeats the operations in steps S357 and S358 as long as an LBA adjacent to the LBA of the precedingly transferred piece of data remains in the NAND management table 351. Thus, each series of pieces of data can be written in the buffer areas 260 in the CM 200b.

When no LBA adjacent to the LBA of the precedingly transferred piece of data remains in the NAND management table 351, the DMA controller 323 determines in step S357 that the NAND management table 351 contains no LBA adjacent to the LBA of the precedingly transferred piece of data, and the operation goes to step S359. (In FIG. 27, the determination in step S357 that the NAND management table 351 contains no LBA adjacent to the LBA of the precedingly transferred piece of data is indicated by “S357a”.)<

<Step S359> The DMA controller 323 in the CBU 300a transfers to the buffer areas 260 in the CM 200b the data size of each series of pieces of data which has been transferred in steps S356 to S358.

<Step S360> The DMA controller 323 in the CBU 300a informs the CPU 201 in the CM 200b of completion of the data transfer, by interruption.

<Step S361> The CPU 201 in the CM 200b turns off the writeback flag in the buffer area 260.

<Step S362> The CPU 201 in the CM 200b writes back into the DE 400 respective series of pieces of data stored in the buffer areas 260.

<Step S363> When the writeback of the respective series of pieces of data is completed, the CPU 201 in the buffer area 260 turns on the writeback flag in the buffer areas 260.

In the above sequence of operations of FIG. 27, when the CPU 201 in the CM 200b reads out each piece of data from the NAND flash memory 331 in the CBU 300a, the CPU 201 in the CM 200b also reads out the LBA associated with the piece of data. Therefore, the CPU 201 in the CM 200b can recognize the location, on the logical volumes, of the piece of data which is read out as above. Thus, after the CPU 201 in the CM 200b reads out and writes back the data into the DE 400, the CPU 201 in the CM 200b can receive a request for access to the data from the host apparatus, and take over the access control which has been performed by the CM 200a.

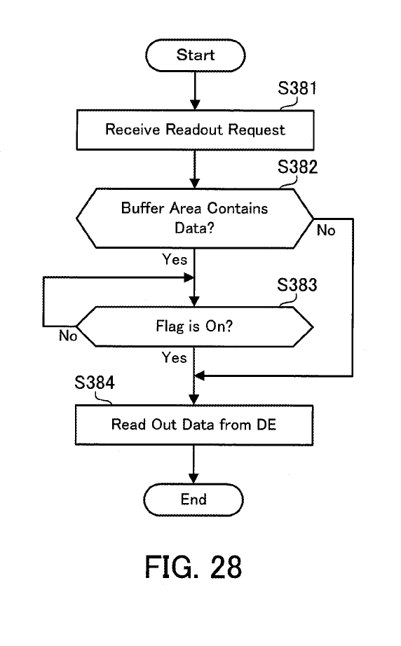

FIG. 28 is a flow diagram indicating an example of a flow of operations performed when a readout request is received from a host apparatus during the operation of writing back data by the CM 200b.

<Step S381> The CPU 201 in the CM 200b receives from the host apparatus 500a or 500b a readout request for data in a logical volume the access control to which has been assigned to the CM 200a.

<Step S382> The CPU 201 in the CM 200b determines whether or not the data requested to be read out is stored in the buffer areas 260, on the basis of the information in the fields “Leading LBA” and “Size” in the buffer areas 260. In the case where the data is stored in the buffer areas 260, the CPU 201 performs the operation in step S383. In the case where the data is not stored in the buffer areas 260, the CPU 201 performs the operation in step S384.

<Step S383> The CPU 201 in the CM 200b refers to the writeback flag in the field “Writeback Flag” in one of the buffer areas 260 associated with the requested data. When the writeback flag is off, the CPU 201 waits for execution of the operation in step S384 until the writeback flag is turned on. When the writeback flag is on, the CPU 201 performs the operation in step S384.

<Step S384> The CPU 201 in the CM 200b reads out from the DE 400 the data requested to be read out, and transmits the data to the host apparatus. In the case where the operation in step S384 is performed after the operation in step S383, the data transmitted to the host apparatus is the newest data which has been stored in the cache area in the other CM 200a before the stop of the CM 200a.

In the above sequence of operations of FIG. 28, the CM 200b suppresses execution of the operation of reading out the data from the DE 400 when the writeback flag is determined to be off in step S383. Therefore, it is possible to prevent transmission to the host apparatus of old data stored in the DE 400 instead of new data which is not yet written back into the DE 400.

2.5 Determination of Operations by IO Control Unit

When communication is performed between the CMs or between a CM and a CBU, the PCIe packets pass through the IO control unit 310 in at least one CBU. When each CBU receives a PCIe packet, the IO control unit 310 in the CBU determines whether the PCIe packet is addressed to the CBU (containing the IO control unit 310) or to the other CBU, on the basis of the combination of conditions including the port through which the PCIe packet is received, the type of the packet (indicated by the values in the fields of “Fmt” and “Type”), and the address determination number (indicated by the bits “Addr[n:n−2]”). When the IO control unit 310 in each CBU determines that the PCIe packet is addressed to the other CBU, the IO control unit 310 transfers the PCIe packet through another port. On the other hand, when the IO control unit 310 in each CBU determines that the PCIe packet is addressed to the CBU (containing the IO control unit 310), the IO control unit 310 can determine operations which the CBU should perform, on the basis of the above combination of conditions.

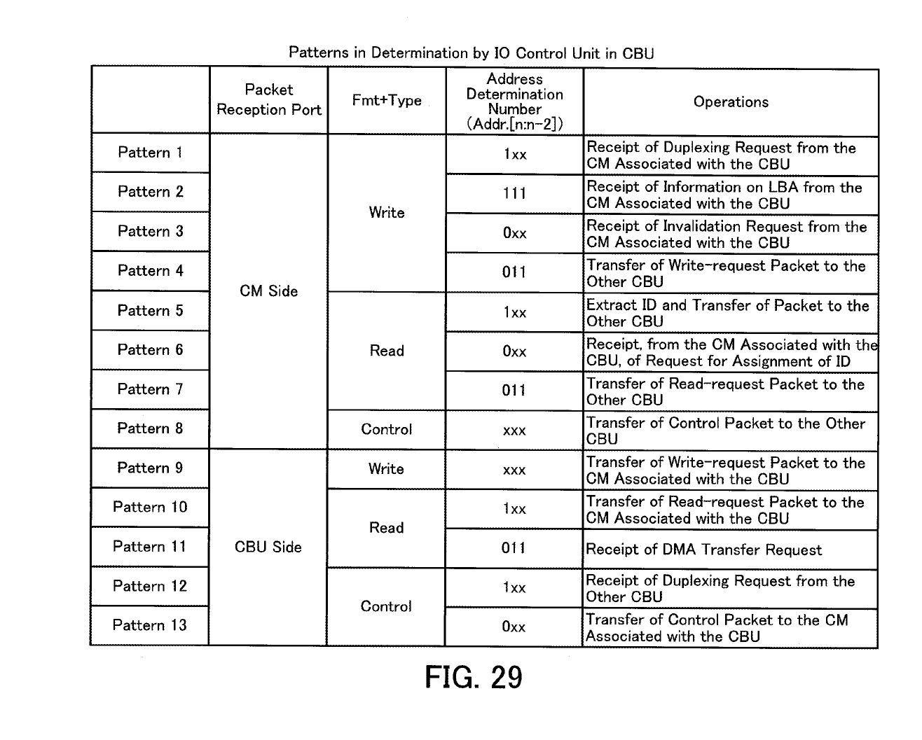

For example, the combination of the above conditions can be classified into the thirteen patterns as indicated in FIG. 29, and the operations as indicated in FIG. 29 can be respectively assigned to the patterns. Hereinbelow, the operations respectively performed by each CBU according to the thirteen patterns are explained. In the following explanations, the CM for which data stored in the cache area 202b are backed up in the NAND flash memory 331 in the CBU which receives the PCIe packet is referred to as the CM associated with the CBU. For example, the CM associated with the CBU 300a is CM 200a, and the CM associated with the other CBU 300b is the CM 200b. In addition, each CBU has two ports; one is connected to the CM associated with the CBU per se, and the other is connected to the CM associated with the other CBU.

In the case of the pattern 1, the IO control unit 310 determines that the CM associated with the CBU (containing the IO control unit 310) requests the CBU to duplex data. For example, the case of the pattern 1 corresponds to each of steps S112 (in the sequence of FIG. 13), S138 (in the sequence of FIG. 14), and S175 (in the sequence of FIGS. 16 and 17). In this case, the least significant two bits constituting the address determination number indicate the type of the division area.

In the case of the pattern 2, the IO control unit 310 determines that the CM associated with the CBU (containing the IO control unit 310) informs the CBU of one or more LBAs. For example, the case of the pattern 2 corresponds to each of steps S108 (in the sequence of FIG. 13), S171 (in the sequence of FIGS. 16 and 17), S209 (in the sequence of FIGS. 19 and 20), and S282 (in the sequence of FIGS. 23 and 24).

In the case of the pattern 3, the IO control unit 310 determines that the CM associated with the CBU (containing the IO control unit 310) requests the CBU to invalidate one or more pages. In the case where one or more LBAs are set in the payload, the IO control unit 310 determines that the CM associated with the CBU (containing the IO control unit 310) requests the CBU to invalidate the one or more pages corresponding to the one or more LBAs, among the pages constituting the division area indicated by the ID. For example, the case of the pattern 3 corresponds to each of steps S166 (in the sequence of FIGS. 16 and 17) and S277 (in the sequence of FIGS. 23 and 24). On the other hand, in the case where no LBA is set in the payload, the IO control unit 310 determines that the CM associated with the CBU (containing the IO control unit 310) requests the CBU to invalidate all the pages constituting the division area indicated by the ID. This case corresponds to, for example, the case where the IO control unit 310 in the CBU 300a receives a write-request packet being sent from the CM 200a in step S333 (in the sequence of FIG. 25) and informing of the ID corresponding to the written-back data.

In the case of the pattern 4, the IO control unit 310 determines to transfer a received write-request packet to the other CBU. The operation in the case of the pattern 4 corresponds to, for example, the operation performed when the IO control unit 310 in the CBU 300a receives the write-request packet sent from the CM 200a in each of steps S203 (in the sequence of FIGS. 19 and 20), S243 (in the sequence of FIGS. 21 and 22), and S273 (in the sequence of FIGS. 23 and 24).

In the case of the pattern 5, the IO control unit 310 determines to extract the ID from a received read-request packet and transfer the received read-request packet to the other CBU. For example, the operation in the case of the pattern 5 corresponds to the operation in each of steps S212 (in the sequence of FIGS. 19 and 20), S248 (in the sequence of FIGS. 21 and 22), and S285 (in the sequence of FIGS. 23 and 24).

In the case of the pattern 6, the IO control unit 310 determines that the CM associated with the CBU (containing the IO control unit 310) requests the CBU to assign an ID. For example, the case of the pattern 6 corresponds to the case where the IO control unit 310 in the CBU 300a receives the read-request packet sent from the CM 200a in each of steps S104 (in the sequence of FIG. 13) and S167 (in the sequence of FIGS. 16 and 17) or the operation of the IO control unit 310 in the CBU 300b receives the read-request packet sent from the CM 200b in each of steps S205 (in the sequence of FIGS. 19 and 20) and S278 (in the sequence of FIGS. 23 and 24). In this case, the least significant two bits constituting the address determination number indicate the type of the division area.

In the case of the pattern 7, the IO control unit 310 determines to transfer a received read-request packet to the other CBU. The case of the pattern 7 corresponds to, for example, the case where the IO control unit 310 in the CBU 300b receives the read-request packet (for requesting a writeback) sent from the CM 200b in step S352 (in the sequence of FIG. 27).

In the case of the pattern 8, the IO control unit 310 determines to transfer a received control packet to the other CBU. The case of the pattern 8 corresponds to, for example, the case where the IO control unit 310 in the CBU 300a receives the reply packet sent from the CM 200a in each of steps S216 (in the sequence of FIGS. 19 and 20), S253 (in the sequence of FIGS. 21 and 22), and S289 (in the sequence of FIGS. 23 and 24).

In the case of the pattern 9, the IO control unit 310 determines to transfer a received write-request packet to the CBU (containing the IO control unit 310). The case of the pattern 9 corresponds to, for example, the case where the IO control unit 310 in the CBU 300a receives the write-request packet sent from the CM 200a in each of steps S203 (in the sequence of FIGS. 19 and 20), S243 (in the sequence of FIGS. 21 and 22), and S273 (in the sequence of FIGS. 23 and 24).

In the case of the pattern 10, the IO control unit 310 determines to transfer a received read-request packet to the CM associated with the CBU (containing the IO control unit 310). The case of the pattern 10 corresponds to, for example, the case where the IO control unit 310 in the CBU 300a receives the read-request packet sent from the CBU 300b in each of steps S212 (in the sequence of FIGS. 19 and 20), S248 (in the sequence of FIGS. 21 and 22), and S285 (in the sequence of FIGS. 23 and 24).

In the case of the pattern 11, the IO control unit 310 determines that the IO control unit 310 receives a request for DMA transfer of data stored in the NAND flash memory 331 in the CBU (containing the IO control unit 310). For example, the case of the pattern 11 corresponds to step S353 (in the sequence of FIG. 27).

In the case of the pattern 12, the IO control unit 310 determines that the CM associated with the other CBU requests the CBU containing the above IO control unit 310 to duplex data. For example, the case of the pattern 12 corresponds to each of steps S217 (in the sequence of FIGS. 19 and 20), S254 (in the sequence of FIGS. 21 and 22), and S290 (in the sequence of FIGS. 23 and 24). In this case, the least significant two bits constituting the address determination number indicate the type of the division area.

In the case of the pattern 13, the IO control unit 310 determines to transfer a received control packet to the CM associated with the CBU (containing the IO control unit 310). The case of the pattern 13 corresponds to, for example, the case where the IO control unit 310 in the CBU 300b receives the control packet sent from the CBU 300a in each of steps S355, S356, S358, and S359 (in the sequence of FIG. 27).

Since the IO control unit 310 determines the operations and the destinations of packets as explained above, communication between the CMs or between a CM and a CBU or between CBUs can be performed by using packets in accordance with the PCI Express standard. Therefore, it is possible to reduce the development cost of the storage system 100, and also reduce the design changes for communication processing performed by the CMs through the PCIe bus.

According to the above aspect, it is possible to doubly store data in a short time.

### 3. Additional Matters

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
a processor;
a first memory;
a second memory;
a first transfer control circuit connected to the processor and the first memory; and
a second transfer control circuit connected to the first transfer control circuit and the second memory;
wherein: the first transfer control circuit sends data to the second transfer control circuit when the first transfer control circuit receives from the processor a request for transfer of the data and the data is addressed to the first memory; and when the second transfer control circuit receives the data sent from the first transfer control circuit, the second transfer control circuit stores the received data in the second memory, and also stores the received data in the first memory through the first transfer control circuit.

2. The information processing system according to claim 1, wherein: when the first transfer control circuit receives from the processor the data addressed to the first memory, the first transfer control circuit sends to the second transfer control circuit a write-request packet containing the data and designating the first memory as a destination of the data; when the second transfer control circuit receives the write-request packet from the first transfer control circuit, the second transfer control circuit writes in the second memory the data contained in the write-request packet, and transfers the write-request packet to the first transfer control circuit; and when the first transfer control circuit receives the write-request packet from the second transfer control circuit, the first transfer control circuit writes in the first memory the data contained in the write-request packet.

3. The information processing system according to claim 1, connected to a storage apparatus, wherein: the processor controls access to the storage apparatus in response to an access request from a host apparatus, and uses the first memory as a cache memory which caches data transmitted between the host apparatus and the storage apparatus; a backup device which controls access to the storage apparatus in response to an access request from the host apparatus on behalf of the processor is connected to the second transfer control circuit; and when operation of the processor stops, the backup device reads out, through the second transfer control circuit, the data stored in the second memory, and writes in the storage apparatus the data which the backup device reads out.

4. The information processing system according to claim 1, wherein: a transfer buffer is connected to the second transfer control circuit; and the second transfer control circuit temporarily stores in the transfer buffer the data sent from the first transfer control circuit, and transfers the data sent from the first transfer control circuit, from the transfer buffer to the second memory, as well as from the transfer buffer through the first transfer control circuit to the first memory.

5. The information processing system according to claim 1, further comprising,
a first communication interface connected to a network,
a first reception buffer which is connected to the first transfer control circuit and temporarily stores data received by the first communication interface through the network,
a second communication interface connected to the network,
a second reception buffer which temporarily stores data received by the second communication interface through the network, and
a third transfer control circuit connected to the second reception buffer and the second transfer control circuit;
wherein: when the processor requests the first transfer control circuit to transfer to the first memory first data stored in the first reception buffer, the first transfer control circuit reads out the first data from the first reception buffer and sends to the second transfer control circuit a write-request packet containing the first data read out from the first reception buffer and designating the first memory as a destination of the first data, and the second transfer control circuit receives the write-request packet from the first transfer control circuit, writes in the second memory the first data contained in the write-request packet, and transfers the write-request packet to the first transfer control circuit, and the first transfer control circuit receives the write-request packet transferred from the second transfer control circuit and writes in the first memory the first data contained in the write-request packet; and
when the processor requests the first transfer control circuit to transfer to the first memory second data stored in the second reception buffer, the first transfer control circuit sends a read-request packet designating the second reception buffer as a data source, to the third transfer control circuit through the second transfer control circuit, the third transfer control circuit receives the read-request packet, reads out the second data from the second reception buffer, and sends to the second transfer control circuit a reply packet containing the second data read out from the second reception buffer, the second transfer control circuit receives the reply packet, writes in the second memory the second data contained in the reply packet, and transfers the reply packet to the first transfer control circuit, and the first transfer control circuit receives the reply packet transferred from the second transfer control circuit and writes in the first memory the second data contained in the reply packet.

6. The information processing system according to claim 1, wherein: the second memory is a NAND flash memory; the second transfer control circuit writes the data in one of multiple division areas of a first type which are defined by dividing a memory area of the NAND flash memory into pages, when the data has a size equal to or smaller than a page; and the second transfer control circuit writes the data in one of multiple division areas of a second type which are defined by dividing a memory area of the NAND flash memory into blocks, when the data has a size greater than a page and equal to or smaller than a block.

7. The information processing system according to claim 6, wherein: the processor acquires from the second transfer control circuit identification information indicating a division area in the second memory which stores the data in response to the request received by the first transfer control circuit; and when the processor requests invalidation of data stored in the second memory, the processor sends identification information indicating a division area in the second memory storing the data stored in the second memory and requested to be invalidated, to the second transfer control circuit through the first transfer control circuit.

8. The information processing system according to claim 7, connected to a storage apparatus, wherein: the processor controls access to the storage apparatus in response to an access request from a host apparatus, and uses the first memory as a cache memory which caches data transmitted between the host apparatus and the storage apparatus; when data stored in the first memory is written back into the storage apparatus, the processor sends, to the second transfer control circuit through the first transfer control circuit, identification information corresponding to the data written back into the storage apparatus and indicating a division area in the second memory in which data backing up the data written back into the storage apparatus is stored, and requests the second transfer control circuit to invalidate the data in the division area indicated by the identification information corresponding to the data written back into the storage apparatus; and the second transfer control circuit receives the identification information corresponding to the data written back into the storage apparatus, and performs an operation for erasing the data stored in the division area indicated by the identification information corresponding to the data written back into the storage apparatus.

9. The information processing system according to claim 7, wherein: when the processor requests overwriting of data backed up in a first division area in the second memory with new data, the processor sends identification information corresponding to the data to be overwritten, to the second transfer control circuit through the first transfer control circuit, and the second transfer control circuit receives the identification information, invalidates the data stored in the first division area on the basis of the identification information, assigns the identification information to a second division area of a type identical to the first division area, and writes the new data in the second division area.

10. The information processing system according to claim 8, wherein: when the processor requests overwriting of part of first data backed up in the second memory with second data, the processor requests the second transfer control circuit to invalidate an area in the second memory in which the part of the first data to be overwritten with the second data is stored and send to the processor new identification information indicating a division area of a type corresponding to a size of the second data; and the second transfer control circuit invalidates the area in the second memory in which the part of the first data to be overwritten with the second data is stored, sends the new identification information to the processor, and writes the second data in the division area indicated by the new identification information.

11. The information processing system according to claim 10, wherein: when the first data, which is stored in the first memory and is then partially overwritten with the second data, is written back into the storage apparatus, the processor sends first identification information corresponding to the first data and second identification information corresponding to the second data, to the second transfer control circuit through the first transfer control circuit, and requests the second transfer control circuit to invalidate data in a division area corresponding to each of the first identification information and the second identification information.

12. The information processing system according to claim 8, wherein: a backup device which controls access to the storage apparatus in response to an access request from the host apparatus on behalf of the processor is connected to the second transfer control circuit; every time a new set of data is stored in the second memory in connection with a request to the first transfer control circuit for data transfer, the processor informs the second transfer control circuit of one or more logical addresses of the new set of data through the first transfer control circuit; the second transfer control circuit records in a management table one or more addresses, each corresponding to a division area of the first type, of the new set of data stored in the second memory, in association with the one or more logical addresses of which the second transfer control circuit is informed by the processor; and when operation of the processor stops, the backup device reads out, through the second transfer control circuit, the data stored in the second memory and one or more logical addresses associated with the data stored in the second memory, determines each set of data associated with consecutive logical addresses among the data stored in the second memory to be a series of data, and writes each series of data in the storage apparatus.

13. A data-storage control method executed in an information processing system including a processor, a first memory, and a second memory, the data-storage control method comprising:
sending, from the processor to a first transfer control circuit connected to the first memory, a request for transfer of data addressed to the first memory;
sending the data from the first transfer control circuit to a second transfer control circuit connected to the second memory; and
receiving the data from the first transfer control circuit by the second transfer control circuit, storing the data in the second memory by the second transfer control circuit, and storing the data in the first memory by the second transfer control circuit through the first transfer control circuit.

14. The data-storage control method according to claim 13, wherein: the sending of the data to the second transfer control circuit includes sending, from the first transfer control circuit to the second transfer control circuit, a write-request packet containing the data and designating the first memory as a destination of the data; and the storing of the data in the first memory and the storing of the data in the second memory are realized by writing in the second memory the data contained in the write-request packet and transferring the write-request packet to the first transfer control circuit, by the second transfer control circuit, on receipt of the write-request packet from the first transfer control circuit, and writing in the first memory the data contained in the write-request packet, on receipt of the write-request packet transferred from the second transfer control circuit.

15. The data-storage control method according to claim 13, wherein the second memory is a NAND flash memory, the data-storage control method further comprising: writing, by the second transfer control circuit, the data into one of first multiple division areas of a first type which are arranged by dividing a memory area of the NAND flash memory into pages, in the case where the data has a size equal to or smaller than a page; and writing, by the second transfer control circuit, the data into one of second multiple division areas of a second type which are arranged by dividing a memory area of the NAND flash memory into blocks, in the case where the data has a size greater than a page and equal to or smaller than a block.

16. The data-storage control method according to claim 15, further comprising: acquiring, from the second transfer control circuit by the processor, identification information indicating one of the first and second multiple division areas in which the data is stored in response to the request sent from the processor to the first transfer control circuit; and sending, by the processor to the second transfer control circuit, identification information indicating one or more of the first and second multiple division areas in which data requested to be invalidated are stored, when the data stored in the one or more of the first and second multiple division areas are requested to be invalidated.
